(19) United States
(12) Patent Application Publication
(10) Pub. No.: US 2015/0178671 A1
(43) Pub. Date: Jun. 25, 2015

(54) SYSTEMS AND METHODS FOR REPLENISHMENT OF PRODUCTS IN MULTIPLE LOCATIONS

(71) Applicant: WAL-MART STORES, INC., Bentonville, AR (US)

(72) Inventors: Matthew A. Jones, Bentonville, AR (US); Matthew M. Lowrie, Bentonville, AR (US); Thomas L. Mckenzie, Rogers, AR (US); Clifford W. Bolinger, Rogers, AR (US)

(21) Appl. No.: 14/134,610

(22) Filed: Dec. 19, 2013

(51) Int. Cl. G06Q 10/08

(52) U.S. Cl. CPC G06Q 10/087

(57) ABSTRACT

In one embodiment, a system for replenishing inventory in a retail environment is disclosed, where the system comprises a memory, at least one processor coupled to the memory, an inventory management engine executed by the processor and adapted to track the quantity of at least one product available in at least one location within the retail environment, and a rule processing engine executed by the processor and adapted to execute at least one rule of a plurality of rules for picking the at least one product for replenishment in the at least one location within the retail environment. In some embodiments, the at least one location within the retail environment includes a selling location, a feature location, and a reserve location.

### BACKGROUND

Tracking of product inventory, as well as stocking of products at sales locations within a retail environment has traditionally been a manually intensive process. Store associates and managers would often have to count manually the quantities of products on hand, both on the shelves, racks or feature displays on the sales floor, as well as in a warehouse stock room. The replenishment of products available for sale on the sales floor would often involve performing a hand count of the product's quantity available on hand in all locations, and then an organized movement of an appropriate quantity of the product from the stock room to the appropriate sales floor location. Given the considerable time and effort necessary to perform all appropriate actions for counting and stocking products, retail stores of sufficient scale, such as grocery and department stores, often lack an ability to keep a real-time count of the exact quantity of a product on-hand, as well as keep the sales floor stocked with as much capacity as possible from the overall quantity of the product present in the store.

### SUMMARY OF INVENTION

With the advent of various digital technologies, such as computer systems, barcode scanners, and radio frequency identification tags and readers, retail environments gained an ability to maintain a digital accounting of the quantities of goods present within a retail environment. Total products on-hand within a retail establishment could be counted by tracking the number of units of a particular product that have been delivered to the store and the number of units of the particular product that had been sold.

While the true availability of an item within a store might correspond to the total number of units of a particular product on-hand within the entire store, it is appreciated that the availability of that product as perceived by a customer depends on the number of units of a product that are present at specific locations within the store environment where that customer might either expect the product to be found or might see the product on featured display within a special location. Even with the advent of digital systems for tracking total product unit availability within a retail establishment, keeping the appropriate sales locations for a particular product stocked throughout the course of the operating hours of a business often requires store employees to take manual initiative to observe current product quantities at various display locations, calculate the number of product units to retrieve from stock room storage, and then restock the various on-sale locations within the retail establishment. Consequently, it is appreciated that there exists a need for a system that not only tracks the quantity of products on-hand within a retail establishment, but maintains count of the products present at multiple locations within the retail establishment and can alert employees to the quantity of product units to be retrieved from storage for replenishing various on-sale locations as well as the times at which restocking those on-sale locations would be most optimal for ensuring consistent perceived product availability in the minds of shoppers.

Aspects and embodiments are directed to an inventory management system capable of tracking product quantities present at multiple locations within a retail establishment, predicting the need for replenishment of product unit availability at those multiple locations, calculating the quantity of product units to be retrieved in any particular replenishment action for those multiple locations, and issuing alerts to employees at appropriate times for when product replenishment should occur for various locations within the retail establishment.

According to some embodiments, a system for replenishing inventory in a retail environment comprises a memory, at least one processor coupled to the memory, an inventory management engine executed by the processor and adapted to track the quantity of at least one product available in at least one location within the retail environment, and a rule processing engine executed by the processor and adapted to execute at least one rule of a plurality of rules for picking the at least one product for replenishment in the at least one location within the retail environment. In some embodiments, the at least one location within the retail environment includes a selling location, a feature location, and a reserve location. In various embodiments, the plurality of rules for picking the at least one product includes a rule that defines a predetermined schedule of time to pick the at least one product.

In some embodiments, the at least one rule of the plurality of rules for picking includes a rule that defines a pick of the at least one product at a time and a quantity chosen by a system operator. In various embodiments, the at least one rule of the plurality of rules for picking includes a rule that defines a pick of a calculated quantity of the at least one product at a time chosen by a system operator.

In various embodiments, the at least one rule of the plurality of rules for picking includes a rule that defines a predetermined schedule of times to pick the at least one product responsive to a determination by the inventory management engine that a rate of sale of the at least one product is greater than a sales floor quantity of the at least one product. In some embodiments, the at least one product is a product whose storage quantity in a reserve location has been increased by delivery of a quantity of the at least one product to the retail establishment within a specific time window. In particular embodiments, the at least one product is a product whose total on-hand quantity in a selling location, a feature location, and a reserve location has changed within a specific time window.

In some embodiments, the at least one product is a product whose total sales floor quantity in the selling location and feature location has diminished within a specific time window. In various embodiments, the at least one rule of the plurality of rules for picking includes a rule that defines a predetermined schedule of times to pick the at least one product responsive to a determination by the inventory management engine that sufficient quantity of the at least one product is available in storage to fill available space on a sales floor reserved for the at least one product. In some embodiments, the at least one rule of the plurality of rules for picking includes a rule that defines a predetermined schedule of times to pick the at least one product responsive to a determination by the inventory management engine that all quantity of the at least one product in storage is available to stock available space on a sales floor reserved for the at least one product.

In various embodiments, the inventory management engine is further configured to track a quantity of the at least one product over a time period whose time window commences at the time of product delivery to the retail establishment. In some embodiments, the inventory management engine is further configured to track a quantity of the at least one product over a time period whose time window commences at the time of a most recent pick of the at least one product. In various embodiments, the inventory management engine is further configured to track a quantity of the at least one product over a time period whose time window commences at the time of a most recent placement of the at least one product in a feature location.

In some embodiments, the at least one rule of the plurality of rules for picking includes a rule for picking the at least one product having only a single modular location. In various embodiments, the at least one rule of the plurality of rules for picking includes a rule for picking the at least one product having multiple modular locations. In some embodiments, the at least one rule of the plurality of rules for picking includes a rule for picking the at least one product having a modular location and a feature location with a feature capacity. In various embodiments, the at least one rule of the plurality of rules for picking includes a rule for picking the at least one product having a modular location and a feature location without a feature capacity.

In various embodiments, the at least one rule of the plurality of rules for picking includes a rule for picking the at least one product having only a feature location with a feature capacity. In some embodiments, the at least one rule of the plurality of rules for picking includes a rule for picking the at least one product having only a feature location without a feature capacity. In particular embodiments, the plurality of rules for picking the at least one product for replenishment comprises at least one rule for replenishment based on case size of the at least one product.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 shows an example retail establishment including both a sales floor and a stock room and highlighting various locations where units of a product can be located;

FIG. 2 shows an example of a distributed computer system with which aspects and embodiments of the inventory management and in-store replenishment system can be implemented;

FIG. 3 shows an example diagram representing various logical components of an inventory management and in-store replenishment system;

FIG. 4 shows an example process diagram by which rules for product picking and executing product replenishment can be accomplished;

FIG. 5 shows an example process diagram for execution a of a rule for picking modular items when the rate of sale is greater than a sales floor quantity;

FIG. 6 shows an example process diagram for execution of a rule for picking modular products when the total quantity of product on-hand is equal to the bin quantity of the product;

FIG. 7A shows an example process diagram for execution of a rule for picking modular products on feature display when the shelf capacity of the product is less than or equal to the feature capacity for the product, and the products is picked by cases;

FIG. 7B shows an example process diagram for execution of a rule for picking modular products on feature display when the shelf capacity of the product is less than or equal to the feature capacity for the product, and the product is picked by “eaches” referred to herein wherein individual product units are picked from storage;

FIG. 7C shows another example process diagram for execution of a rule for picking modular products on feature display when the shelf capacity of the product is less than or equal to the feature capacity for the product, and the product is only stored by eaches;

FIG. 8A shows an example process diagram for execution of a rule for picking modular products on feature display when the shelf capacity of the product is greater than or equal to the feature capacity for the product, and the product is picked by cases;

FIG. 8B shows an example process diagram for execution of a rule for picking modular products on feature display when the shelf capacity of the product is greater than or equal to the feature capacity for the product, and the product is picked by eaches;

FIG. 8C shows an example process diagram for execution of a rule for picking modular products on feature display when the shelf capacity of the product is greater than or equal to the feature capacity for the product, and the product is only stored by eaches;

FIG. 9A shows an example process diagram for the execution of a rule for picking modular products on feature display when the total quantity of the product on-hand is equal to the bin quantity of the product, and the product is picked by cases;

FIG. 9B shows an example process diagram for the execution of a rule for picking modular products on feature display when the total quantity of the product on-hand is equal to the bin quantity of the product, and the product is picked by eaches;

FIG. 9C shows an example process diagram for the execution of a rule for picking modular products on feature display when the total quantity of the product on-hand is equal to the bin quantity of the product, and the product is only stored by eaches;

FIG. 10A shows an example process diagram for the execution of a rule for picking non-modular products on feature display when the sales floor quantity of the product is less than 60% of the feature capacity of the product, and the product is picked by cases;

FIG. 10B shows an example process diagram for the execution of a rule for picking non-modular products on feature display when the sales floor quantity of the product is less than 60% of the feature capacity of the product, and the product is picked by eaches;

FIG. 10C shows an example process diagram for the execution of a rule for picking non-modular products on feature display when the sales floor quantity of the product is less than 60% of the feature capacity of the product, and the product is only stored by eaches;

FIG. 11A shows an example process diagram for the execution of a rule for picking non-modular products on feature display when the total quantity of the product on-hand is equal to the bin quantity of the product, and the product is picked by cases;

FIG. 11B shows an example process diagram for the execution of a rule for picking non-modular products on feature display when the total quantity of the product on-hand is equal to the bin quantity of the product, and the product is picked by eaches;

FIG. 11C shows an example process diagram for the execution of a rule for picking non-modular products on feature display when the total quantity of the product on-hand is equal to the bin quantity of the product, and the product is only stored by eaches;

FIG. 12A shows an example process diagram for the execution of a rule for picking modular products on feature display without feature capacity when the rate of sale for the product is greater or equal to than the shelf capacity of the product, and the product is picked by cases;

FIG. 12B shows an example process diagram for the execution of a rule for picking modular products on feature display without feature capacity when the rate of sale for the product is greater or equal to than the shelf capacity of the product, and the product is picked by eaches;

FIG. 12C shows an example process diagram for the execution of a rule for picking modular products on feature display without feature capacity when the rate of sale for the product is greater or equal to than the shelf capacity of the product, and the product is only stored by eaches;

FIG. 13A shows an example process diagram for the execution of a rule for picking modular products on feature display without feature capacity when the total quantity of the product on-hand is equaled to the bin quantity of the product, and the product is picked by cases;

FIG. 13B shows an example process diagram for the execution of a rule for picking modular products on feature display without feature capacity when the total quantity of the product on-hand is equaled to the bin quantity of the product, and the product is picked by eaches;

FIG. 13C shows an example process diagram for the execution of a rule for picking modular products on feature display without feature capacity when the total quantity of the product on-hand is equaled to the bin quantity of the product, and the product is only stored by eaches;

FIG. 14A shows an example process diagram for the execution of a rule for picking non-modular products on feature display when the rate of sale for the product is greater than the sales floor quantity of the product, and the product is picked by cases;

FIG. 14B shows an example process diagram for the execution of a rule for picking non-modular products on feature display when the rate of sale for the product is greater than the sales floor quantity of the product, and the product is picked by eaches;

FIG. 14C shows an example process diagram for the execution of a rule for picking non-modular products on feature display when the rate of sale for the product is greater than the sales floor quantity of the product, and the product is only stored by eaches;

FIG. 15A shows an example process diagram for the execution of a rule for picking non-modular products on feature display without feature capacity when the total quantity of product on-hand is equaled to the bin quantity of the product, and the product is picked by cases;

FIG. 15B shows an example process diagram for the execution of a rule for picking non-modular products on feature display without feature capacity when the total quantity of product on-hand is equaled to the bin quantity of the product, and the product is picked by eaches;

FIG. 15C shows an example process diagram for the execution of a rule for picking non-modular products on feature display without feature capacity when the total quantity of product on-hand is equaled to the bin quantity of the product, and the product is only stored by eaches;

FIG. 16 shows an example process diagram for the execution of a rule for picking modular products to maintain a level of sales floor quantity of the product at scheduled times when the rate of sale for the product is greater than the sales floor quantity of the product;

FIG. 17 shows an example process diagram for the execution of a rule for picking modular products to maintain a level of sales floor quantity of the product at scheduled times when the total quantity of product on-hand equals the bin quantity of the product;

FIG. 18A shows an example process diagram for the execution of a rule for picking modular products on feature display to maintain a level of sales floor quantity of the product at scheduled times when the shelf capacity of the product is less than feature capacity of the product, and the product is picked by cases;

FIG. 18B shows an example process diagram for the execution of a rule for picking modular products on feature display to maintain a level of sales floor quantity of the product at scheduled times when the shelf capacity of the product is less than feature capacity of the product, and the product is picked by eaches;

FIG. 18C shows an example process diagram for the execution of a rule for picking modular products on feature display to maintain a level of sales floor quantity of the product at scheduled times when the shelf capacity of the product is less than feature capacity of the product, and the product is only stored by eaches;

FIG. 19A shows an example process diagram for the execution of a rule for picking modular products on feature display to maintain a level of sales floor quantity of the product at scheduled times when the shelf capacity of the product is greater than or equal to the feature capacity of the product, and the product is picked by cases;

FIG. 19B shows an example process diagram for the execution of a rule for picking modular products on feature display to maintain a level of sales floor quantity of the product at scheduled times when the shelf capacity of the product is greater than or equal to the feature capacity of the product, and the product is picked by eaches;

FIG. 19C shows an example process diagram for the execution of a rule for picking modular products on feature display to maintain a level of sales floor quantity of the product at scheduled times when the shelf capacity of the product is greater than or equal to the feature capacity of the product, and the product is only stored by eaches;

FIG. 20A shows an example process diagram for the execution of a rule for picking modular products on feature display to maintain a level of sales floor quantity of the product at scheduled times when the total quantity of product on-hand is equaled to the bin quantity of the product, and the product is picked by cases;

FIG. 20B shows an example process diagram for the execution of a rule for picking modular products on feature display to maintain a level of sales floor quantity of the product at scheduled times when the total quantity of product on-hand is equaled to the bin quantity of the product, and the product is picked by eaches;

FIG. 20C shows an example process diagram for the execution of a rule for picking modular products on feature display to maintain a level of sales floor quantity of the product at scheduled times when the total quantity of product on-hand is equaled to the bin quantity of the product, and the product is only stored by eaches;

FIG. 21A shows an example process diagram for the execution of a rule for picking modular products on feature display to maintain a level of sales floor quantity of the product at scheduled times when the sales floor quantity of the product is less than 60% of the feature capacity of the product, and the product is picked by cases;

FIG. 21B shows an example process diagram for the execution of a rule for picking modular products on feature display to maintain a level of sales floor quantity of the product at scheduled times when the sales floor quantity of the product is less than 60% of the feature capacity of the product, and the product is picked by eaches;

FIG. 21C shows an example process diagram for the execution of a rule for picking modular products on feature display to maintain a level of sales floor quantity of the product at scheduled times when the sales floor quantity of the product is less than 60% of the feature capacity of the product, and the product is only stored by eaches;

FIG. 22A shows an example process diagram for the execution of a rule for picking non-modular products on feature display to maintain a level of sales floor quantity of the product at scheduled times when the total on-hand quantity of the product is equal to the bin quantity of the product, and the product is picked by cases;

FIG. 22B shows an example process diagram for the execution of a rule for picking non-modular products on feature display to maintain a level of sales floor quantity of the product at scheduled times when the total on-hand quantity of the product is equal to the bin quantity of the product, and the product is picked by eaches;

FIG. 22C shows an example process diagram for the execution of a rule for picking non-modular products on feature display to maintain a level of sales floor quantity of the product at scheduled times when the total on-hand quantity of the product is equal to the bin quantity of the product, and the product is only stored by eaches;

FIG. 23A shows an example process diagram for the execution of a rule for picking non-modular products on feature display to maintain a level of sales floor quantity of the product at scheduled times when the rate of sale of the product is greater than or equal to the shelf capacity of the product, and the product is picked by cases;

FIG. 23B shows an example process diagram for the execution of a rule for picking non-modular products on feature display to maintain a level of sales floor quantity of the product at scheduled times when the rate of sale of the product is greater than or equal to the shelf capacity of the product, and the product is picked by eaches;

FIG. 23C shows an example process diagram for the execution of a rule for picking non-modular products on feature display to maintain a level of sales floor quantity of the product at scheduled times when the rate of sale of the product is greater than or equal to the shelf capacity of the product, and the product is only stored by eaches;

FIG. 24A shows an example process diagram for the execution of a rule for picking modular products on feature display without feature capacity or when feature capacity is zero to maintain a level of sales floor quantity of the product at scheduled times when the total quantity of product on-hand equals the bin quantity of the product, and the product is picked by cases;

FIG. 24B shows an example process diagram for the execution of a rule for picking modular products on feature display without feature capacity or when feature capacity is zero to maintain a level of sales floor quantity of the product at scheduled times when the total quantity of product on-hand equals the bin quantity of the product, and the product is picked by eaches;

FIG. 24C shows an example process diagram for the execution of a rule for picking modular products on feature display without feature capacity or when feature capacity is zero to maintain a level of sales floor quantity of the product at scheduled times when the total quantity of product on-hand equals the bin quantity of the product, and the product is only stored by eaches;

FIG. 25A shows an example process diagram for the execution of a rule for picking modular products on feature display without feature capacity or when feature capacity is zero to maintain a level of sales floor quantity of the product at scheduled times when the rate of sale of the product is greater than or equal to the sales floor quantity of the product, and the product is picked by cases;

FIG. 25B shows an example process diagram for the execution of a rule for picking modular products on feature display without feature capacity or when feature capacity is zero to maintain a level of sales floor quantity of the product at scheduled times when the rate of sale of the product is greater than or equal to the sales floor quantity of the product, and the product is picked by eaches;

FIG. 25C shows an example process diagram for the execution of a rule for picking modular products on feature display without feature capacity or when feature capacity is zero to maintain a level of sales floor quantity of the product at scheduled times when the rate of sale of the product is greater than or equal to the sales floor quantity of the product, and the product is only stored by eaches;

FIG. 26A shows an example process diagram for the execution of a rule for picking modular products on feature display without feature capacity or when the feature capacity is zero to maintain a level of sales floor quantity of the product at scheduled times when the total quantity of the product on-hand is equal to the bin quantity of the product and tracked sales for the product are greater than the case pack value for the product, and the product is picked by cases;

FIG. 26B shows an example process diagram for the execution of a rule for picking modular products on feature display without feature capacity or when the feature capacity is zero to maintain a level of sales floor quantity of the product at scheduled times when the total quantity of the product on-hand is equal to the bin quantity of the product and tracked sales for the product are greater than the case pack value for the product, and the product is picked by eaches;

FIG. 26C shows an example process diagram for the execution of a rule for picking modular products on feature display without feature capacity or when the feature capacity is zero to maintain a level of sales floor quantity of the product at scheduled times when the total quantity of the product on-hand is equal to the bin quantity of the product and tracked sales for the product are greater than the case pack value for the product, and the product is only stored by eaches;

FIG. 27 shows an example process diagram for the execution of a rule for picking a modular product at scheduled times to fill the sales floor capacity of the product based on the shelf capacity of the product and current sales floor quantity of the product;

FIG. 28A shows an example process diagram for the execution of a rule for picking a modular product on feature display at scheduled times to fill the sales floor capacity of the product based on the shelf capacity of the product and current sales floor quantity of the product, and the product is picked by cases;

FIG. 28B shows an example process diagram for the execution of a rule for picking a modular product on feature display at scheduled times to fill the sales floor capacity of the product based on the shelf capacity of the product and current sales floor quantity of the product, and the product is picked by eaches;

FIG. 28C shows an example process diagram for the execution of a rule for picking a modular product on feature display at scheduled times to fill the sales floor capacity of the product based on the shelf capacity of the product and current sales floor quantity of the product, and the product is only stored by eaches;

FIG. 29A shows an example process diagram for the execution of a rule for picking a non-modular product on feature display with a feature capacity at scheduled times to fill the sales floor capacity of the product based on feature capacity of the product and current sales floor quantity of the product, and the product is picked by cases;

FIG. 29B shows an example process diagram for the execution of a rule for picking a non-modular product on feature display with a feature capacity at scheduled times to fill the sales floor capacity of the product based on feature capacity of the product and current sales floor quantity of the product, and the product is picked by eaches;

FIG. 29C shows an example process diagram for the execution of a rule for picking a non-modular product on feature display with a feature capacity at scheduled times to fill the sales floor capacity of the product based on feature capacity of the product and current sales floor quantity of the product, and the product is only stored by eaches;

FIG. 30A shows an example process diagram for the execution of a rule for picking a modular product on feature display without a feature capacity at scheduled times to fill the sales floor capacity of the product based on feature capacity of the product and current sales floor quantity of the product, and the product is picked by cases;

FIG. 30B shows an example process diagram for the execution of a rule for picking a modular product on feature display without a feature capacity at scheduled times to fill the sales floor capacity of the product based on feature capacity of the product and current sales floor quantity of the product, and the product is picked by eaches;

FIG. 30C shows an example process diagram for the execution of a rule for picking a modular product on feature display without a feature capacity at scheduled times to fill the sales floor capacity of the product based on feature capacity of the product and current sales floor quantity of the product, and the product is only stored by eaches;

FIG. 31A shows an example process diagram for the execution of a rule for picking a non-modular product on feature display without a feature capacity at scheduled times to fill the sales floor capacity of the product based on feature capacity of the product and current sales floor quantity of the product, and the product is picked by cases;

FIG. 31B shows an example process diagram for the execution of a rule for picking a non-modular product on feature display without a feature capacity at scheduled times to fill the sales floor capacity of the product based on feature capacity of the product and current sales floor quantity of the product, and the product is picked by eaches;

FIG. 31C shows an example process diagram for the execution of a rule for picking a non-modular product on feature display without a feature capacity at scheduled times to fill the sales floor capacity of the product based on feature capacity of the product and current sales floor quantity of the product, and the product is only stored by eaches;

FIG. 32 shows an example process diagram for the execution of a rule for picking a modular product at a user initiated time based on the shelf capacity for the product;

FIG. 33A shows an example process diagram for the execution of a rule for picking a modular product on feature display at a user initiated time based on the shelf capacity, feature capacity, and current sales floor quantity, and the product is picked by cases;

FIG. 33B shows an example process diagram for the execution of a rule for picking a modular product on feature display at a user initiated time based on the shelf capacity, feature capacity, and current sales floor quantity, and the product is picked by eaches;

FIG. 33C shows an example process diagram for the execution of a rule for picking a modular product on feature display at a user initiated time based on the shelf capacity, feature capacity, and current sales floor quantity, and the product is only stored by eaches;

FIG. 34A shows an example process diagram for the execution of a rule for picking a modular product on feature display at a user initiated time based on the feature capacity and current sales floor quantity, and the product is picked by cases;

FIG. 34B shows an example process diagram for the execution of a rule for picking a modular product on feature display at a user initiated time based on the feature capacity and current sales floor quantity, and the product is picked by eaches;

FIG. 34C shows an example process diagram for the execution of a rule for picking a modular product on feature display at a user initiated time based on the feature capacity and current sales floor quantity, and the product is only stored by eaches;

FIG. 35A shows an example process diagram for the execution of a rule for picking a modular product on feature display without a feature capacity at a user initiated time based on the tracked sales of the product, and the product is picked by cases;

FIG. 35B shows an example process diagram for the execution of a rule for picking a modular product on feature display without a feature capacity at a user initiated time based on the tracked sales of the product, and the product is picked by eaches;

FIG. 35C shows an example process diagram for the execution of a rule for picking a modular product on feature display without a feature capacity at a user initiated time based on the tracked sales of the product, and the product is only stored by eaches;

FIG. 36A shows an example process diagram for the execution of a rule for picking a non-modular product on feature display without a feature capacity at a user initiated time based on tracked sales of the product, and the product is picked by eaches;

FIG. 36B shows an example process diagram for the execution of a rule for picking a non-modular product on feature display without a feature capacity at a user initiated time based on tracked sales of the product, and the product is picked by cases; and

FIG. 36C shows an example process diagram for the execution of a rule for picking a non-modular product on feature display without a feature capacity at a user initiated time based on tracked sales of the product, and the product is only stored by eaches.

### DETAILED DESCRIPTION

At least some of the aspects and embodiments disclosed herein relate to systems and processes for tracking the quantity of products available within a retail establishment, configuration of those systems to execute rules for replenishment of products available for sale at various locations within the retail establishment, and communication of instructions to employees for performing replenishment actions. Inventory management systems can be utilized to keep an accurate accounting of products available to be sold within a retail establishment. But it is appreciated that keeping an accurate count of products on-hand within a store does not always keep products in-stock at the locations where customers in search of a particular item are most apt to look for that item or in locations where customers that might be interested in a particular item are most likely to walk. Store employees are tasked with keeping shelves stocked with sufficient quantities of various products to meet the demand of customers in search of the goods they require. Various embodiments of an inventory management system described below provide a distributed computerized network capable of tracking the quantity of products available at various locations within the store and executing various types of rules that calculate quantities of individual products that employees should “pick” from a storage location within the retail establishment for replenishment at various display sites located on a sales floor. The systems and processes described in various embodiments execute a variety of rules that take into account stock quantities of a product at various locations, maximum capacities for products at various locations, rates of sale for a particular product, the size of “cases” in which collections of individual products are packaged when delivered to backroom storage, timing schedule of picks for greatest employee efficiency and product availability, as well as other metrics.

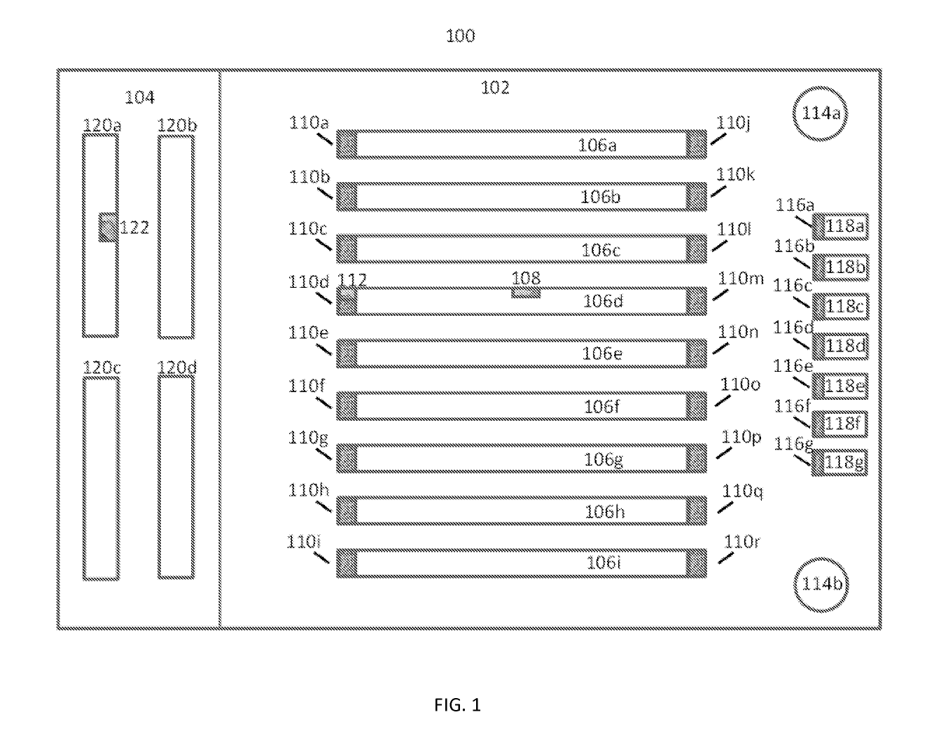

Referring to FIG. 1, an example retail establishment 100 can be divided into two main segments, a sales floor 102 that is accessible to customers and employees of the retail establishment and a backroom 104 that is only accessible to employees. The sales floor 102 can contain a number of distinct locations for the display of products that are made available for sale by the retail establishment. These on-sale locations can include main product display locations 106a-106i that can include aisles with shelves or racks for housing a product at its modular home, such as modular home 108. A modular home 108 will normally be defined to have a fixed capacity for housing a maximum quantity of a specific product during a specific time period. While changing the maximum capacity of a product's modular home is possible, a product's modular home normally stays at a fixed size during normal sales hours of operation.

A product can also be put on display for sale at feature locations, such as end aisle feature locations 110a-110r, open feature locations 114a-114b, and checkout aisle feature locations 116a-116g. Placing a product on display within a feature location can be used to highlight products to customers that normally would not browse the location of a product's modular home. A product placed within a feature location can be described as having a feature home, such as feature home 112. Feature locations located at the end of an aisle, such as feature locations 110a-110r, or at the feature locations 116a-116g of checkout counters 118a-118g, will normally have a fixed capacity, which can be defined as a feature capacity. Open feature locations, such as feature locations 114a-114b, can be described as feature locations without a feature capacity. The quantity of product units that can be placed on-sale in locations without a feature capacity have no relative limit in relation to the total number of product units that would normally be on-hand within the retail establishment.

Depending on the nature of a particular product, as well as the current demand for that particular product, a product can be placed on sale in any combination of a single modular home, multiple modular homes, a single feature location, and multiple feature locations. The feature locations can either have a feature capacity or not have a feature capacity. To keep a ready supply of products on-hand, a retail establishment normally maintains a backroom 104 that warehouses a supply of products not currently on display on a sales floor 102. The backroom 104 can include a number of storage areas 120a-120d that allocate storage locations 122 for particular products.

One embodiment of an inventory management and in-store replenishment system described below may provide an up-to-date accounting of the total quantity of each product on-hand (OH) within the entirety of the retail establishment, as well as the quantities of any particular product present within each of the locations of interest defined within the retail establishment, including the bin quantity available at a product's backroom (BR) storage location 122, the quantity, or shelf-capacity (SC), that can be displayed at a product's modular home location 108, and the quantity, or feature capacity (FC), that can be housed at a product's feature location 112 that has a feature capacity. By taking the difference of the total quantity of a product on-hand within the retail establishment and the total quantity of a product that is stored in the backroom, the amount of product available on the sales floor (SF) can be determined at any given time. In some embodiments of an inventory management and in-store replenishment system, a system can be used to track products that are on perpetual inventory (PI). Products on PI are products whose total quantity can be measured in terms of individual packaged units of a product on-hand. In other embodiments of an inventory management and in-store replenishment system, a system can be used to track products that are tracked by different metrics such as by total weight or measure of product on-hand.

One embodiment of an inventory management system presented below may include functionality for automating the determination of when replenishment activity should occur for various locations within a retail establishment, as well as communicating with employees via messages within a distributed computer network to provide instructions on the quantity of, and location for, product replenishment.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Various aspects and functions described herein may be implemented as specialized hardware or software components executing in one or more computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Consequently, examples are not limited to executing on any particular system or group of systems.

Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

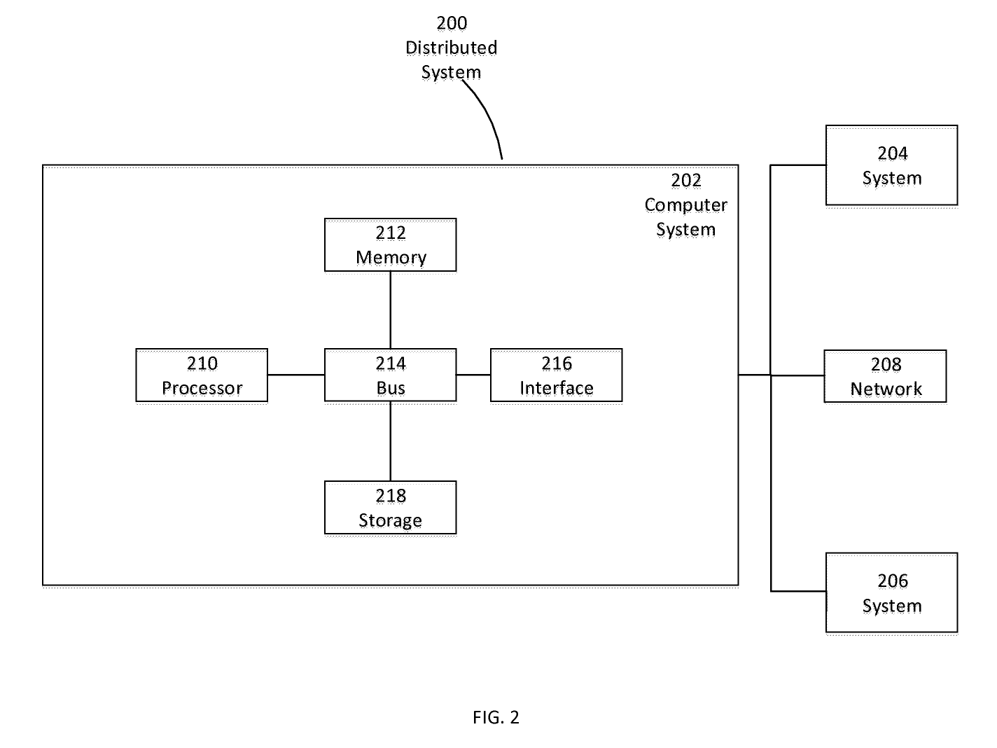

Referring to FIG. 2, there is illustrated a block diagram of a distributed computer system 200, in which various aspects and functions are practiced. As shown, the distributed computer system 200 includes one more computer systems that exchange information. More specifically, the distributed computer system 200 includes computer systems 202, 204 and 206. As shown, the computer systems 202, 204 and 206 are interconnected by, and may exchange data through, a communication network 208. The network 208 may include any communication network through which computer systems may exchange data. To exchange data using the network 208, the computer systems 202, 204 and 206 and the network 208 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the computer systems 202, 204 and 206 may transmit data via the network 208 using a variety of security measures including, for example, TLS, SSL or VPN. While the distributed computer system 200 illustrates three networked computer systems, the distributed computer system 200 is not so limited and may include any number of computer systems and computing devices, networked using any medium and communication protocol.

As illustrated in FIG. 2, the computer system 202 includes a processor 210, a memory 212, a bus 214, an interface 216 and data storage 218. To implement at least some of the aspects, functions and processes disclosed herein, the processor 210 performs a series of instructions that result in manipulated data. The processor 210 may be any type of processor, multiprocessor or controller. Some exemplary processors include commercially available processors such as an Intel Xeon, Itanium, Core, Celeron, or Pentium processor, an AMD Opteron processor, a Sun UltraSPARC or IBM Power5+ processor and an IBM mainframe chip. The processor 210 is connected to other system components, including one or more memory devices 212, by the bus 214. The memory 212 stores programs and data during operation of the computer system 202. Thus, the memory 212 may be a relatively high performance, volatile, random access memory such as a dynamic random access memory (DRAM) or static memory (SRAM). However, the memory 212 may include any device for storing data, such as a disk drive or other nonvolatile storage device. Various examples may organize the memory 212 into particularized and, in some cases, unique structures to perform the functions disclosed herein. These data structures may be sized and organized to store values for particular data and types of data.

Components of the computer system 202 are coupled by an interconnection element such as the bus 214. The bus 214 may include one or more physical busses, for example, busses between components that are integrated within a same machine, but may include any communication coupling between system elements including specialized or standard computing bus technologies such as IDE, SCSI, PCI and InfiniBand. The bus 214 enables communications, such as data and instructions, to be exchanged between system components of the computer system 202.

The computer system 202 also includes one or more interface devices 216 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 202 to exchange information and to communicate with external entities, such as users and other systems.

The data storage 218 includes a computer readable and writeable nonvolatile, or nontransitory, data storage medium in which instructions are stored that define a program or other object that is executed by the processor 210. The data storage 218 also may include information that is recorded, on or in, the medium, and that is processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller causes data to be read from the nonvolatile recording medium into another memory, such as the memory 212, that allows for faster access to the information by the processor 210 than does the storage medium included in the data storage 218. The memory may be located in the data storage 218 or in the memory 212, however, the processor 210 manipulates the data within the memory, and then copies the data to the storage medium associated with the data storage 218 after processing is completed. A variety of components may manage data movement between the storage medium and other memory elements and examples are not limited to particular data management components. Further, examples are not limited to a particular memory system or data storage system.

Although the computer system 202 is shown by way of example as one type of computer system upon which various aspects and functions may be practiced, aspects and functions are not limited to being implemented on the computer system 202 as shown in FIG. 2. Various aspects and functions may be practiced on one or more computers having a different architectures or components than that shown in FIG. 2. For instance, the computer system 202 may include specially programmed, special-purpose hardware, such as an application-specific integrated circuit (ASIC) tailored to perform a particular operation disclosed herein. While another example may perform the same function using a grid of several general-purpose computing devices running MAC OS System X with Motorola PowerPC processors or Intel Core processors and several specialized computing devices running proprietary hardware and operating systems.

The computer system 202 may be a computer system including an operating system that manages at least a portion of the hardware elements included in the computer system 202. In some examples, a processor or controller, such as the processor 210, executes an operating system. Examples of a particular operating system that may be executed include a Windows-based operating system, such as, Windows NT, Windows 2000 (Windows ME), Windows XP, Windows Vista, Windows 7 or Windows 8 operating systems, available from the Microsoft Corporation, a MAC OS System X or iOS operating systems available from Apple Computer, one of many Linux-based operating system distributions, for example, the Enterprise Linux operating system available from Red Hat Inc. or Android operating system available from Google Inc., a Solaris operating system available from Oracle Corporation, or a UNIX operating systems available from various sources. Many other operating systems may be used, and examples are not limited to any particular operating system.

The processor 210 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used.

Alternatively, functional, scripting, or logical programming languages may be used. Additionally, various aspects and functions may be implemented in a non-programmed environment, for example, documents created in HTML, XML or other format that, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements, e.g. specialized hardware, executable code, data structures or objects that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

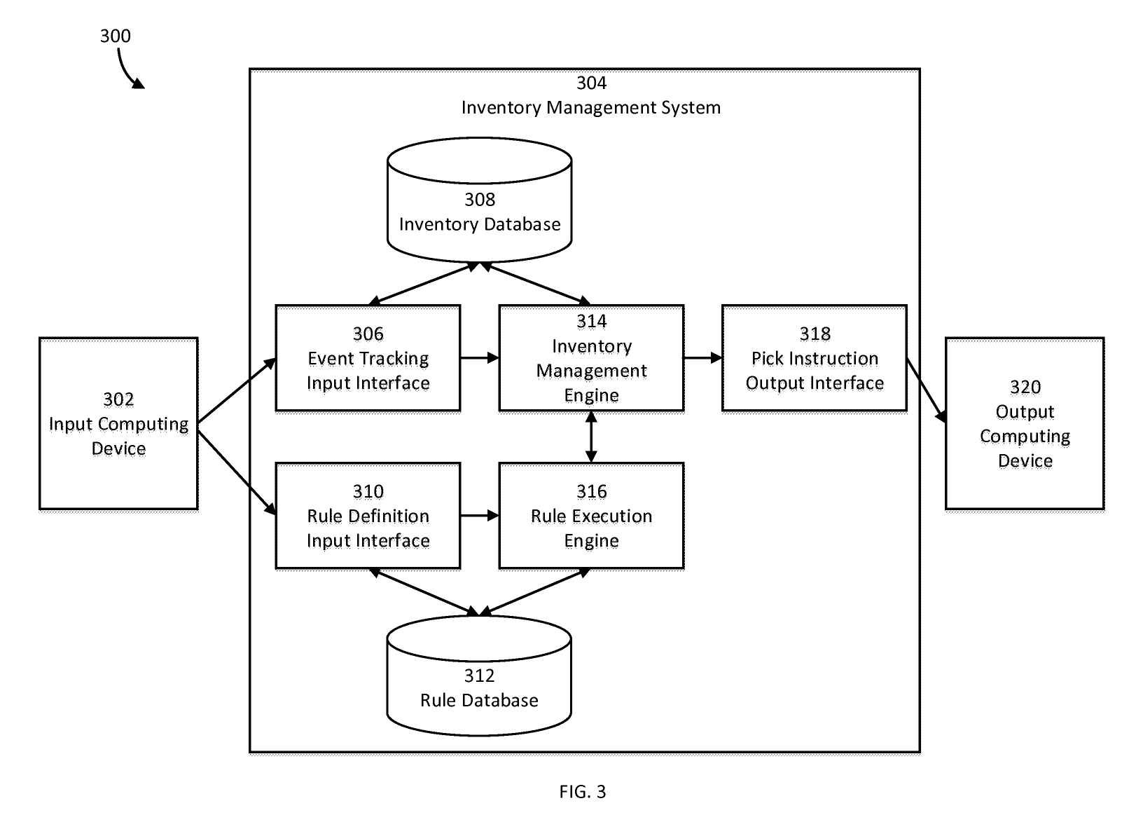

In some embodiments of an distributed inventory management system, there exist distinct logical components that execute unique functions as part of the overall inventory tracking, replenishment quantity calculation, and product picking instruction communication process. One example of the logical components included within such an inventory management system is included in FIG. 3. Referring to FIG. 3, a distributed computing network 300 includes an input computing device, such as input computing device 302, can accept input regarding the status of a particular product being offered for sale within the retail establishment. Examples of an input computing device 302 that can be incorporated as part of the overall inventory management system include PCs, tablets, and smart phones that incorporate applications with which an employee is intended to perform direct interaction via keyboard, mouse, touch-screen, or voice inputs. Example input computing devices can also include point-of-sale register systems that record goods as they are being sold, or scanning devices, such as hand-held or fixed laser scanning or RFID reader devices that can be used to read barcode or RFID information on product packaging as products are placed within various locations in a retail establishment.

The input computing device 302 is connected via a wired or wireless network within the distributed computing network 300 to at least one computer system 304 that executes components for accepting input information from the input computing device including an event tracking input interface 306 and a rule definition input interface 310. In some embodiments, the event tracking input interface 308 can record events such as the delivery of new product shipments to the backroom storage facility 104 of the retail establishment, the picking of products from the backroom storage facility 104, the placement of products within a modular home location, such as modular home 108, in various feature locations, such as 110a-110r, 114a-114b, or 116a-116g, or the sale of items recorded at checkout registers 118a-11g. In various embodiments, the rule definition input interface can provide functionality for accepting user input for the definition of product picking rules that can be entered into a rule picking definition application. A rule picking definition application as described herein incorporates interfaces for creating, modifying, and deleting product picking rules as well as defining and configuring the logic to be executed in association with any particular product picking rule. The rule picking definition application can be implemented, for example, as a native application executing on the input computing device 302 or as a web service executing on the inventory management system 304 and presented to the input computing device 302 through a web browser. Events received by the event tracking input interface 306 from the input computing device 302 trigger updates to stored values representing quantities of products available within a product inventory database 308.

The rule definition input interface 310 can provide functionality for defining various types of rules for product picking. Product picking rules can include rules for performing a “critical pick,” an “event pick,” and a “pick to fill.” Product picking rules can also be categorized as a “scheduled pick” or a “pick on-demand.” In some embodiments, a rule for a critical pick can be defined as a rule that compares the forecast of sales for a product to the current sales floor quantity for that product and issues instructions for picking a defined quantity of product when the forecast quantity exceeds the sales floor. In some embodiments, a rule for an event pick can be defined as a rule that can be executed as a result of a single event such as a product sale, a delivery of additional product quantity, or a change in the total quantity of product on-hand. In other embodiments, a rule for an event pick can be defined as a rule that can be executed as a result of a complex event in which one or more single events occur in particular sequence. In other embodiments the complex event associated with a rule for an event pick can be associated with a set of single events that occur in any sequence. In various embodiments, an event pick can use the same logic as found in a critical pick of comparing the forecast sales of an item to the quantity currently available on the sales floor, but may apply to items that have had a delivery, an on-hand quantity change, or a sale.

In some embodiments, a rule for a pick to fill can be defined as a rule that can be executed to fill the sales floor to the current capacity defined for the zero or more modular home locations and zero or more feature locations currently allocated to a particular product. In some embodiments, a picking rule can be defined as a “scheduled pick,” which can be a pick to be executed by an employee at a pre-determined time. In some embodiments, a rule such as a pick to fill often can be configured as a scheduled pick, as filling the available sales floor capacity for a particular product could be most efficiently performed during an off-peak hour of business when many customers are not present in the retail establishment. In various embodiments, a picking rule can also be defined as a “pick on-demand,” which can be a pick to be executed at a time determined by an employee. As part of a pick on-demand, the employee determines both the time that a pick is to occur and the quantity of product to be picked for items in a particular grouping. In some embodiments, the groupings used when executing a pick on-demand can include products in a same product category, a same department, a same aisle, a same source location within the backroom storage facility 104 or the same location on the sales floor 102.

In some embodiments, as a part of executing a rule for a scheduled pick, the rule can include logic for determining the quantity of a product to be transferred from the backroom storage 104 to the sales floor 102 for placement in various modular home locations and feature locations. In various embodiments, the logic for determining the quantity of a product to be picked can include information regarding the size of a “case pack” (CP) for a product. The case pack is the quantity of a product that is included within the bulk packaging units delivered to the retail establishment and stored within a backroom storage location, such as storage location 122. In some embodiments, a picking rule can include a combination of a scheduled time and a comparison of sales floor quantity to case pack size to determine the most efficient process for issuing pick instructions to an employee. In other embodiments, a picking rule can ignore the case pack size of a product and can instruct employees to pick individual product units, which can be referred to as “eaches,” from storage for placement at modular home locations and feature locations on the sales floor 102.

In various embodiments, upon receiving picking rule definitions from the input computing device 302, the rule definition input interface 308 stores these rule definitions in a picking rule database 312, where they are made available for later use by a rule execution engine 316. The event tracking input interface 306 can also communicate with an inventory management engine 314 that performs the high level logic to determine which picking rules should be executed based on the events that have been received by the event tracking input interface 306.

Upon determining the appropriate picking rules for execution based on the events received, the inventory management engine communicates with a rule execution engine 316 that performs the execution of picking rules the engine can retrieve from the picking rule database 312. Upon execution of the appropriate picking rules, the picking rule execution engine 316 can return instructions to the inventory management engine 314 for the appropriate pick to be performed by an employee. The inventory management engine can then instruct a pick instruction output interface 318 to report the instructions for a pick to be performed to an output computing device 320. The output computing device 320 can include a variety of different computing platforms, including PCs, tablets, phones, smartphones, kiosks, and point-of-sale register systems. The message for an employee to perform a pick can be delivered in a variety of message formats including messages posted within a native application on the output computing device 320, message posted within a web service hosted by the pick instruction output interface 318 and accessed by the output computing device 320, e-mail messages sent to an employee e-mail account, SMS messages sent to an output computing device 320, as well as a variety of other electronic messaging formats. In some embodiments, the output computing device 320 can be the same device as the input computing device 302.

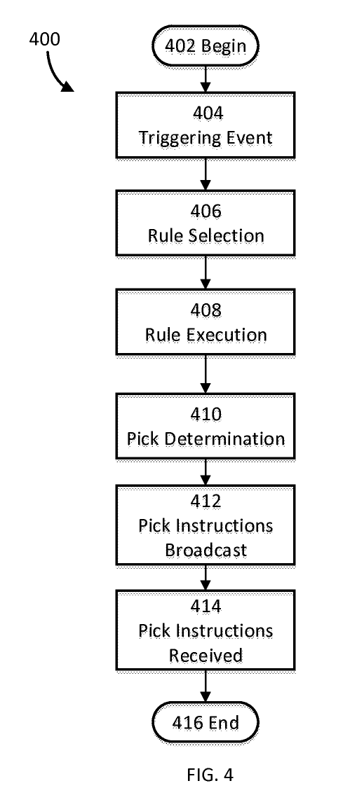

FIG. 4 shows a representation of one example process by which the system in FIG. 3 can execute a picking rule in response to an event, and then issue picking instructions based on the executed rule. Process 400 begins at act 402. At act 404, a triggering event, such as a product delivery, a product sale, or a change in on-hand product quantity can communicate the need for rule execution from the event tracking input interface 306 to the inventory management engine 314, as discussed previously above. In act 406, the inventory management engine 314 can select the appropriate picking rules to be executed based on the triggering event. In act 408, the inventory management engine 314 can instruct the rule execution engine 316 to execute the selected picking rules, which then executes the selected picking rules. In act 410, the executed picking rules can determine the appropriate quantity of a product that need to be picked from storage based on the outcome of rule execution. In some embodiments, the executed rule might not result in an actual product pick being required. In act 412, the instructions for performing a product pick at an appropriate time, and in an appropriate quantity, can be sent from the inventory management engine 314 to the pick instruction output interface 318 where those instructions are broadcast in turn to any appropriate output computing device 320. In act 414, the broadcast pick instructions can be received by the appropriate output computing device 320 where they can be viewed by the employee that performs the product pick. In some embodiments, the employee performing the pick can enter an acknowledgement when the pick has been performed and the quantity of the appropriate product has been updated at the product's modular home location or feature location.

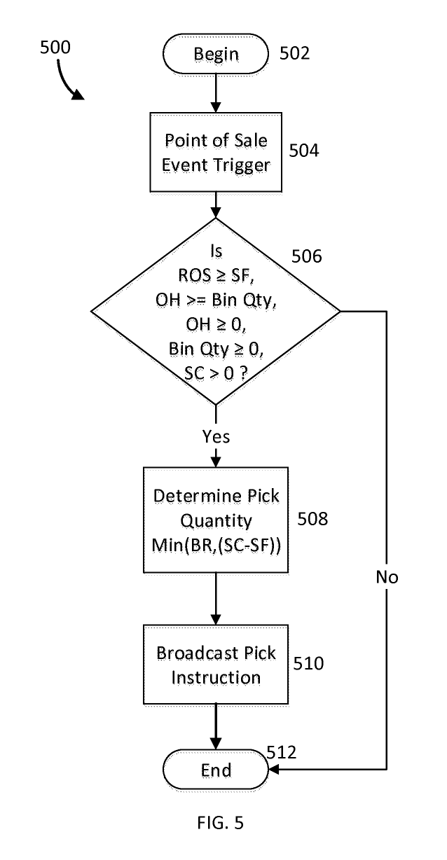

By executing combinations of various picking rules, described in more detail below in relation to FIG. 5-FIG. 36, various iterations of rule execution can ensure that a particular product is available for customers on the sales floor in the most efficient manner possible. As one example, in a multiple location pick, the location with the lowest capacity can be the most at risk location and would drive the likelihood that an associated pick rule can be executed. This example illustrates a weighting rule that can be applied to the concurrent execution of multiple picking rules for a particular product, where a specific location choice could produce better efficiency than generalized picking, since a location with the lowest stock can be more likely to go out of stock prior to a pick being generalized.

FIG. 5 presents an example implementation of a critical pick rule for modular items that can be triggered by a sale of an item, and when the rate of sale of the product is greater than the sales floor quantity of the product. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 5 is a scheduled rule that is intended for execution immediately upon sale of an associated product or other trigger event described above. The rule presented in FIG. 5 is not necessarily to be associated with a vendor managed product, but is associated with a product that has been binned. The rule presented in FIG. 5 is associated with products that are on perpetual inventory (PI), and is associated with products that have a modular home location or multiple modular home locations, but not with products that are on feature display. If the employee that receives pick instructions does not execute the pick by a predefined expiration time associated with this rule, then the instruction for executing the pick expires. The process 500 of executing the rule in FIG. 5 begins with act 502. In act 504, a point of sale triggering event or other triggering event occurs, that instructs the inventory management system 304 to execute this rule. In act 506, required conditions for executing the associated pick are checked. The required conditions for this pick rule include:

1) Is the rate of sale of the product greater than or equal to the sales floor quantity of the product? (ROS≧SF)
2) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the shelf capacity of the product's modular home greater than zero? (SC>0)
If any of these conditions do not return in the affirmative, then the execution of the rule exits. If all of these conditions return in the affirmative, the execution of the rule continues. In act 508, the quantity of product to be picked is determined to be either the backroom quantity of the product in storage or the difference of the shelf capacity of the product's modular home and the quantity of the product currently on the sales floor, whichever is less (Min(BR,(SC−SF))). In some embodiments of the execution of this rule, the picking of product from storage can be performed by picking cases. In other embodiments of the execution of this rule, the picking of product from storage can be performed by picking eaches. In act 510, upon determination of the appropriate quantity of product for the current pick, the pick instructions are broadcast by the pick instruction output interface 318 to the appropriate output computing device 320. In act 512, execution of the rule ends.

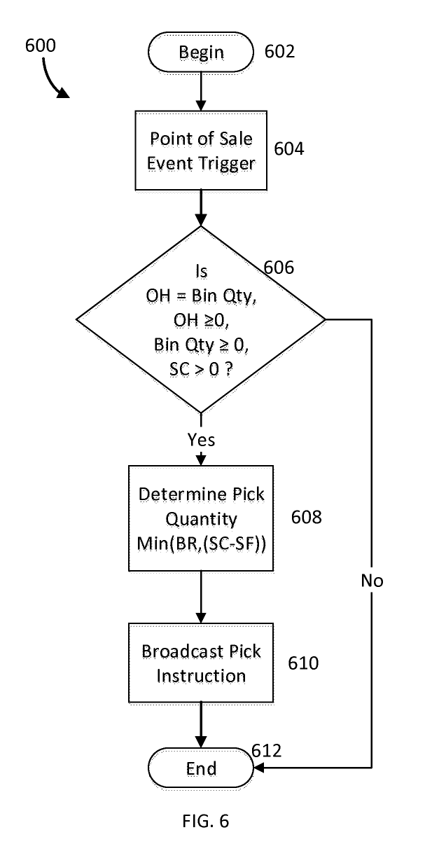

FIG. 6 presents an example implementation of a critical pick rule for modular items that can be triggered by a sale of an item, and when the total on-hand product quantity is equal to the bin quantity. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 6 is a scheduled rule that is intended for execution immediately upon sale of an associated product or other trigger event described above. The rule presented in FIG. 6 is not necessarily to be associated with a vendor managed product, but is associated with a product that has been binned. The rule presented in FIG. 6 is associated with products that are on PI, and is associated with products that have a modular home, but not with products that are on feature display. If the employee that receives pick instructions does not execute the pick by a predefined expiration time associated with this rule, then the instruction for executing the pick expires. The process 600 of executing the rule in FIG. 6 begins with act 602. In act 604, a point of sale triggering event or other triggering event occurs, that instructs the inventory management system 304 to execute this rule. In act 606, required conditions for executing the associated pick are checked. The required conditions for this pick rule include:

1) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the shelf capacity of the product's modular home greater than zero? (SC>0)
If any of these conditions do not return in the affirmative, then the execution of the rule exits. If all of these conditions return in the affirmative, the execution of the rule continues. In act 608, the quantity of product to be picked is determined to be either the backroom quantity of the product in storage or the difference of the shelf capacity of the product's modular home and the quantity of the product currently on the sales floor, whichever is less (Min(BR,(SC−SF))). In some embodiments of the execution of this rule, the picking of product from storage can be performed by picking cases. In other embodiments of the execution of this rule, the picking of product from storage can be performed by picking eaches. In act 610, upon determination of the appropriate quantity of product for the current pick, the pick instructions are broadcast by the pick instruction output interface 318 to the appropriate output computing device 320. In act 612, execution of the rule ends.

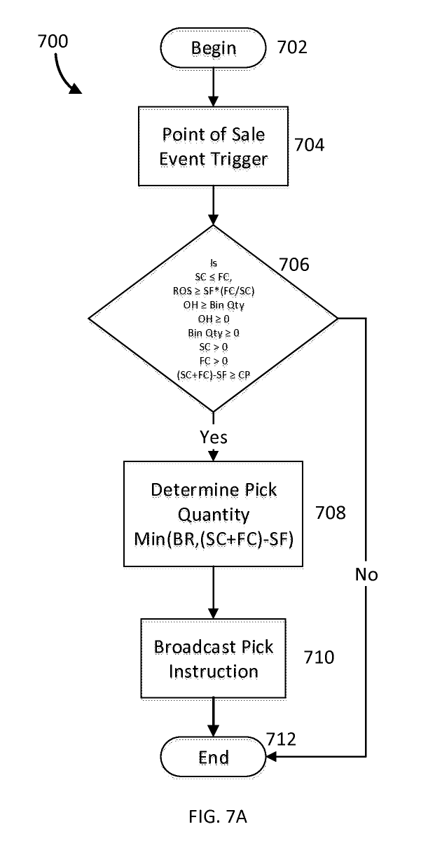

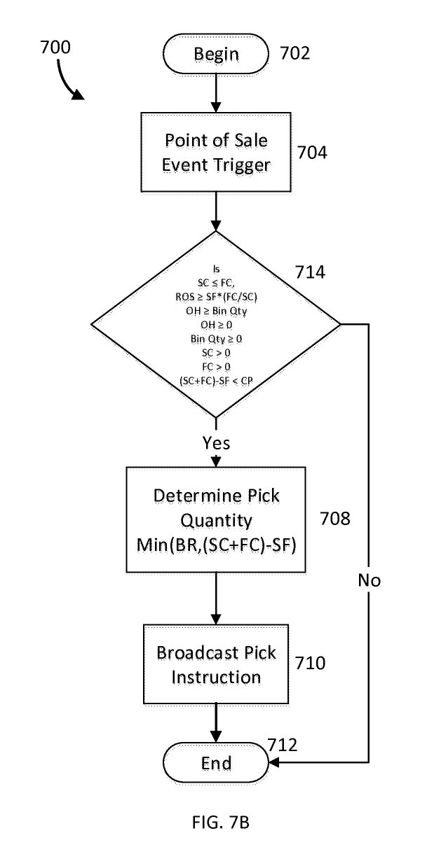

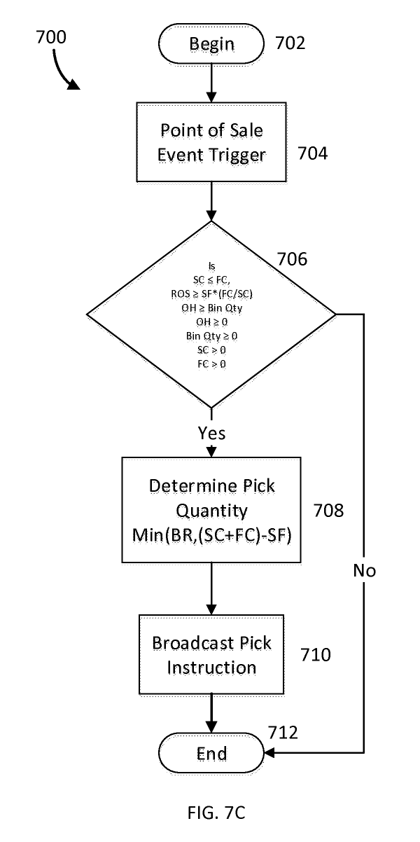

FIG. 7A presents an example implementation of a critical pick rule for modular items on feature display that can be triggered by a sale of an item, and when the shelf capacity of the product is less than or equal to the feature capacity. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 7A is a scheduled rule that is intended for execution immediately upon sale of an associated product, or other trigger event described above, and when the rate of sale of the product is greater than the sales floor quantity of the product. The rule presented in FIG. 7A is not necessarily to be associated with a vendor managed product, but is associated with a product that has been binned. The rule presented in FIG. 7A is associated with products that are on PI, and is associated with products that have a modular home. If the employee that receives pick instructions does not execute the pick by a predefined expiration time associated with this rule, then the instruction for executing the pick expires. The process 700 of executing the rule in FIG. 7A begins with act 702. In act 704, a point of sale triggering event occurs, that instructs the inventory management system 304 to execute this rule. In act 706, required conditions for executing the associated pick are checked. The required conditions for this pick rule include:

1) Is the shelf capacity for the product less than or equal to the feature capacity of the product? (SC≦FC)
2) Is the rate of sale of the product greater than or equal to the sales floor quantity of the product multiplied by the ratio of the shelf capacity of the product to the feature capacity of the product? (ROS≧SF*(FC/SC))
3) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the shelf capacity of the product's modular home greater than zero? (SC>0)
6) Is the feature capacity of the product greater than zero? (FC>0)
7) Is the difference of the sum of the shelf capacity and the feature capacity with the current sales floor quantity greater than or equal to the case pack size of the product? ((SC+FC)−SF≧CP)
If any of these conditions do not return in the affirmative, then the execution of the rule exits. If all of these conditions return in the affirmative, the execution of the rule continues. In this example, the condition 7 above results in cases being picked from the backroom storage location 122. In act 708, the quantity of product to be picked is determined to be either the backroom quantity of the product in storage or the difference of the sum of the shelf capacity of the products modular home and feature capacity of the product with the quantity of the product on the sales floor, whichever is less (Min(BR,(SC+FC)−SF)). In act 710, upon determination of the appropriate quantity of product for the current pick, the pick instructions are broadcast by the pick instruction output interface 318 to the appropriate output computing device 320. In act 712, execution of the rule ends.

FIG. 7B presents a slightly altered example of the rule described in FIG. 7A, where act 706 of FIG. 7A is replaced by act 714. In act 714, conditions 1-6 are unchanged from act 706, but condition 7 can be expressed as follows:

7) Is the difference of the sum of the shelf capacity and the feature capacity with the current sales floor quantity less than the case pack size of the product? ((SC+FC)−SF<CP)
If any of the conditions do not return in the affirmative, then the execution of the rule exits. If all of these conditions return in the affirmative, then the execution of the rule continues. In this example, the altered condition 7 in act 714 results in eaches being picked from the backroom storage location.

FIG. 7C presents another slightly altered example of the rule described in FIG. 7A, where act 706 of FIG. 7A is replaced by act 716. In act 716, conditions 1-6 are unchanged from act 706, but there is no condition 7. The rule presented within FIG. 7C is applicable when the product is not stored by cases within the storage location 122, but is only stored as individual product units, and must be picked by eaches.

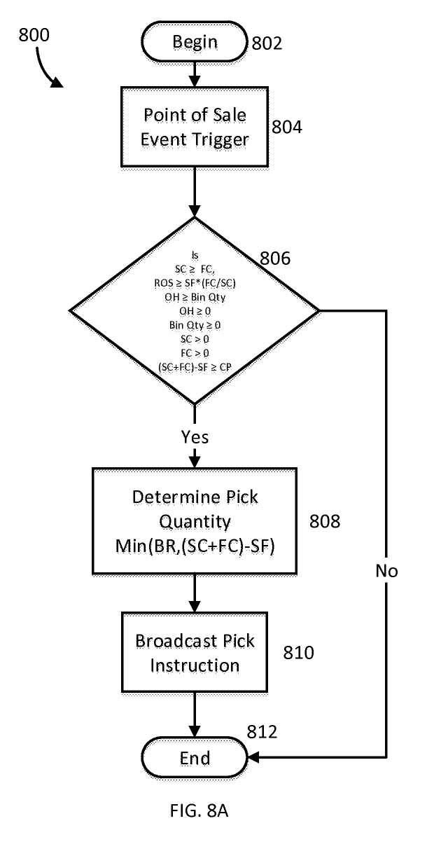

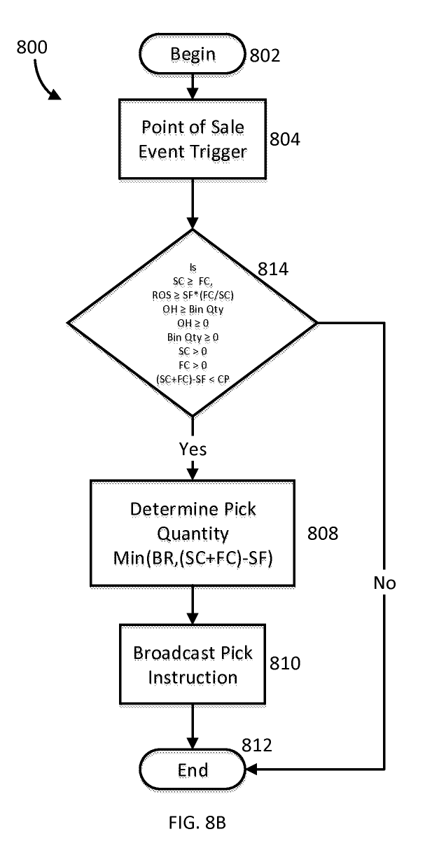

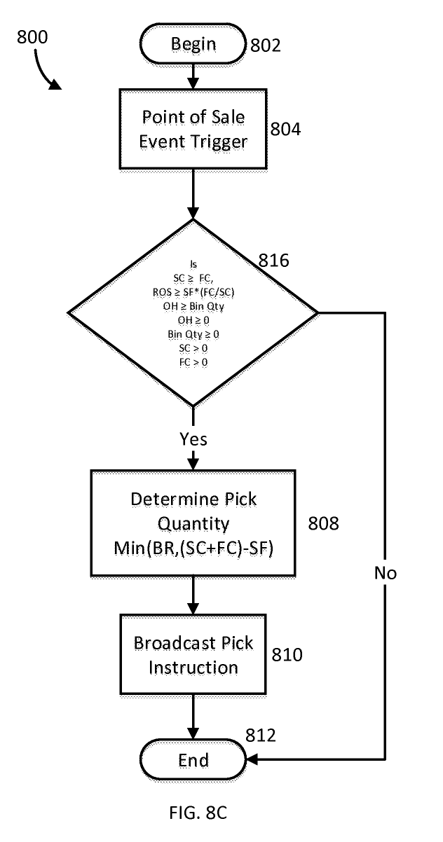

FIG. 8A presents an example implementation of a critical pick rule for modular items on feature display that can be triggered by a sale of an item, and when the shelf capacity of the product is greater than or equal to the feature capacity. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 8A is a scheduled rule that is intended for execution immediately upon sale of an associated product, or other trigger event described above, and when the rate of sale of the product is greater than the sales floor quantity of the product. The rule presented in FIG. 8A is not necessarily to be associated with a vendor managed product, but is associated with a product that has been binned. The rule presented in FIG. 8A is associated with products that are on PI, and is associated with products that have a modular home. If the employee that receives pick instructions does not execute the pick by a predefined expiration time associated with this rule, then the instruction for executing the pick expires. The process 800 of executing the rule in FIG. 8A begins with act 802. In act 804, a point of sale triggering event occurs, that instructs the inventory management system 304 to execute this rule. In act 806, required conditions for executing the associated pick are checked. The required conditions for this pick rule include:

1) Is the shelf capacity for the product less than or equal to the feature capacity of the product? (SC≧FC)
2) Is the rate of sale of the product greater than or equal to the sales floor quantity of the product multiplied by the ratio of the shelf capacity of the product to the feature capacity of the product? (ROS≧SF*(FC/SC))
3) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the shelf capacity of the product's modular home greater than zero? (SC>0)
6) Is the feature capacity of the product greater than zero? (FC>0)
7) Is the difference of the sum of the shelf capacity and the feature capacity with the current sales floor quantity less than the case pack size of the product? ((SC+FC)−SF≧CP)
If any of these conditions does not return in the affirmative, then the execution of the rule exits. If all of these conditions return in the affirmative, the execution of the rule continues. In this example, the condition 7 above results in cases being picked from the backroom storage location 122. In act 808, the quantity of product to be picked is determined to be either the backroom quantity of the product in storage or the difference of the sum of the shelf capacity of the products modular home and feature capacity of the product with the quantity of the product on the sales floor, whichever is less (Min(BR,(SC+FC)−SF)). In act 810, upon determination of the appropriate quantity of product for the current pick, the pick instructions are broadcast by the pick instruction output interface 318 to the appropriate output computing device 320. In act 812, execution of the rule ends.

FIG. 8B presents a slightly altered example of the rule described in FIG. 8A, where act 806 of FIG. 8A is replaced by act 814. In act 814, conditions 1-6 are unchanged from act 806, but condition 7 can be expressed as follows:

7) Is the difference of the sum of the shelf capacity and the feature capacity with the current sales floor quantity less than the case pack size of the product? ((SC+FC)−SF<CP)
If any of the conditions do not return in the affirmative, then the execution of the rule exits. If all of these conditions return in the affirmative, then the execution of the rule continues. In this example, the altered condition 7 in act 814 results in eaches being picked from the backroom storage location.

FIG. 8C presents another slightly altered example of the rule described in FIG. 8A, where act 806 of FIG. 8A is replaced by act 816. In act 816, conditions 1-6 are unchanged from act 806, but there is no condition 7. The rule presented within FIG. 8C is applicable when the product is not stored by cases within the storage location 122, but is only stored as individual product units, and must be picked by eaches.

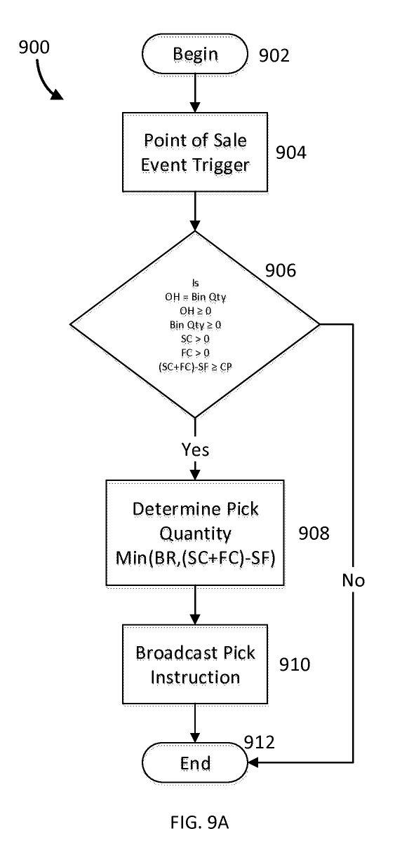

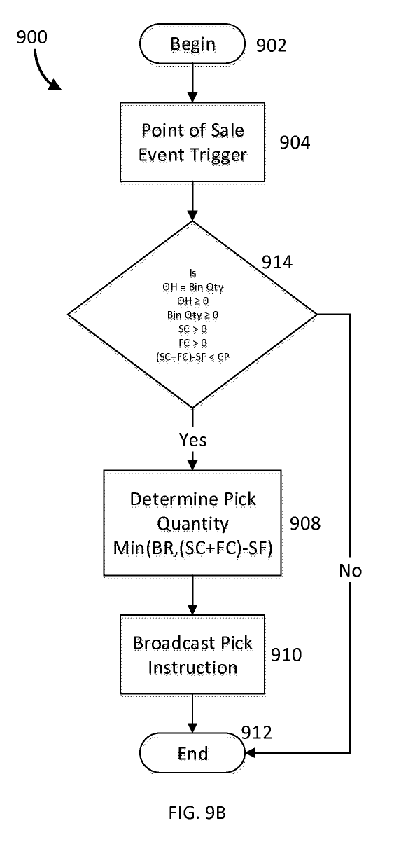

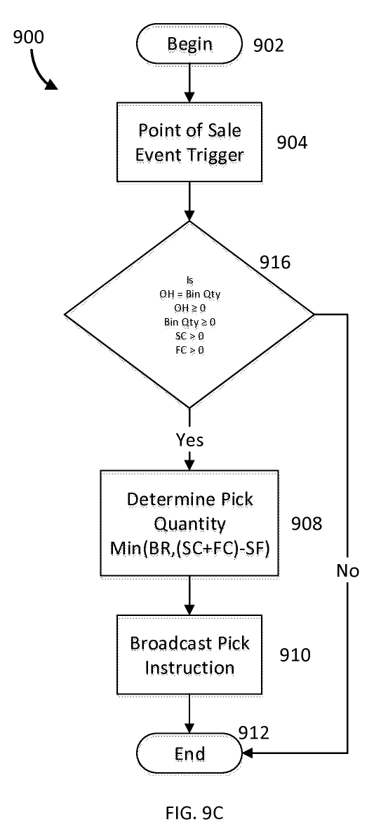

FIG. 9A presents an example implementation of a critical pick rule for modular items on feature display that can be triggered by a sale of an item, and when the total quantity of the product on-hand equals the bin quantity. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 9A is a scheduled rule that is intended for execution immediately upon sale of an associated product, or other trigger event described above. The rule presented in FIG. 9A is not necessarily to be associated with a vendor managed product, but is associated with a product that has been binned. The rule presented in FIG. 9A is associated with products that are on PI, and is associated with products that have a modular home. If the employee that receives pick instructions does not execute the pick by a predefined expiration time associated with this rule, then the instruction for executing the pick expires. The process 900 of executing the rule in FIG. 9A begins with act 902. In act 904, a point of sale triggering event occurs, that instructs the inventory management system 304 to execute this rule. In act 906, required conditions for executing the associated pick are checked. The required conditions for this pick rule include:

1) Is the total on-hand quantity of the product equal to the bin quantity of the product? (OH=BR)
3) Is the on-hand quantity of the product greater than or equal to zero? (OH≧0)
4) Is the bin quantity of the product greater than or equal to zero? (BR≧0)
5) Is the shelf capacity of the product's modular home greater than zero? (SC>0)
6) Is the feature capacity of the product greater than zero? (FC>0)
7) Is the difference of the sum of the shelf capacity and the feature capacity with the current sales floor quantity greater than or equal to the case pack size of the product? ((SC+FC)−SF≧CP)
If any of these conditions does not return in the affirmative, then the execution of the rule exits. If all of these conditions return in the affirmative, the execution of the rule continues. In this example, the condition 7 above results in cases being picked from the backroom storage location 122. In act 908, the quantity of product to be picked is determined to be either the backroom quantity of the product in storage or the difference of the sum of the shelf capacity of the products modular home and feature capacity of the product with the quantity of the product on the sales floor, whichever is less (Min(BR,(SC+FC)−SF)). In act 910, upon determination of the appropriate quantity of product for the current pick, the pick instructions are broadcast by the pick instruction output interface 318 to the appropriate output computing device 320. In act 912, execution of the rule ends.

FIG. 9B presents a slightly altered example of the rule described in FIG. 9A, where act 906 of FIG. 9A is replaced by act 914. In act 914, conditions 1-6 are unchanged from act 906, but condition 7 can be expressed as follows:

7) Is the difference of the sum of the shelf capacity and the feature capacity with the current sales floor quantity less than the case pack size of the product? ((SC+FC)−SF<CP)
If any of the conditions do not return in the affirmative, then the execution of the rule exits. If all of these conditions return in the affirmative, then the execution of the rule continues. In this example, the altered condition 7 in act 914 results in eaches being picked from the backroom storage location.

FIG. 9C presents another slightly altered example of the rule described in FIG. 9A, where act 906 of FIG. 9A is replaced by act 916. In act 916, conditions 1-6 are unchanged from act 906, but there is no condition 7. The rule presented within FIG. 9C is applicable when the product is not stored by cases within the storage location 122, but is only stored as individual product units, and must be picked by eaches.

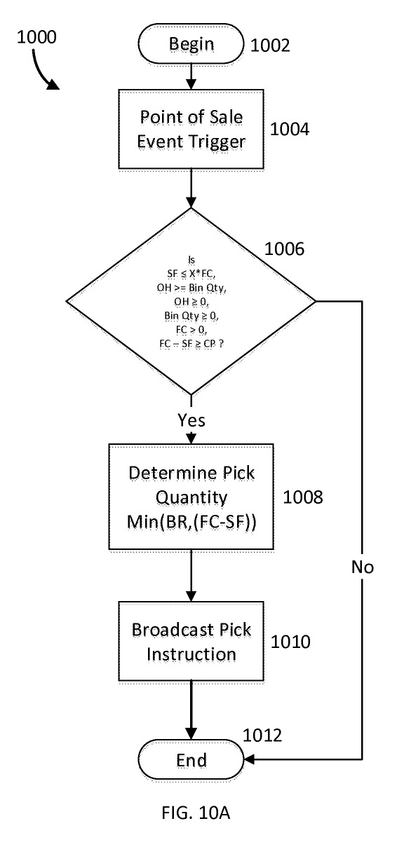

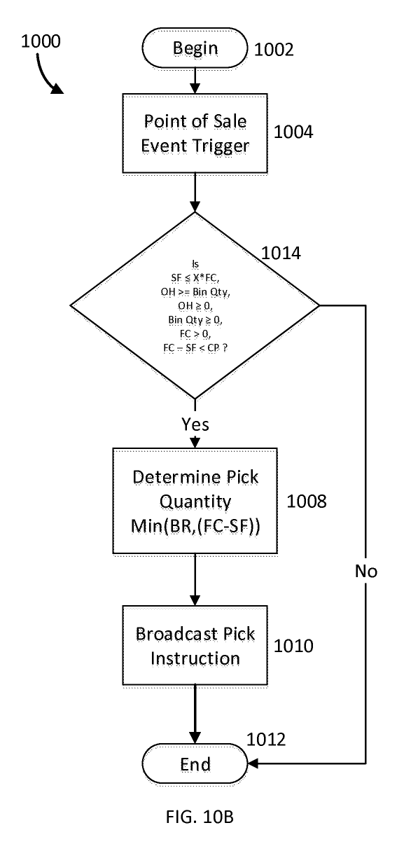

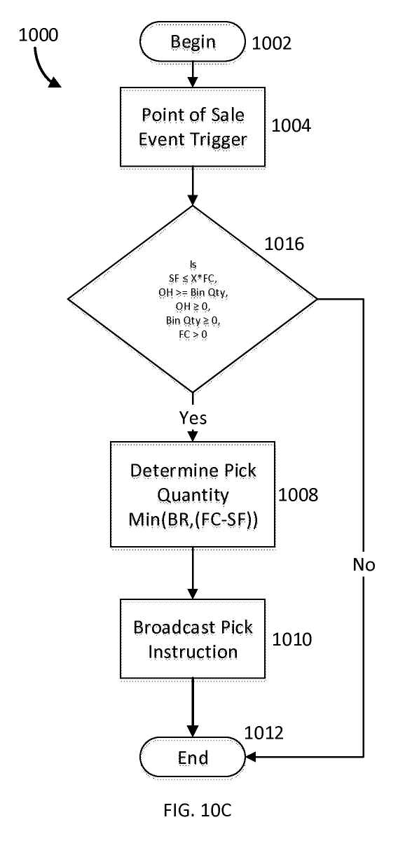

FIG. 10A presents an example implementation of a critical pick rule for non-modular items on feature display that can be triggered by a sale of a product, and when the sales floor quantity of the product is less than a predefined percentage X of the feature capacity of the product, for example 60% of the feature capacity of the product. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 10A is a scheduled rule that is intended for execution immediately upon sale of an associated product, or other trigger event described above. The rule presented in FIG. 10A is not necessarily to be associated with a vendor managed product, but is associated with a product that has been binned. The rule presented in FIG. 10A is associated with products that are on PI. If the employee that receives pick instructions does not execute the pick by a predefined expiration time associated with this rule, then the instruction for executing the pick expires. The process 1000 of executing the rule in FIG. 10A begins with act 1002. In act 1004, a point of sale triggering event occurs, that instructs the inventory management system 304 to execute this rule. In act 1006, required conditions for executing the associated pick are checked. The required conditions for this pick rule include:

1) Is the sales floor quantity of the product less than or equal to a predefined percentage of the feature capacity? (SF≦X*FC)
Is the shelf capacity for the product less than or equal to the feature capacity of the product?
2) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the feature capacity of the product greater than zero? (FC>0)
6) Is the difference of the feature capacity and the sales floor quantity greater than or equal to the size of the case pack for the product? (FC−SF≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 1008, the quantity of product to be picked is determined to be either the backroom quantity of the product in storage or the difference of the shelf capacity of the product's modular home and the quantity of the product currently on the sales floor, whichever is less (Min(BR,FC−SF)). In act 1010, upon determination of the appropriate quantity of product for the current pick, the pick instructions are broadcast by the pick instruction output interface 318 to the appropriate output computing device 320. In act 1012, execution of the rule ends.

FIG. 10B presents a slightly altered example of the rule described in FIG. 10A, where act 1006 of FIG. 10A is replaced by act 1014. In act 1014, conditions 1-5 are unchanged from act 1006, but condition 6 can be expressed as follows:

6) Is the difference of the feature capacity and the sales floor quantity less than the size of the case pack for the product? (FC−SF<CP)
If any of the conditions do not return in the affirmative, then the execution of the rule exits. If all of these conditions return in the affirmative, then the execution of the rule continues. In this example, the altered condition 6 in act 1014 results in eaches being picked from the backroom storage location.

FIG. 10C presents another slightly altered example of the rule described in FIG. 10A, where act 1006 of FIG. 10A is replaced by act 1016. In act 1016, conditions 1-5 are unchanged from act 1006, but there is no condition 6. The rule presented within FIG. 10C is applicable when the product is not stored by cases within the storage location 122, but is only stored as individual product units, and must be picked by eaches.

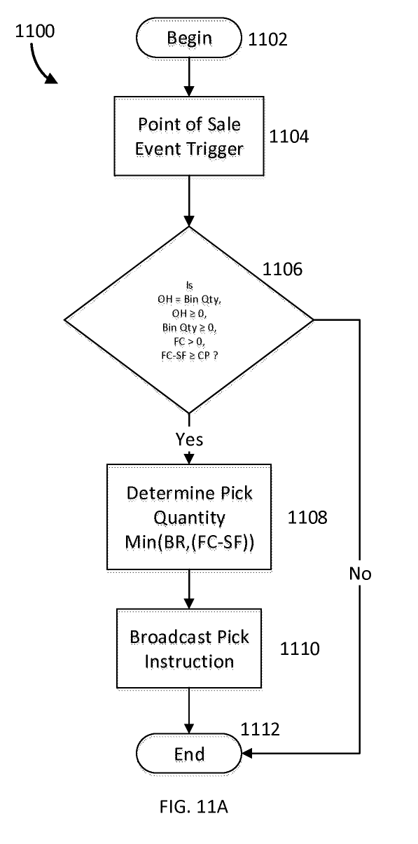

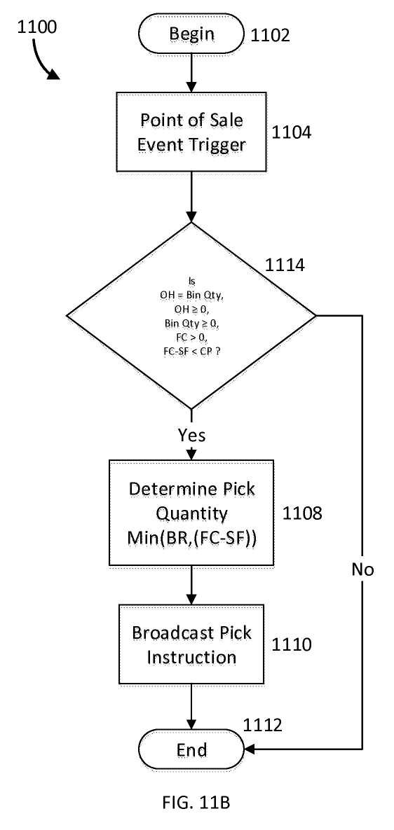

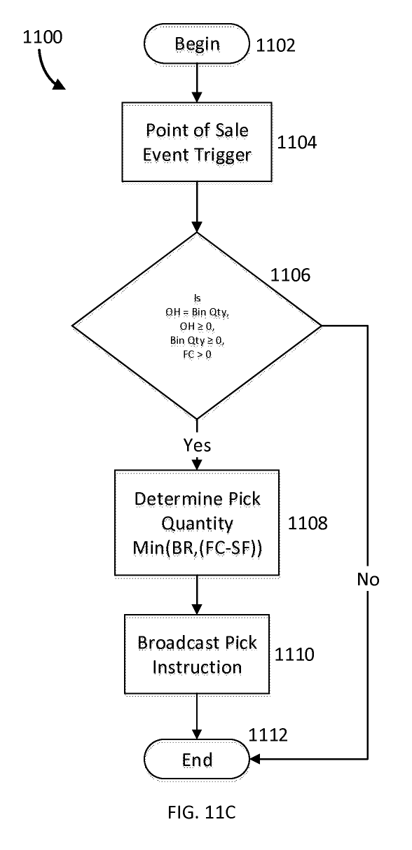

FIG. 11A presents an example implementation of a critical pick rule for non-modular items on feature display that can be triggered by a sale of a product, and when the total on-hand product quantity equals the bin quantity of the product. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 11A is a scheduled rule that is intended for execution immediately upon sale of an associated product, or other trigger event described above. The rule presented in FIG. 11A is not necessarily to be associated with a vendor managed product, but is associated with a product that has been binned. The rule presented in FIG. 11A is associated with products that are on PI. If the employee that receives pick instructions does not execute the pick by a predefined expiration time associated with this rule, then the instruction for executing the pick expires. The process 1100 of executing the rule in FIG. 11A begins with act 1102. In act 1104, a point of sale triggering event occurs, that instructs the inventory management system 304 to execute this rule. In act 1106, required conditions for executing the associated pick are checked. The required conditions for this pick rule include:

1) Is the total on-hand quantity of the product equal to the bin quantity of the product? (OH=BR)
2) Is the on-hand quantity of the product greater than or equal to zero? (OH≧0)
3) Is the bin quantity of the product greater than or equal to zero? (BR≧0)
4) Is the feature capacity of the product greater than zero? (FC>0)
5) Is the difference of the feature capacity and the sales floor quantity greater than or equal to the size of the case pack for the product? (FC−SF≧CP)
If any of these conditions does not return in the affirmative, then the execution of the rule exits. If all of these conditions return in the affirmative, the execution of the rule continues. In this example, the condition 5 above results in cases being picked from the backroom storage location 122. In act 1108, the quantity of product to be picked is determined to be either the backroom quantity of the product in storage or the difference of the shelf capacity of the product's modular home and the quantity of the product currently on the sales floor, whichever is less (Min(BR,FC−SF)). In act 1110, upon determination of the appropriate quantity of product for the current pick, the pick instructions are broadcast by the pick instruction output interface 318 to the appropriate output computing device 320. In act 1112, execution of the rule ends.

FIG. 11B presents a slightly altered example of the rule described in FIG. 11A, where act 1106 of FIG. 11A is replaced by act 1114. In act 1114, conditions 1-5 are unchanged from act 1106, but condition 5 can be expressed as follows:

5) Is the difference of the feature capacity and the sales floor quantity less than the size of the case pack for the product? (FC−SF<CP)
If any of the conditions do not return in the affirmative, then the execution of the rule exits. If all of these conditions return in the affirmative, then the execution of the rule continues. In this example, the altered condition 5 in act 1114 results in eaches being picked from the backroom storage location.

FIG. 11C presents another slightly altered example of the rule described in FIG. 11A, where act 1106 of FIG. 11A is replaced by act 1116. In act 1116, conditions 1-4 are unchanged from act 1106, but there is no condition 5. The rule presented within FIG. 11C is applicable when the product is not stored by cases within the storage location 122, but is only stored as individual product units, and must be picked by eaches.

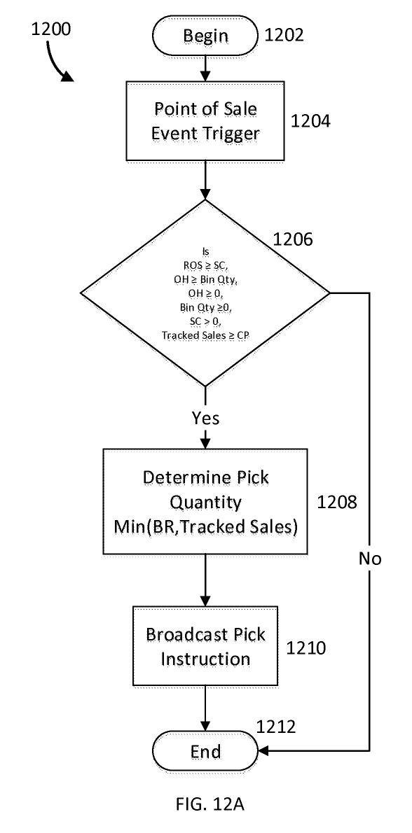

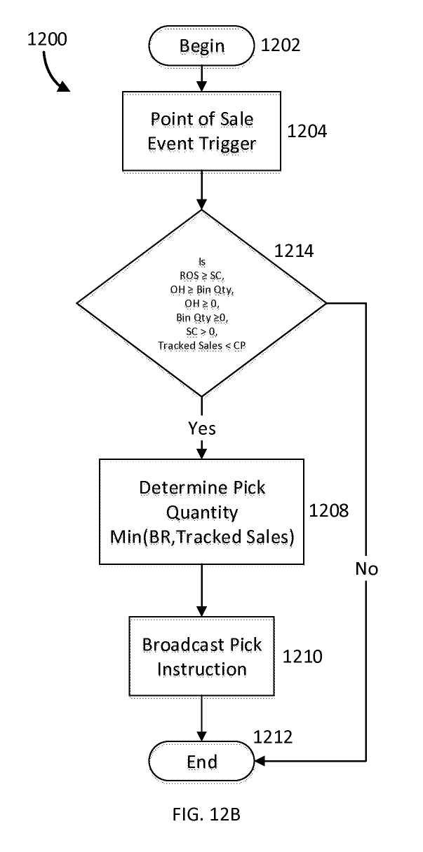

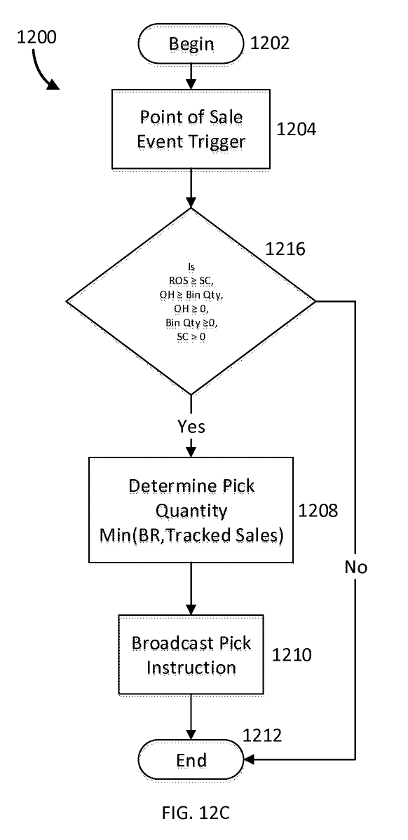

FIG. 12A presents an example implementation of a critical pick rule for modular items on feature display without a feature capacity that can be triggered by a sale of an item, and when the rate of sale of the product is greater than the shelf capacity. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 12A is a scheduled rule that is intended for execution immediately upon sale of an associated product, or other trigger event described above. The rule presented in FIG. 12A is not necessarily to be associated with a vendor managed product, but is associated with a product that has been binned. The rule presented in FIG. 12A is associated with products that are on PI, and is associated with products that have a modular home. If the employee that receives pick instructions does not execute the pick by a predefined expiration time associated with this rule, then the instruction for executing the pick expires. The process 1200 of executing the rule in FIG. 12A begins with act 1202. In act 1204, a point of sale triggering event occurs, that instructs the inventory management system 304 to execute this rule. In act 1206, required conditions for executing the associated pick are checked. The required conditions for this pick rule include:

1) Is the rate of sale of the product greater than or equal to the shelf capacity for the product? (ROS≧SC)
2) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the shelf capacity of the product's modular home greater than zero? (SC>0)
6) Are tracked sales of the product greater than or equal to the size of the case pack for the product? (Tracked Sales≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 1208, the quantity of product to be picked is determined to be either the backroom quantity of the product in storage and tracked sales of the product, whichever is less (Min(BR, Tracked Sales). In act 1210, upon determination of the appropriate quantity of product for the current pick, the pick instructions are broadcast by the pick instruction output interface 318 to the appropriate output computing device 320. In act 1212, execution of the rule ends.

FIG. 12B presents a slightly altered example of the rule described in FIG. 12A, where act 1206 of FIG. 12A is replaced by act 1214. In act 1214, conditions 1-5 are unchanged from act 1206, but condition 6 can be expressed as follows:

6) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 6 in act 1214 results in eaches being picked from the backroom storage location.

FIG. 12C presents another slightly altered example of the rule described in FIG. 12A, where act 1206 of FIG. 12A is replaced by act 1216. In act 1216, conditions 1-5 are unchanged from act 1206, but there is no condition 6. The rule presented within FIG. 12C is applicable when the product is not stored by cases within the storage location 122, but is only stored as individual product units, and must be picked by eaches.

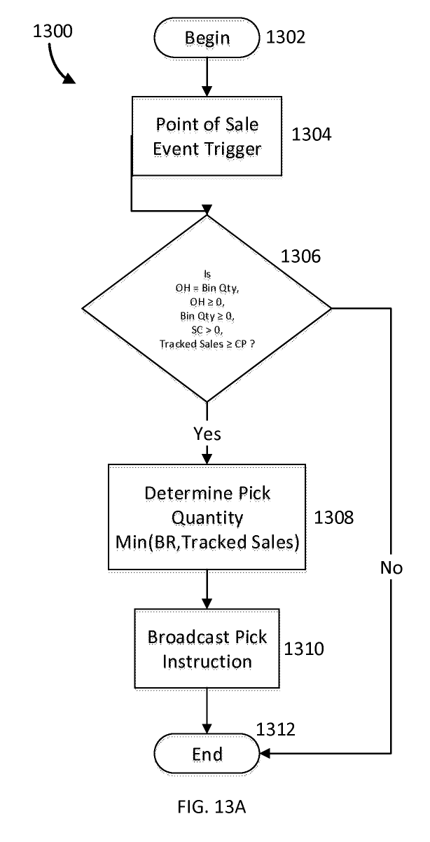

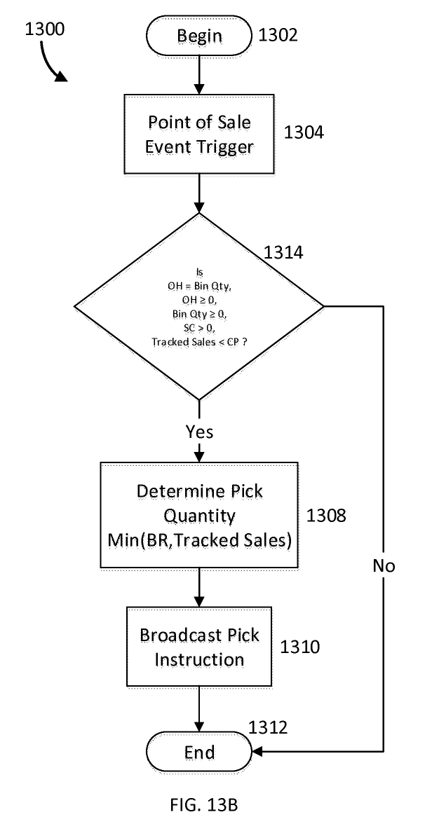

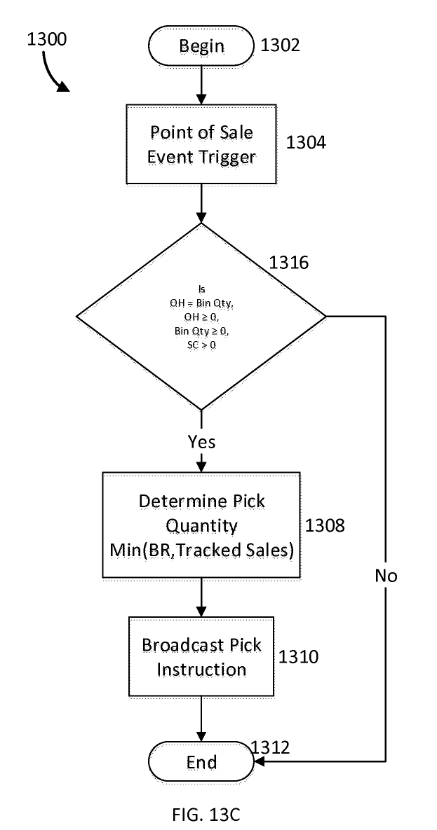

FIG. 13A presents an example implementation of a critical pick rule for modular items on feature display without feature capacity that can be triggered by a sale of an item, and when the total on-hand quantity of the product equals the bin quantity of the product. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 13A is a scheduled rule that is intended for execution immediately upon sale of an associated product, or other trigger event described above. The rule presented in FIG. 13A is not necessarily to be associated with a vendor managed product, but is associated with a product that has been binned. The rule presented in FIG. 13A is associated with products that are on PI, and is associated with products that have a modular home. If the employee that receives pick instructions does not execute the pick by a predefined expiration time associated with this rule, then the instruction for executing the pick expires. The process 1300 of executing the rule in FIG. 13A begins with act 1302. In act 1304, a point of sale triggering event occurs, that instructs the inventory management system 304 to execute this rule. In act 1306, required conditions for executing the associated pick are checked. The required conditions for this pick rule include:

1) Is the total on-hand quantity of the product equal to the bin quantity of the product? (OH=BR)
2) Is the on-hand quantity of the product greater than or equal to zero? (OH≧0)
3) Is the bin quantity of the product greater than or equal to zero? (BR≧0)
4) Is the shelf capacity of the product's modular home greater than zero? (SC>0)
5) Are the tracked sales for the product greater than or equal to the size of the case pack for the product? (Tracked Sales≧CP)
If any of these conditions does not return in the affirmative, then the execution of the rule exits. If all of these conditions return in the affirmative, the execution of the rule continues. In this example, the condition 5 above results in cases being picked from the backroom storage location 122. In act 1308, the quantity of product to be picked is determined to be either the backroom quantity of the product in storage and the tracked sales of the product, whichever is less (Min(BR, Tracked Sales)). In act 1310, upon determination of the appropriate quantity of product for the current pick, the pick instructions are broadcast by the pick instruction output interface 318 to the appropriate output computing device 320. In act 1312, execution of the rule ends.

FIG. 13B presents a slightly altered example of the rule described in FIG. 13A, where act 1306 of FIG. 13A is replaced by act 1314. In act 1314, conditions 1-4 are unchanged from act 1306, but condition 5 can be expressed as follows:

5) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 5 in act 1314 results in eaches being picked from the backroom storage location.

FIG. 13C presents another slightly altered example of the rule described in FIG. 13A, where act 1306 of FIG. 13A is replaced by act 1316. In act 1316, conditions 1-4 are unchanged from act 1306, but there is no condition 5. The rule presented within FIG. 13C is applicable when the product is not stored by cases within the storage location 122, but is only stored as individual product units, and must be picked by eaches.

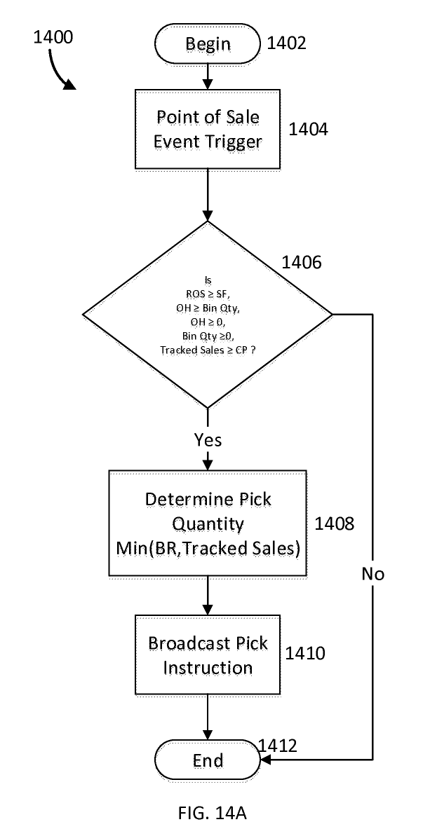

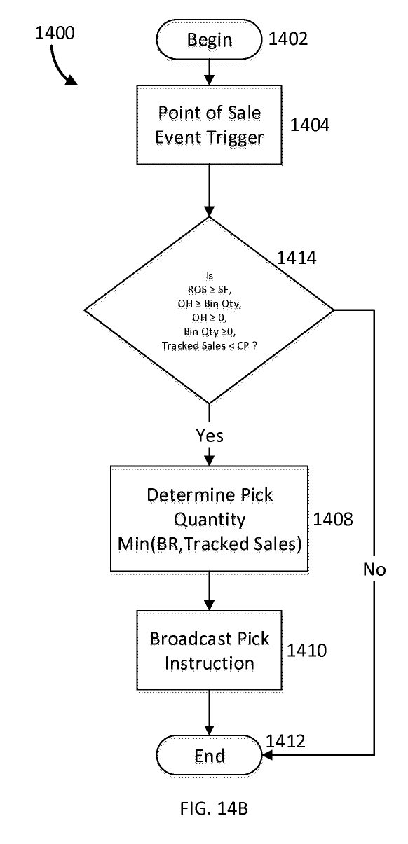

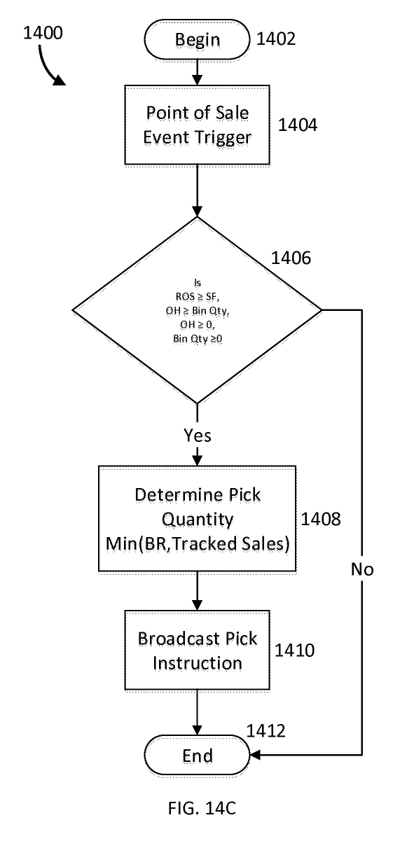

FIG. 14A presents an example implementation of a critical pick rule for non-modular items on feature display that can be triggered by a sale of an item, and when the rate of sale of the product is greater than the sales floor quantity of the product. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 14A is a scheduled rule that is intended for execution immediately upon sale of an associated product, or other trigger event described above. The rule presented in FIG. 14A is not necessarily to be associated with a vendor managed product, but is associated with a product that has been binned. The rule presented in FIG. 14A is associated with products that are on PI. If the employee that receives pick instructions does not execute the pick by a predefined expiration time associated with this rule, then the instruction for executing the pick expires. The process 1400 of executing the rule in FIG. 14A begins with act 1402. In act 1404, a point of sale triggering event occurs, that instructs the inventory management system 304 to execute this rule. In act 1406, required conditions for executing the associated pick are checked. The required conditions for this pick rule include:

1) Is the rate of sale of the product greater than or equal to the sales floor quantity of the product? (ROS≧SF)
2) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Are the tracked sales of the product greater than or equal to the size of the case pack for the product? (Tracked Sales≧CP)
If any of these conditions does not return in the affirmative, then the execution of the rule exits. If all of these conditions return in the affirmative, the execution of the rule continues. In this example, the condition 5 above results in cases being picked from the backroom storage location 122. In act 1408, the quantity of product to be picked is determined to be either the backroom quantity of the product in storage and the tracked sales of the product, whichever is less (Min(BR, Tracked Sales)). In act 1410, upon determination of the appropriate quantity of product for the current pick, the pick instructions are broadcast by the pick instruction output interface 318 to the appropriate output computing device 320. In act 1412, execution of the rule ends.

FIG. 14B presents a slightly altered example of the rule described in FIG. 14A, where act 1406 of FIG. 14A is replaced by act 1414. In act 1414, conditions 1-4 are unchanged from act 1406, but condition 5 can be expressed as follows:

5) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 5 in act 1414 results in eaches being picked from the backroom storage location.

FIG. 14C presents another slightly altered example of the rule described in FIG. 14A, where act 1406 of FIG. 14A is replaced by act 1416. In act 1416, conditions 1-4 are unchanged from act 1406, but there is no condition 5. The rule presented within FIG. 14C is applicable when the product is not stored by cases within the storage location 122, but is only stored as individual product units, and must be picked by eaches.

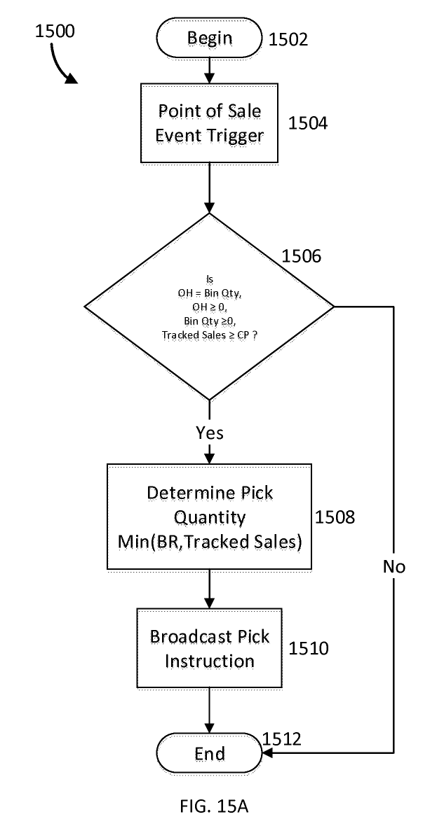

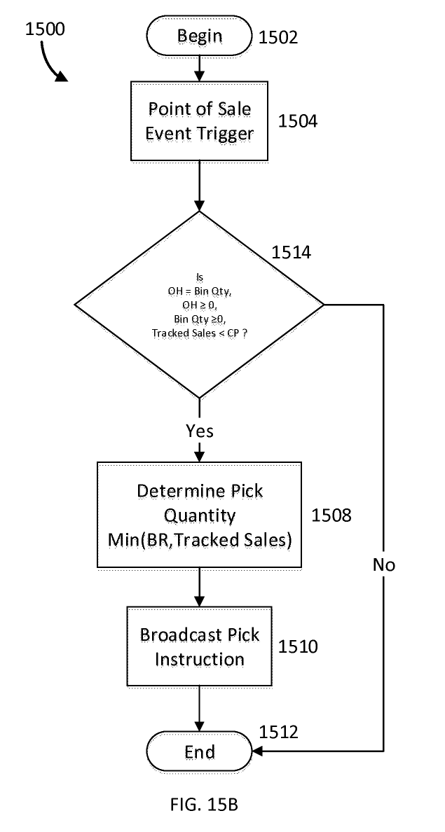

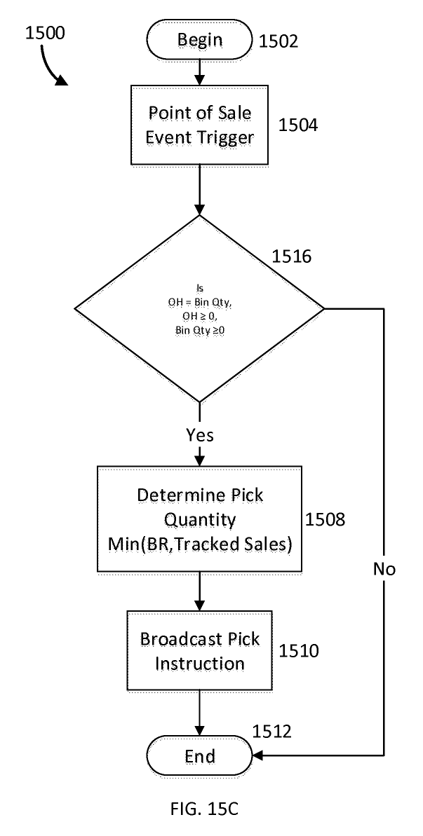

FIG. 15A presents an example implementation of a critical pick rule for non-modular items on feature display that can be triggered by a sale of an item, and when the total quantity of a product on-hand is equal to the quantity of the product in backroom storage. In some embodiments, the critical pick rule can also be triggered by a delivery of the product to the retail establishment. In other embodiments, the critical pick rule can be triggered by a change to shelf capacity. In various embodiments, the critical pick rule can be triggered by a change in the amount of product on hand. The rule presented in FIG. 15A is a scheduled rule that is intended for execution immediately upon sale of an associated product, or other trigger event described above. The rule presented in FIG. 15A is not necessarily to be associated with a vendor managed product, but is associated with a product that has been binned. The rule presented in FIG. 15A is associated with products that are on PI. If the employee that receives pick instructions does not execute the pick by a predefined expiration time associated with this rule, then the instruction for executing the pick expires. The process 1500 of executing the rule in FIG. 15A begins with act 1502. In act 1504, a point of sale triggering event occurs, that instructs the inventory management system 304 to execute this rule. In act 1506, required conditions for executing the associated pick are checked. The required conditions for this pick rule include:

1) Is the total on-hand quantity of the product greater than or equal to the bin quantity of the product? (OH=BR)
2) Is the on-hand quantity of the product greater than or equal to zero? (OH≧0)
3) Is the bin quantity of the product greater than or equal to zero? (BR≧0)
4) Are the tracked sales of the product greater than or equal to the size of the case pack for the product? (Tracked Sales≧CP)
If any of these conditions does not return in the affirmative, then the execution of the rule exits. If all of these conditions return in the affirmative, the execution of the rule continues. In this example, the condition 4 above results in cases being picked from the backroom storage location 122. In act 1508, the quantity of product to be picked is determined to be either the backroom quantity of the product in storage and the tracked sales of the product, whichever is less (Min(BR, Tracked Sales)). In act 1510, upon determination of the appropriate quantity of product for the current pick, the pick instructions are broadcast by the pick instruction output interface 318 to the appropriate output computing device 320. In act 1512, execution of the rule ends.

FIG. 15B presents a slightly altered example of the rule described in FIG. 15A, where act 1506 of FIG. 15A is replaced by act 1514. In act 1514, conditions 1-3 are unchanged from act 1506, but condition 4 can be expressed as follows:

4) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 4 in act 1514 results in eaches being picked from the backroom storage location.

FIG. 15C presents another slightly altered example of the rule described in FIG. 15A, where act 1506 of FIG. 15A is replaced by act 1516. In act 1516, conditions 1-3 are unchanged from act 1506, but there is no condition 4. The rule presented within FIG. 15C is applicable when the product is not stored by cases within the storage location 122, but is only stored as individual product units, and must be picked by eaches.

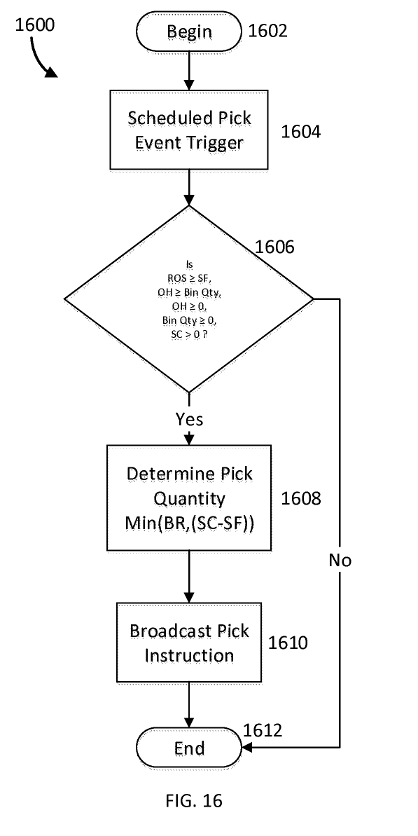

FIG. 16 presents an example implementation of a pick to maintain rule for modular items that can be triggered by a pre-determined schedule of execution times. At the scheduled execution time, picks are generated when the rate of sale of a product is greater than the sales floor quantity of that product. The rule presented in FIG. 16 is not necessarily to be associated with a vendor managed product, but is associated with a product that has been binned. The rule presented in FIG. 16 is associated with products that are on PI, and is associated with products that have a modular home. If the employee that receives pick instructions does not execute the pick by a predefined expiration time associated with this rule, then the instruction for executing the pick expires. The process 1600 of executing the rule in FIG. 16 begins with act 1602. In act 1604, a scheduled pick triggering event occurs, that instructs the inventory management system 304 to execute this rule. In act 1606, required conditions for executing the associated pick are checked. The required conditions for this pick rule include:

1) Is the rate of the product greater than or equal to the current sales floor quantity of the product? (ROS≧SF)
2) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the shelf capacity of the product's modular home greater than zero? (SC>0)
If any of these conditions does not return in the affirmative, then the execution of the rule exits. If all of these conditions return in the affirmative, the execution of the rule continues. In act 1608, the quantity of product to be picked is determined to be either the backroom quantity of the product in storage or the difference of the shelf capacity of the product's modular home and the quantity of the product currently on the sales floor, whichever is less (Min(BR,(SC−SF))). In some embodiments of the execution of this rule, the picking of product from storage can be performed by picking cases. In other embodiments of the execution of this rule, the picking of product from storage can be performed by picking eaches. In act 1610, upon determination of the appropriate quantity of product for the current pick, the pick instructions are broadcast by the pick instruction output interface 318 to the appropriate output computing device 320. In act 1612, execution of the rule ends.

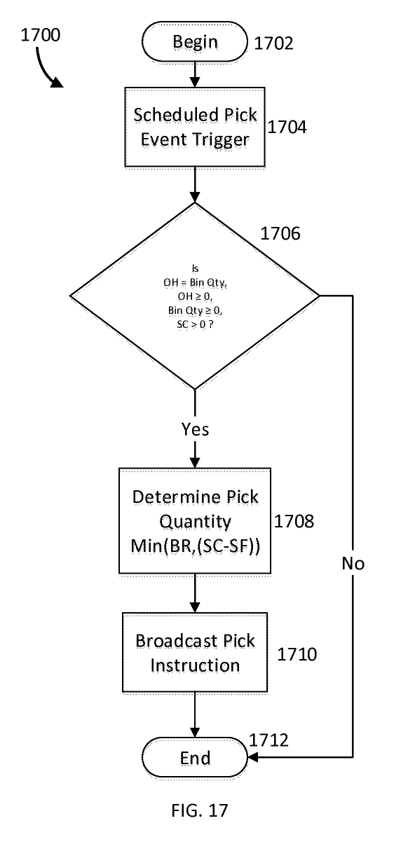

FIG. 17 presents an example implementation of a pick to maintain rule for modular items that can be triggered by a pre-determined schedule of execution times. At the scheduled execution time, picks are generated when the on-hand quantity of a product equals the bin quantity of the product. The rule presented in FIG. 17 is not necessarily to be associated with a vendor managed product, but is associated with a product that has been binned. The rule presented in FIG. 17 is associated with products that are on PI, and is associated with products that have a modular home. If the employee that receives pick instructions does not execute the pick by a predefined expiration time associated with this rule, then the instruction for executing the pick expires. The process 1700 of executing the rule in FIG. 17 begins with act 1702. In act 1704, a scheduled pick triggering event occurs, that instructs the inventory management system 304 to execute this rule. In act 1706, required conditions for executing the associated pick are checked. The required conditions for this pick rule include:

1) Is the total on-hand quantity of the product equal to the bin quantity of the product? (OH=BR)
2) Is the on-hand quantity of the product greater than or equal to zero? (OH≧0)
3) Is the bin quantity of the product greater than or equal to zero? (BR≧0)
4) Is the shelf capacity of the product's modular home greater than zero? (SC>0)
If any of these conditions does not return in the affirmative, then the execution of the rule exits. If all of these conditions return in the affirmative, the execution of the rule continues. In act 1708, the quantity of product to be picked is determined to be either the backroom quantity of the product in storage or the difference of the shelf capacity of the product's modular home and the quantity of the product currently on the sales floor, whichever is less (Min(BR,(SC−SF))). In some embodiments of the execution of this rule, the picking of product from storage can be performed by picking cases. In other embodiments of the execution of this rule, the picking of product from storage can be performed by picking eaches. In act 1710, upon determination of the appropriate quantity of product for the current pick, the pick instructions are broadcast by the pick instruction output interface 318 to the appropriate output computing device 320. In act 1712, execution of the rule ends.

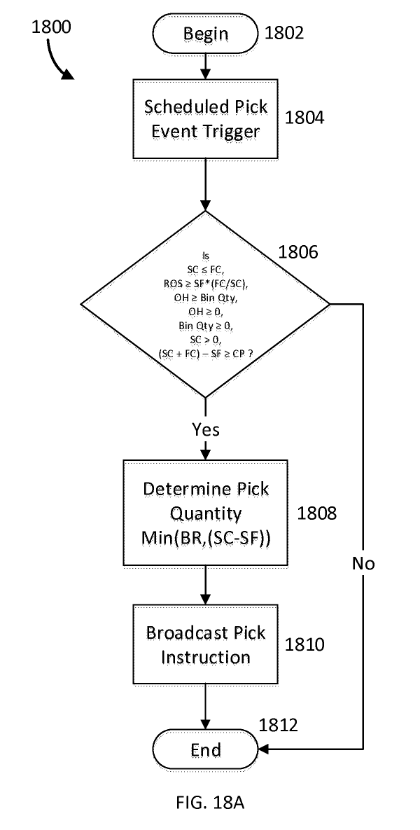

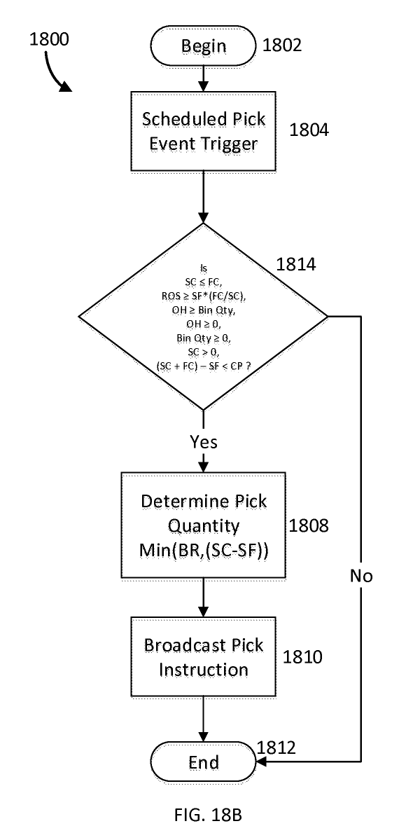

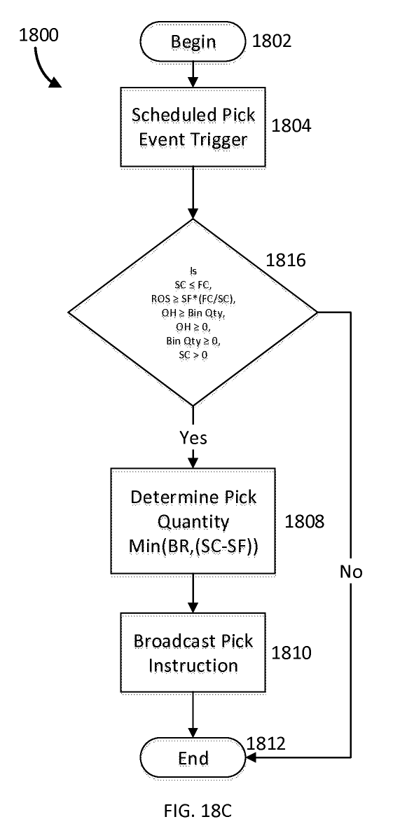

FIG. 18A presents an example implementation of a pick to maintain rule for modular items that can be triggered by a pre-determined schedule of execution times. At the scheduled execution time, picks are generated when the shelf capacity of a product is less than feature capacity, and when the sales floor can fit more than a case pack based on shelf capacity, feature capacity, total quantity of product on the sales floor. The rule presented in FIG. 18A is not necessarily to be associated with a vendor managed product, but is associated with a product that has been binned. The rule presented in FIG. 18A is associated with products that are on PI, and is associated with products that have a modular home. If the employee that receives pick instructions does not execute the pick by a predefined expiration time associated with this rule, then the instruction for executing the pick expires. The process 1800 of executing the rule in FIG. 18A begins with act 1802. In act 1804, a scheduled pick triggering event occurs, that instructs the inventory management system 304 to execute this rule. In act 1806, required conditions for executing the associated pick are checked. The required conditions for this pick rule include:

1) Is the shelf capacity of the product less than or equal to the feature capacity of the product? (SC≦FC)
2) Is the rate of sale of the product greater than or equal to the sales floor capacity of the product multiplied by the ratio of the shelf capacity of the product to the feature capacity? (ROS≧SF*(FC/SC))
3) Is the total on-hand quantity of the product greater than or equal to the bin quantity of the product? (OH≧BR)
4) Is the on-hand quantity of the product greater than or equal to zero? (OH≧0)
5) Is the bin quantity of the product greater than or equal to zero? (BR≧0)
6) Is the shelf capacity of the product's modular home greater than zero? (SC>0)
7) Is the difference of the sum of the shelf capacity and feature capacity of the product with the total quantity of the product on the sales floor greater than or equal to the case pack size of the product? ((SC+FC)−FC)≧CP
If any of these conditions does not return in the affirmative, then the execution of the rule exits. If all of these conditions return in the affirmative, the execution of the rule continues. In this example, the condition 7 above results in cases being picked from the backroom storage location 122. In act 1808, the quantity of product to be picked is determined to be either the backroom quantity of the product in storage or the difference of the shelf capacity of the product's modular home and the quantity of the product currently on the sales floor, whichever is less (Min(BR,(SC−SF))). In act 1810, upon determination of the appropriate quantity of product for the current pick, the pick instructions are broadcast by the pick instruction output interface 318 to the appropriate output computing device 320. In act 1812, execution of the rule ends.

FIG. 18B presents a slightly altered example of the rule described in FIG. 18A, where act 1806 of FIG. 18A is replaced by act 1814. In act 1814, conditions 1-6 are unchanged from act 1806, but condition 7 can be expressed as follows:

7) Is the difference of the sum of the shelf capacity and the feature capacity with the current sales floor quantity less than the case pack size of the product? ((SC+FC)−SF<CP)
If any of the conditions do not return in the affirmative, then the execution of the rule exits. If all of these conditions return in the affirmative, then the execution of the rule continues. In this example, the altered condition 7 in act 1814 results in eaches being picked from the backroom storage location.

FIG. 18C presents another slightly altered example of the rule described in FIG. 18A, where act 1806 of FIG. 18A is replaced by act 1816. In act 1816, conditions 1-6 are unchanged from act 1806, but there is no condition 7. The rule presented within FIG. 18C is applicable when the product is not stored by cases within the storage location 122, but is only stored as individual product units, and must be picked by eaches.

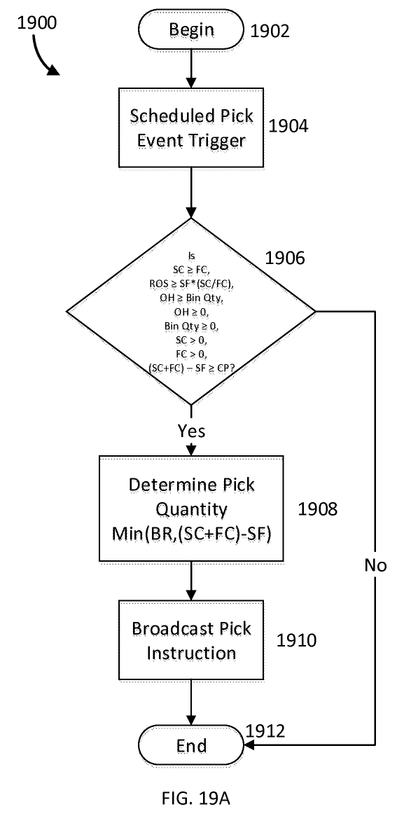

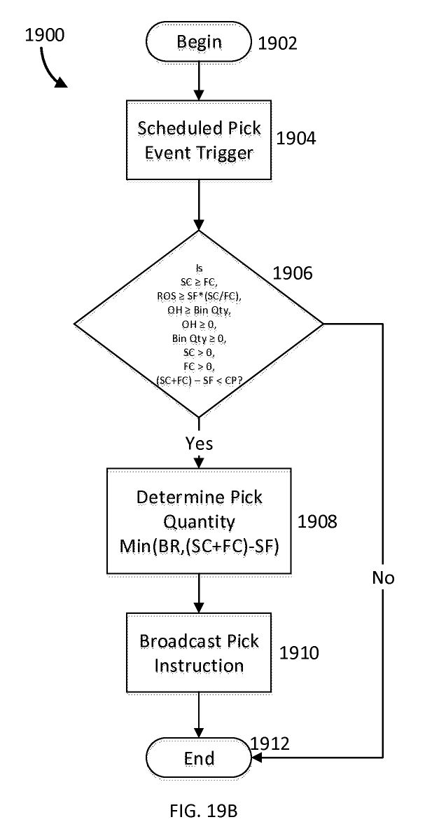

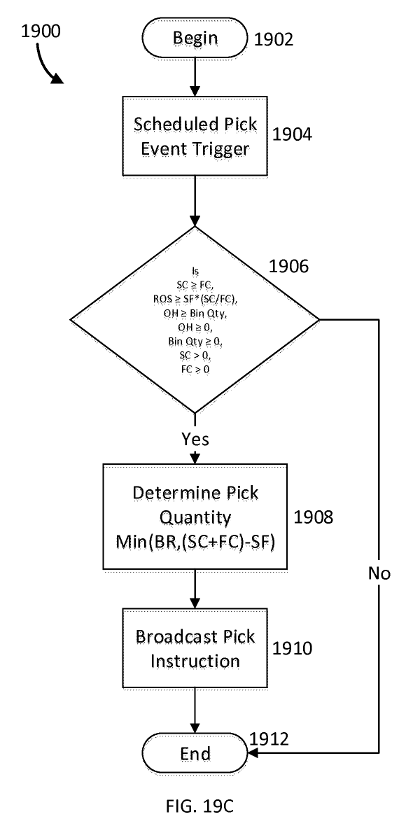

FIG. 19A presents an example implementation of pick to a maintain rule for modular items with a feature display that can be triggered by a pre-determined schedule of execution times. At the scheduled execution time, picks are generated when the shelf capacity of a product is greater than the feature capacity, and when the sales floor can fit more than a case pack based on shelf capacity, feature capacity, total quantity of product on the sales floor. The rule presented in FIG. 19A is not necessarily to be associated with a vendor managed product, but is associated with a product that has been binned. The rule presented in FIG. 19A is associated with products that are on PI, and is associated with products that have a modular home. If the employee that receives pick instructions does not execute the pick by a predefined expiration time associated with this rule, then the instruction for executing the pick expires. The process 1900 of executing the rule in FIG. 19A begins with act 1902. In act 1904, a scheduled pick triggering event occurs, that instructs the inventory management system 304 to execute this rule. In act 1906, required conditions for executing the associated pick are checked. The required conditions for this pick rule include:

1) Is the shelf capacity of the product greater than or equal to the feature capacity of the product? (SC≧FC)
2) Is the rate of sale of the product greater than or equal to the sales floor capacity of the product multiplied by the ratio of the shelf capacity of the product to the feature capacity? (ROS≧SF*(FC/SC))
3) Is the total on-hand quantity of the product greater than or equal to the bin quantity of the product? (OH≧BR)
4) Is the on-hand quantity of the product greater than or equal to zero? (OH≧0)
5) Is the bin quantity of the product greater than or equal to zero? (BR≧0)
6) Is the shelf capacity of the product's modular home greater than zero? (SC>0)
7) Is the feature capacity of the product greater than zero? (FC>0)
8) Is the difference of the sum of the shelf capacity and feature capacity of the product with the total quantity of the product on the sales floor greater than or equal to the case pack size of the product? ((SC+FC)−FC>CP)
If any of these conditions does not return in the affirmative, then the execution of the rule exits. If all of these conditions return in the affirmative, the execution of the rule continues. In this example, the condition 8 above results in cases being picked from the backroom storage location 122. In act 1908, the quantity of product to be picked is determined to be either the backroom quantity of the product in storage or the difference of the sum of the shelf capacity of the products modular home and feature capacity of the product with the quantity of the product on the sales floor, whichever is less (Min(BR,(SC+FC)−SF)). In act 1910, upon determination of the appropriate quantity of product for the current pick, the pick instructions are broadcast by the pick instruction output interface 318 to the appropriate output computing device 320. In act 1912, execution of the rule ends.

FIG. 19B presents a slightly altered example of the rule described in FIG. 19A, where act 1906 of FIG. 19A is replaced by act 1914. In act 1914, conditions 1-7 are unchanged from act 1906, but condition 8 can be expressed as follows:

8) Is the difference of the sum of the shelf capacity and the feature capacity with the current sales floor quantity less than the case pack size of the product? ((SC+FC)−SF<CP)
If any of the conditions do not return in the affirmative, then the execution of the rule exits. If all of these conditions return in the affirmative, then the execution of the rule continues. In this example, the altered condition 8 in act 1914 results in eaches being picked from the backroom storage location.

FIG. 19C presents another slightly altered example of the rule described in FIG. 19A, where act 1906 of FIG. 19A is replaced by act 1916. In act 1916, conditions 1-7 are unchanged from act 1806, but there is no condition 8. The rule presented within FIG. 19C is applicable when the product is not stored by cases within the storage location 122, but is only stored as individual product units, and must be picked by eaches.

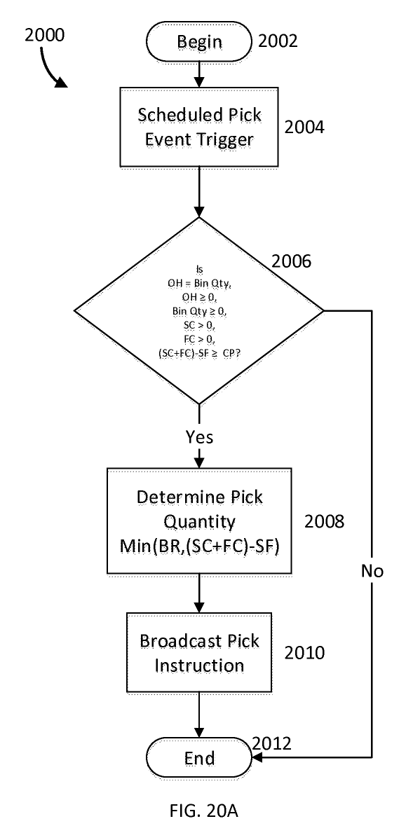

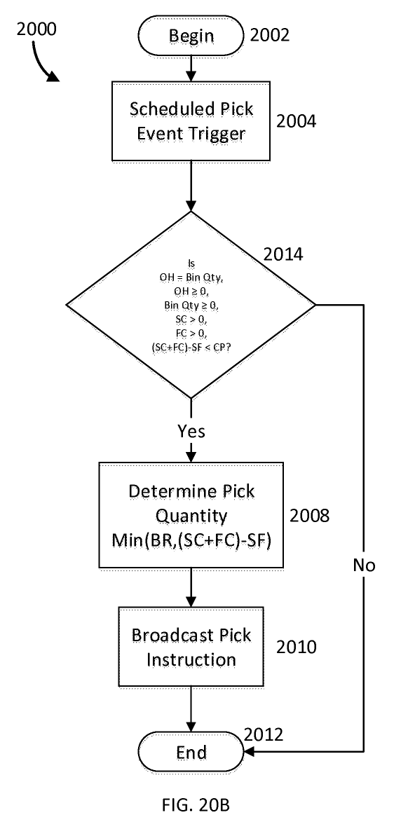

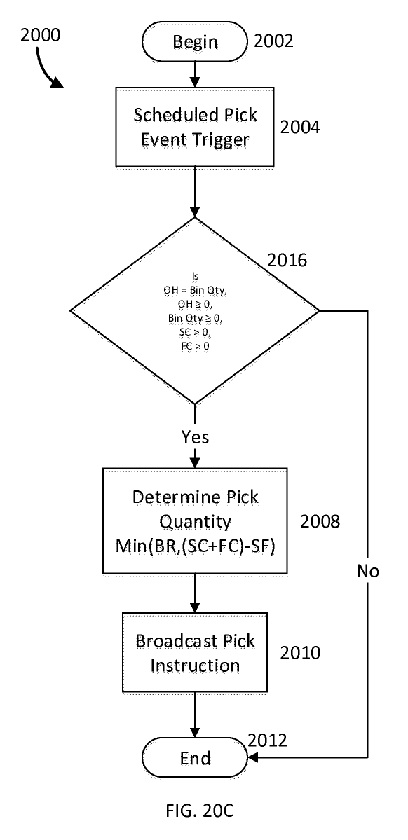

FIG. 20A presents an example implementation of a pick to maintain rule for modular items with a feature display that can be triggered by a pre-determined schedule of execution times. At the scheduled execution time, picks are generated when the total quantity of a product on-hand equals the bin quantity of the product. The rule presented in FIG. 20A is not necessarily to be associated with a vendor managed product, but is associated with a product that has been binned. The rule presented in FIG. 20A is associated with products that are on PI, and is associated with products that have a modular home. If the employee that receives pick instructions does not execute the pick by a predefined expiration time associated with this rule, then the instruction for executing the pick expires. The process 2000 of executing the rule in FIG. 20A begins with act 2002. In act 2004, a scheduled pick triggering event occurs, that instructs the inventory management system 304 to execute this rule. In act 2006, required conditions for executing the associated pick are checked. The required conditions for this pick rule include:

1) Is the total on-hand quantity of the product equal to the bin quantity of the product? (OH=BR)
2) Is the on-hand quantity of the product greater than or equal to zero? (OH≧0)
3) Is the bin quantity of the product greater than or equal to zero? (BR≧0)
4) Is the shelf capacity of the product's modular home greater than zero? (SC>0)
5) Is the feature capacity of the product greater than zero? (FC>0)
6) Is the difference of the sum of the shelf capacity and feature capacity of the product with the total quantity of the product on the sales floor greater than or equal to the case pack size of the product? ((SC+FC)−FC)≧CP
If any of these conditions does not return in the affirmative, then the execution of the rule exits. If all of these conditions return in the affirmative, the execution of the rule continues. In this example, the condition 6 above results in cases being picked from the backroom storage location 122. In act 2008, the quantity of product to be picked is determined to be either the backroom quantity of the product in storage or the difference of the sum of the shelf capacity of the products modular home and feature capacity of the product with the quantity of the product on the sales floor, whichever is less (Min(BR,(SC+FC)−SF)). In act 2010, upon determination of the appropriate quantity of product for the current pick, the pick instructions are broadcast by the pick instruction output interface 318 to the appropriate output computing device 320. In act 2012, execution of the rule ends.

FIG. 20B presents a slightly altered example of the rule described in FIG. 20A, where act 2006 of FIG. 20A is replaced by act 2014. In act 2014, conditions 1-5 are unchanged from act 2006, but condition 8 can be expressed as follows:

6) Is the difference of the sum of the shelf capacity and the feature capacity with the current sales floor quantity less than the case pack size of the product? ((SC+FC)−SF<CP)
If any of the conditions do not return in the affirmative, then the execution of the rule exits. If all of these conditions return in the affirmative, then the execution of the rule continues. In this example, the altered condition 6 in act 2014 results in eaches being picked from the backroom storage location.

FIG. 20C presents another slightly altered example of the rule described in FIG. 20A, where act 2006 of FIG. 20A is replaced by act 2016. In act 2016, conditions 1-5 are unchanged from act 1806, but there is no condition 6. The rule presented within FIG. 20C is applicable when the product is not stored by cases within the storage location 122, but is only stored as individual product units, and must be picked by eaches.

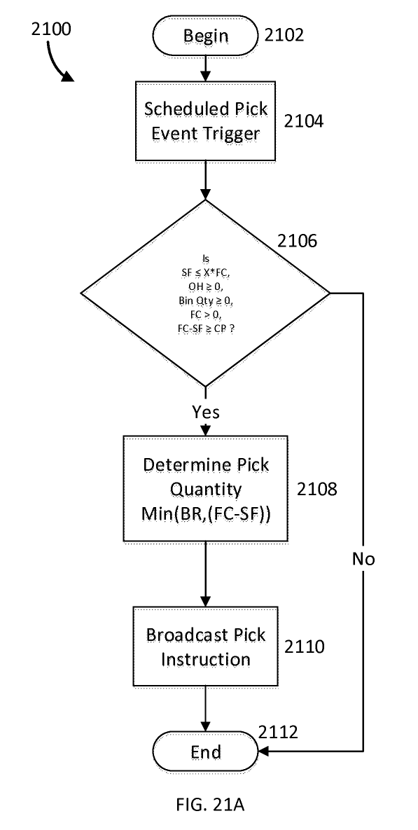

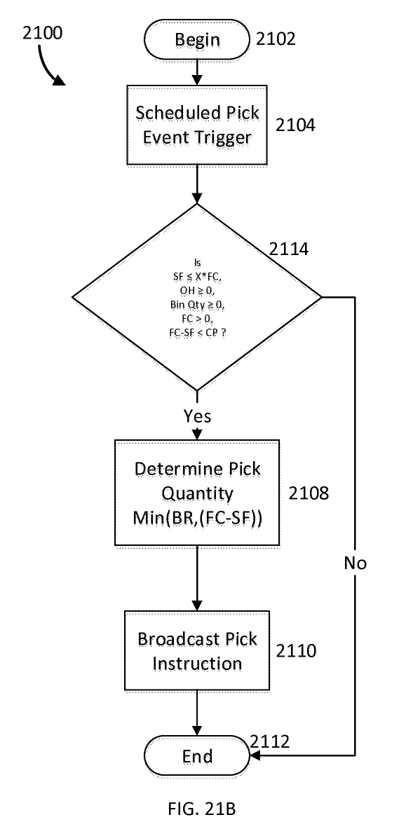

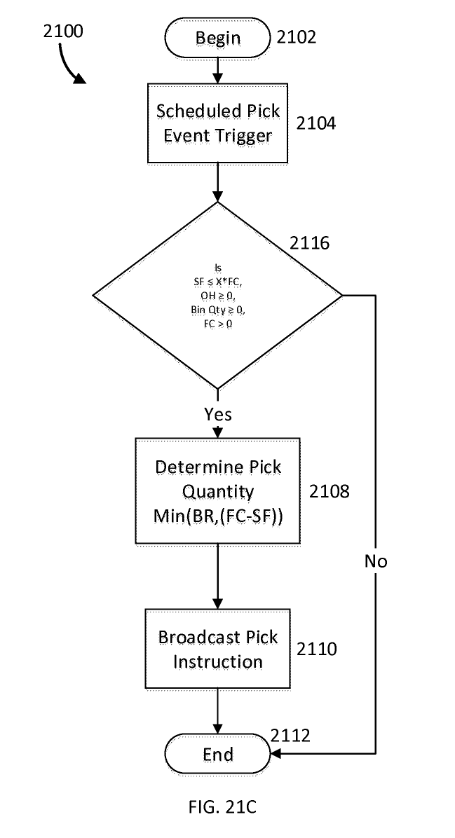

FIG. 21A presents an example implementation of a pick to maintain rule for non-modular items with a feature display that can be triggered by a pre-determined schedule of execution times. At the scheduled execution time, picks are generated when the sales floor quantity of a product is less than a predefined percentage X of the feature capacity of the product, for example 60% of the feature capacity of the product. The rule presented in FIG. 21A is not necessarily to be associated with a vendor managed product, but is associated with a product that has been binned. The rule presented in FIG. 21A is associated with products that are on PI. If the employee that receives pick instructions does not execute the pick by a predefined expiration time associated with this rule, then the instruction for executing the pick expires. The process 2100 of executing the rule in FIG. 21A begins with act 2102. In act 2104, a scheduled pick triggering event occurs, that instructs the inventory management system 304 to execute this rule. In act 2106, required conditions for executing the associated pick are checked. The required conditions for this pick rule include:

1) Is the sales floor quantity of the product on-hand less than or equal to a predefined percentage of the feature capacity of the product? (SF≦X*FC)
2) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the feature capacity of the product greater than zero? (FC>0)
6) Is the difference of the feature capacity of the product and the current sales floor quantity of the product greater than or equal to the case pack size of the product? ((FC−SF)≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 2108, the quantity of product to be picked is determined to be either the backroom quantity of the product in storage or the difference between the feature capacity of the product and the current sales floor quantity of the product, whichever is less (Min(BR,(FC−SF))). In act 2110, upon determination of the appropriate quantity of product for the current pick, the pick instructions are broadcast by the pick instruction output interface 318 to the appropriate output computing device 320. In act 2112, execution of the rule ends.

FIG. 21B presents a slightly altered example of the rule described in FIG. 21A, where act 2106 of FIG. 21A is replaced by act 2114. In act 2114, conditions 1-5 are unchanged from act 2106, but condition 6 can be expressed as follows:

6) Is the difference of the feature capacity and the sales floor quantity less than the size of the case pack for the product? (FC−SF<CP)
If any of the conditions do not return in the affirmative, then the execution of the rule exits. If all of these conditions return in the affirmative, then the execution of the rule continues. In this example, the altered condition 6 in act 2114 results in eaches being picked from the backroom storage location.

FIG. 21C presents another slightly altered example of the rule described in FIG. 21A, where act 2106 of FIG. 21A is replaced by act 2116. In act 2116, conditions 1-5 are unchanged from act 2106, but there is no condition 6. The rule presented within FIG. 21C is applicable when the product is not stored by cases within the storage location 122, but is only stored as individual product units, and must be picked by eaches.

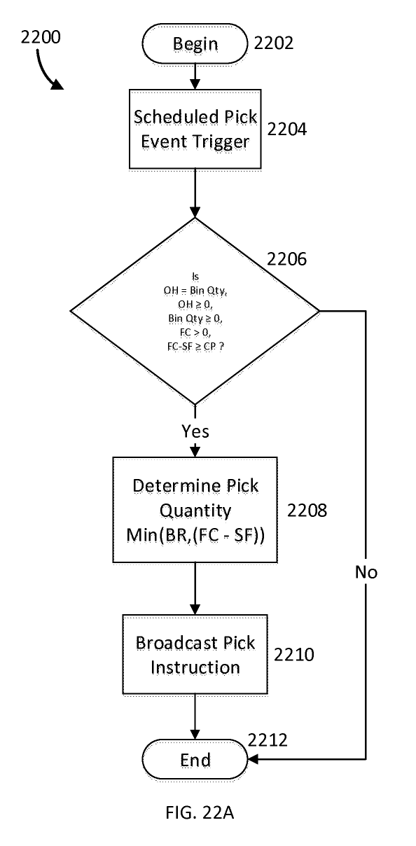

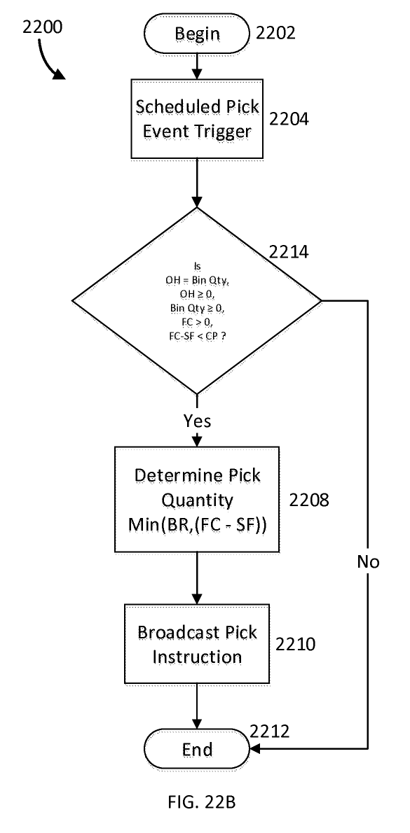

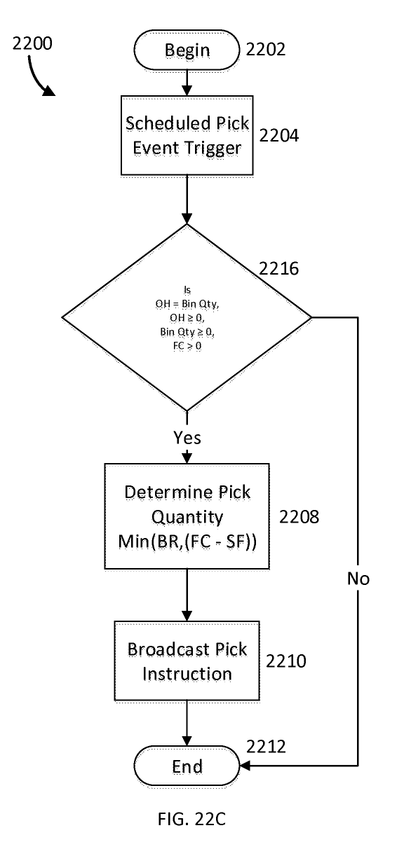

FIG. 22A presents an example implementation of a pick to maintain rule for non-modular items with a feature display that can be triggered by a pre-determined schedule of execution times. At the scheduled execution time, picks are generated when the total quantity of a product on-hand is equal to the bin quantity of the product. The rule presented in FIG. 22A is not necessarily to be associated with a vendor managed product, but is associated with a product that has been binned. The rule presented in FIG. 22A is associated with products that are on PI. If the employee that receives pick instructions does not execute the pick by a predefined expiration time associated with this rule, then the instruction for executing the pick expires. The process 2200 of executing the rule in FIG. 22A begins with act 2202. In act 2204, a scheduled pick triggering event occurs, that instructs the inventory management system 304 to execute this rule. In act 2206, required conditions for executing the associated pick are checked. The required conditions for this pick rule include:

1) Is the total on-hand quantity of the product equal to the bin quantity of the product? (OH=BR)
3) Is the on-hand quantity of the product greater than or equal to zero? (OH≧0)
4) Is the bin quantity of the product greater than or equal to zero? (BR≧0)
5) Is the feature capacity of the product greater than zero? (FC>0)
6) Is the difference of the feature capacity of the product and the current sales floor quantity of the product greater than or equal to the case pack size of the product? ((FC−SF)≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 2208, the quantity of product to be picked is determined to be either the backroom quantity of the product in storage or the difference between the feature capacity of the product and the current sales floor quantity of the product, whichever is less (Min(BR,(FC−SF))). In act 2210, upon determination of the appropriate quantity of product for the current pick, the pick instructions are broadcast by the pick instruction output interface 318 to the appropriate output computing device 320. In act 2212, execution of the rule ends.

FIG. 22B presents a slightly altered example of the rule described in FIG. 22A, where act 2206 of FIG. 22A is replaced by act 2214. In act 2214, conditions 1-5 are unchanged from act 1006, but condition 6 can be expressed as follows:

6) Is the difference of the feature capacity and the sales floor quantity less than the size of the case pack for the product? (FC−SF<CP)
If any of the conditions do not return in the affirmative, then the execution of the rule exits. If all of these conditions return in the affirmative, then the execution of the rule continues. In this example, the altered condition 6 in act 2214 results in eaches being picked from the backroom storage location.

FIG. 22C presents another slightly altered example of the rule described in FIG. 22A, where act 2206 of FIG. 22A is replaced by act 2216. In act 2216, conditions 1-5 are unchanged from act 2206, but there is no condition 6. The rule presented within FIG. 22C is applicable when the product is not stored by cases within the storage location 122, but is only stored as individual product units, and must be picked by eaches.

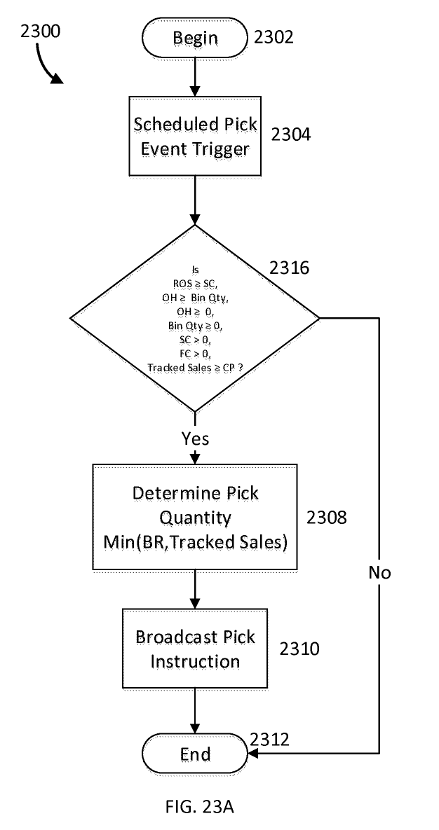

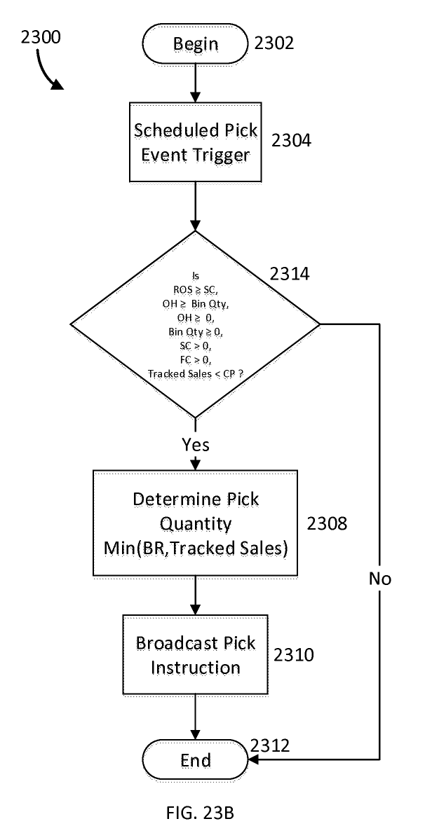

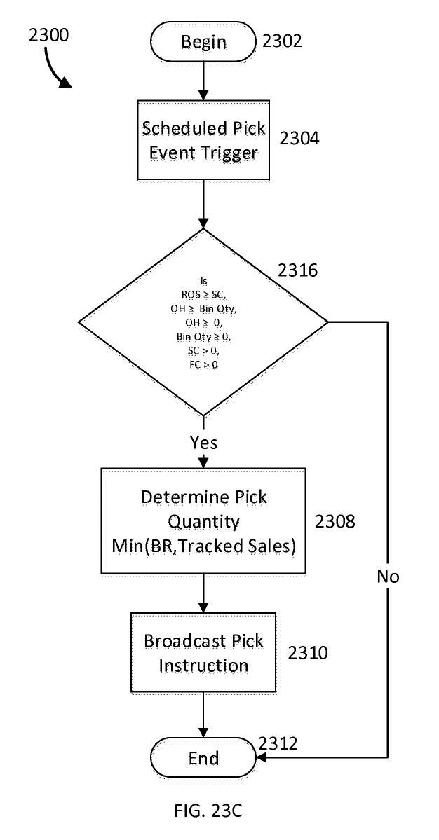

FIG. 23A presents an example implementation of a pick to maintain rule for non-modular items with a feature display that can be triggered by a pre-determined schedule of execution times. At the scheduled execution time, picks are generated when the rate of sale of a product is greater than the shelf capacity for the product. The rule presented in FIG. 23A is not necessarily to be associated with a vendor managed product, but is associated with a product that has been binned. The rule presented in FIG. 23A is associated with products that are on PI. If the employee that receives pick instructions does not execute the pick by a predefined expiration time associated with this rule, then the instruction for executing the pick expires. The process 2300 of executing the rule in FIG. 23A begins with act 2302. In act 2304, a scheduled pick triggering event occurs, that instructs the inventory management system 304 to execute this rule. In act 2306, required conditions for executing the associated pick are checked. The required conditions for this pick rule include:

1) Is the rate of sale of the product greater than or equal to the shelf capacity of the product? (ROS≧SC)
2) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the shelf capacity of the product greater than zero? (SC>0)
6) Is the feature capacity of the product greater than zero? (FC>0)
7) Are the tracked sales of the product greater than or equal to the size of a case pack for the product? (Tracked Sales≧CP)
If any of these conditions does not return in the affirmative, then the execution of the rule exits. If all of these conditions return in the affirmative, the execution of the rule continues. In this example, the condition 7 above results in cases being picked from the backroom storage location 122. In act 2308, the quantity of product to be picked is determined to be either the backroom quantity of the product in storage or the tracked sales of the product, whichever is less (Min(BR, Tracked Sales)). In act 2310, upon determination of the appropriate quantity of product for the current pick, the pick instructions are broadcast by the pick instruction output interface 318 to the appropriate output computing device 320. In act 2312, execution of the rule ends.

FIG. 23B presents a slightly altered example of the rule described in FIG. 23A, where act 2306 of FIG. 23A is replaced by act 2314. In act 2314, conditions 1-6 are unchanged from act 2306, but condition 7 can be expressed as follows:

7) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 7 in act 2314 results in eaches being picked from the backroom storage location.

FIG. 23C presents another slightly altered example of the rule described in FIG. 23A, where act 2306 of FIG. 23A is replaced by act 2316. In act 2316, conditions 1-6 are unchanged from act 2306, but there is no condition 7. The rule presented within FIG. 23C is applicable when the product is not stored by cases within the storage location 122, but is only stored as individual product units, and must be picked by eaches.

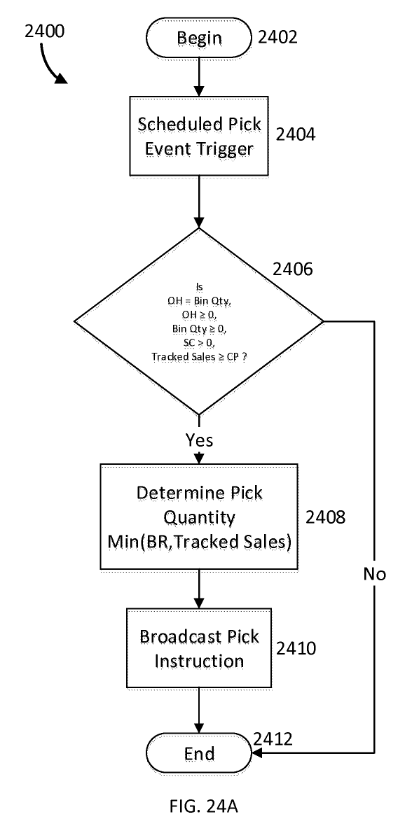

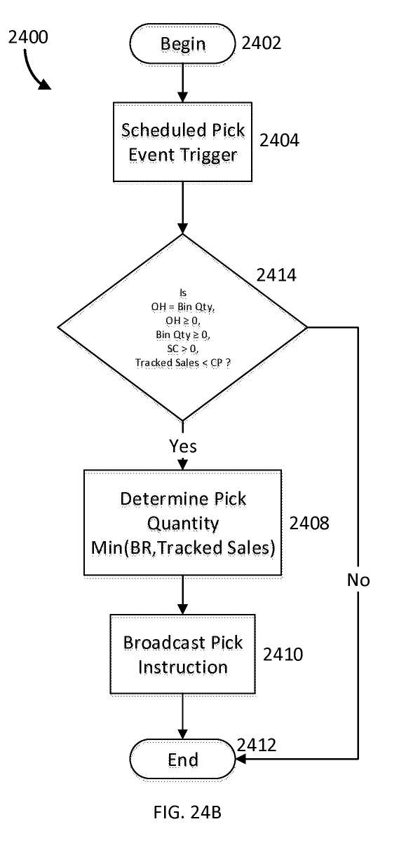

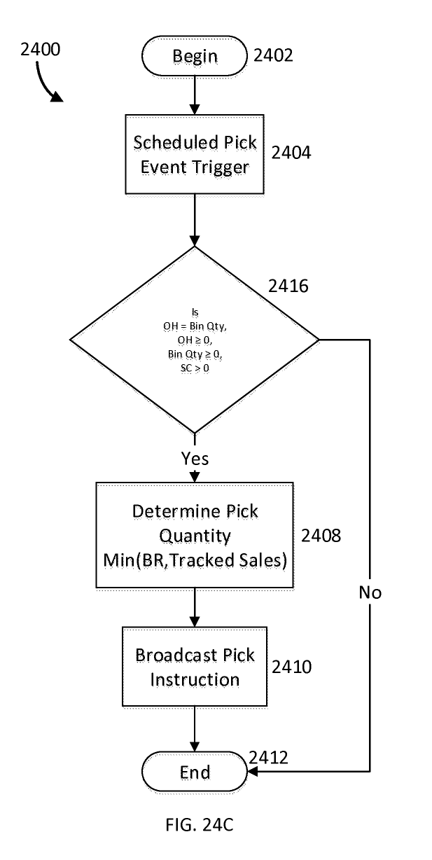

FIG. 24A presents an example implementation of a pick to maintain rule for modular items without feature display, or when the feature capacity is zero, that can be triggered by a pre-determined schedule of execution times. At the scheduled execution time, picks are generated when the total quantity of product on-hand is equal to the bin quantity of the product. The rule presented in FIG. 24A is not necessarily to be associated with a vendor managed product, but is associated with a product that has been binned. The rule presented in FIG. 24A is associated with products that are on PI. If the employee that receives pick instructions does not execute the pick by a predefined expiration time associated with this rule, then the instruction for executing the pick expires. The process 2400 of executing the rule in FIG. 24A begins with act 2402. In act 2404, a scheduled pick triggering event occurs, that instructs the inventory management system 304 to execute this rule. In act 2406, required conditions for executing the associated pick are checked. The required conditions for this pick rule include:

1) Is the total on-hand quantity of the product equal to the bin quantity of the product? (OH=BR)
3) Is the on-hand quantity of the product greater than or equal to zero? (OH≧0)
4) Is the bin quantity of the product greater than or equal to zero? (BR≧0)
5) Is the shelf capacity of the product greater than zero? (SC>0)
6) Are the tracked sales of the product greater than or equal to the size of a case pack for the product? (Tracked Sales≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 2408, the quantity of product to be picked is determined to be either the backroom quantity of the product in storage or the tracked sales of the product, whichever is less (Min(BR, Tracked Sales)). In act 2410, upon determination of the appropriate quantity of product for the current pick, the pick instructions are broadcast by the pick instruction output interface 318 to the appropriate output computing device 320. In act 2412, execution of the rule ends.

FIG. 24B presents a slightly altered example of the rule described in FIG. 24A, where act 2406 of FIG. 24A is replaced by act 2414. In act 2414, conditions 1-5 are unchanged from act 2406, but condition 6 can be expressed as follows:

6) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 6 in act 2414 results in eaches being picked from the backroom storage location.

FIG. 24C presents another slightly altered example of the rule described in FIG. 24A, where act 2406 of FIG. 24A is replaced by act 2416. In act 2416, conditions 1-5 are unchanged from act 2406, but there is no condition 6. The rule presented within FIG. 24C is applicable when the product is not stored by cases within the storage location 122, but is only stored as individual product units, and must be picked by eaches.

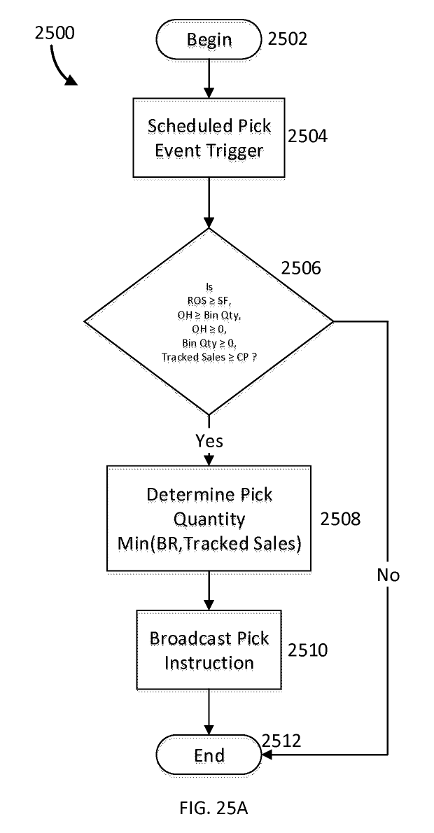

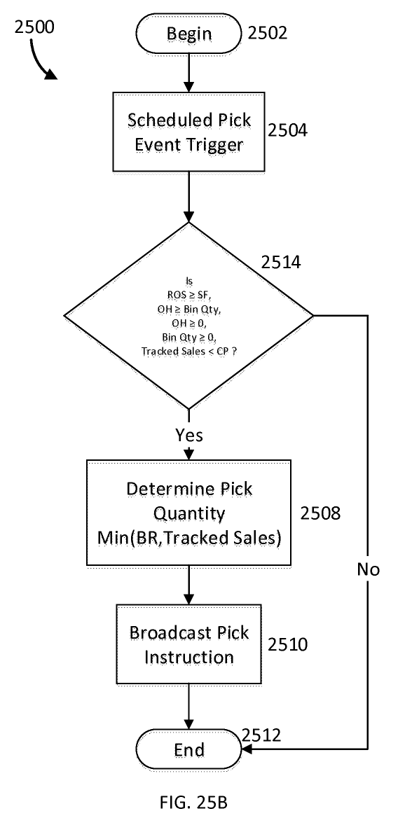

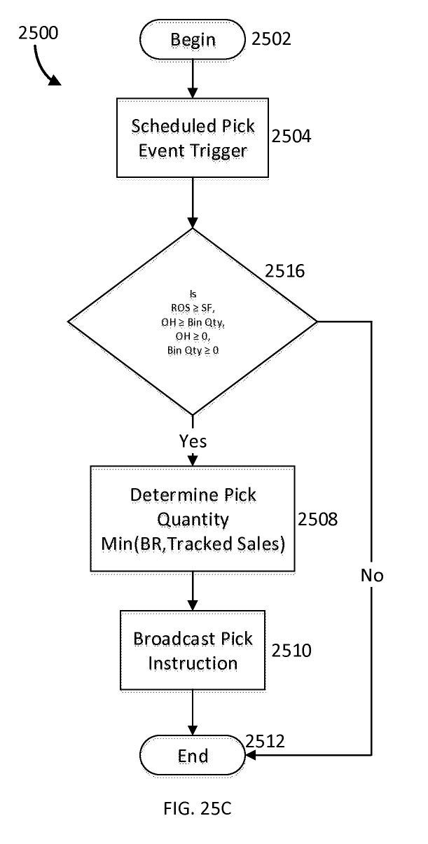

FIG. 25A presents an example implementation of a pick to maintain rule for modular items without feature display, or when the feature capacity is zero, that can be triggered by a pre-determined schedule of execution times. At the scheduled execution time, picks are generated when the total quantity of product on-hand is equal to the bin quantity of the product. The rule presented in FIG. 25A is not necessarily to be associated with a vendor managed product, but is associated with a product that has been binned. The rule presented in FIG. 25A is associated with products that are on PI. If the employee that receives pick instructions does not execute the pick by a predefined expiration time associated with this rule, then the instruction for executing the pick expires. The process 2500 of executing the rule in FIG. 25A begins with act 2502. In act 2504, a scheduled pick triggering event occurs, that instructs the inventory management system 304 to execute this rule. In act 2506, required conditions for executing the associated pick are checked. The required conditions for this pick rule include:

1) Is the rate of sale of the product greater than or equal to the current sales floor quantity of the product? (ROS≧SF)
2) Is the total on-hand quantity of the product greater than or equal to the bin quantity of the product? (OH≧BR)
3) Is the on-hand quantity of the product greater than or equal to zero? (OH≧0)
4) Is the bin quantity of the product greater than or equal to zero? (BR≧0)
5) Is the feature capacity of the product equal to zero? (FC=0)
6) Are the tracked sales of the product greater than or equal to the size of a case pack for the product? (Tracked Sales≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 2508, the quantity of product to be picked is determined to be either the backroom quantity of the product in storage or the tracked sales of the product, whichever is less (Min(BR, Tracked Sales)). In act 2510, upon determination of the appropriate quantity of product for the current pick, the pick instructions are broadcast by the pick instruction output interface 318 to the appropriate output computing device 320. In act 2512, execution of the rule ends.

FIG. 25B presents a slightly altered example of the rule described in FIG. 25A, where act 2506 of FIG. 25A is replaced by act 2514. In act 2514, conditions 1-5 are unchanged from act 2506, but condition 6 can be expressed as follows:

6) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 6 in act 2514 results in eaches being picked from the backroom storage location.

FIG. 25C presents another slightly altered example of the rule described in FIG. 25A, where act 2506 of FIG. 25A is replaced by act 2516. In act 2516, conditions 1-5 are unchanged from act 2506, but there is no condition 6. The rule presented within FIG. 25C is applicable when the product is not stored by cases within the storage location 122, but is only stored as individual product units, and must be picked by eaches.

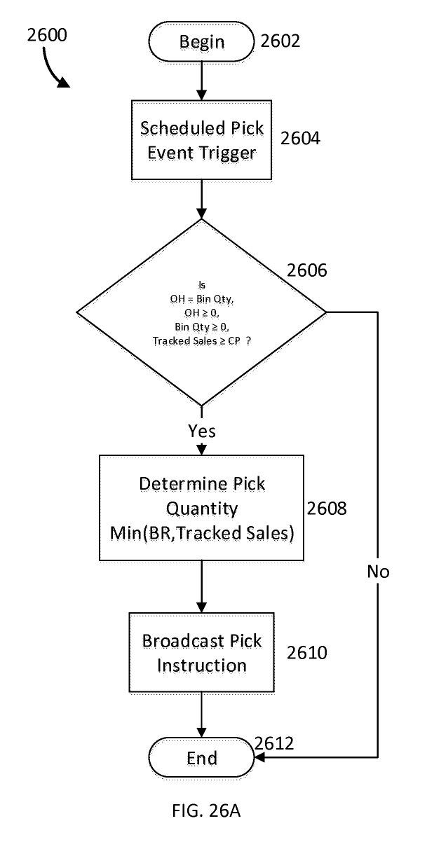

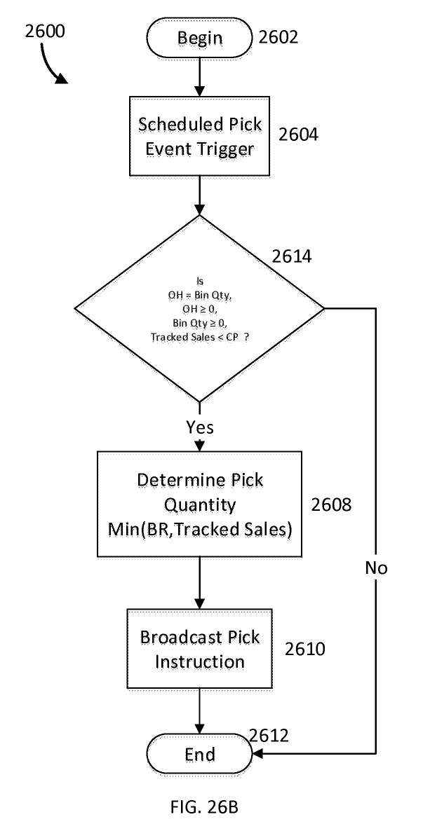

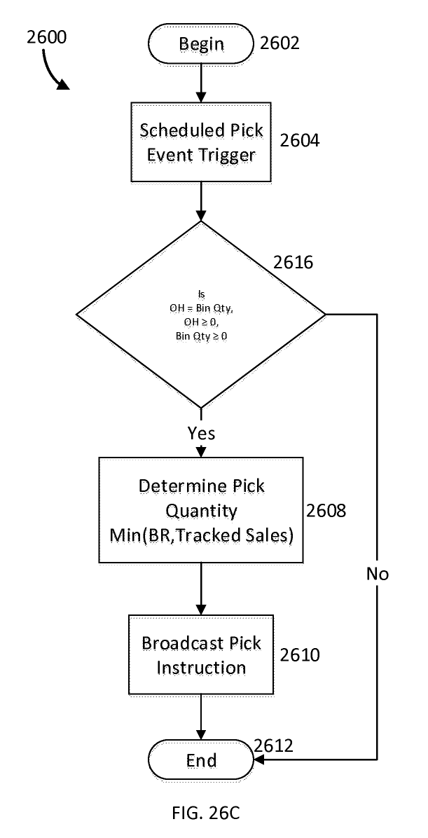

FIG. 26A presents an example implementation of a pick to maintain rule for non-modular items on feature display that can be triggered by a pre-determined schedule of execution times. At the scheduled execution time, picks are generated when the total quantity of a product on-hand equals the bin quantity of the product and when the tracked sales of the product are greater than the case pack size of the product. The rule presented in FIG. 26A is not necessarily to be associated with a vendor managed product, but is associated with a product that has been binned. The rule presented in FIG. 26A is associated with products that are on PI. If the employee that receives pick instructions does not execute the pick by a predefined expiration time associated with this rule, then the instruction for executing the pick expires. The process 2600 of executing the rule in FIG. 26A begins with act 2602. In act 2604, a scheduled pick triggering event occurs, that instructs the inventory management system 304 to execute this rule. In act 2606, required conditions for executing the associated pick are checked. The required conditions for this pick rule include:

1) Is the total on-hand quantity of the product equal to the bin quantity of the product? (OH=BR)
2) Is the on-hand quantity of the product greater than or equal to zero? (OH≧0)
3) Is the bin quantity of the product greater than or equal to zero? (BR≧0)
4) Is the feature capacity of the product equal to zero? (FC=0)
5) Are the tracked sales of the product greater than or equal to the size of a case pack for the product? (Tracked Sales≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 2608, the quantity of product to be picked is determined to be either the backroom quantity of the product in storage or the tracked sales of the product, whichever is less (Min(BR, Tracked Sales)). In act 2610, upon determination of the appropriate quantity of product for the current pick, the pick instructions are broadcast by the pick instruction output interface 318 to the appropriate output computing device 320. In act 2612, execution of the rule ends.

FIG. 26B presents a slightly altered example of the rule described in FIG. 26A, where act 2606 of FIG. 26A is replaced by act 2614. In act 2614, conditions 1-4 are unchanged from act 2606, but condition 5 can be expressed as follows:

5) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 5 in act 2614 results in eaches being picked from the backroom storage location.

FIG. 26C presents another slightly altered example of the rule described in FIG. 26A, where act 2606 of FIG. 26A is replaced by act 2616. In act 2616, conditions 1-4 are unchanged from act 2606, but there is no condition 5. The rule presented within FIG. 26C is applicable when the product is not stored by cases within the storage location 122, but is only stored as individual product units, and must be picked by eaches.

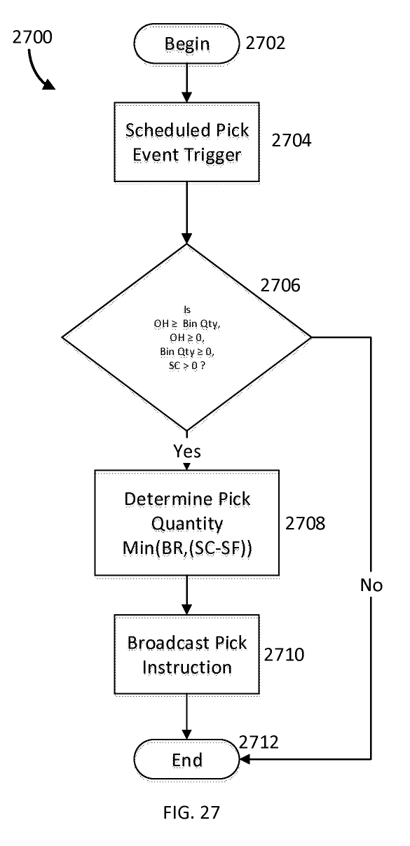

FIG. 27 presents an example implementation of a pick to fill rule for modular items that can be triggered by a pre-determined schedule of execution times. At the scheduled execution time, picks are generated based on the shelf capacity of the product and the current sales floor quantity of the product. The rule presented in FIG. 27 is not necessarily to be associated with a vendor managed product, but is associated with a product that has been binned. The rule presented in FIG. 27 is associated with products that are on PI. If the employee that receives pick instructions does not execute the pick by a predefined expiration time associated with this rule, then the instruction for executing the pick expires. The process 2700 of executing the rule in FIG. 27 begins with act 2702. In act 2704, a scheduled pick triggering event occurs, that instructs the inventory management system 304 to execute this rule. In act 2706, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Is the shelf capacity of the product greater than or equal to zero? (SC>0)
If any of these conditions does not return in the affirmative, then the execution of the rule exits. If all of these conditions return in the affirmative, the execution of the rule continues. In act 2708, the quantity of product to be picked is determined to be either the backroom quantity of the product in storage or the difference of the shelf capacity of the product's modular home and the quantity of the product currently on the sales floor, whichever is less (Min(BR,(SC−SF))). In some embodiments of the execution of this rule, the picking of product from storage can be performed by picking cases. In other embodiments of the execution of this rule, the picking of product from storage can be performed by picking eaches. In act 2710, upon determination of the appropriate quantity of product for the current pick, the pick instructions are broadcast by the pick instruction output interface 318 to the appropriate output computing device 320. In act 2712, execution of the rule ends.

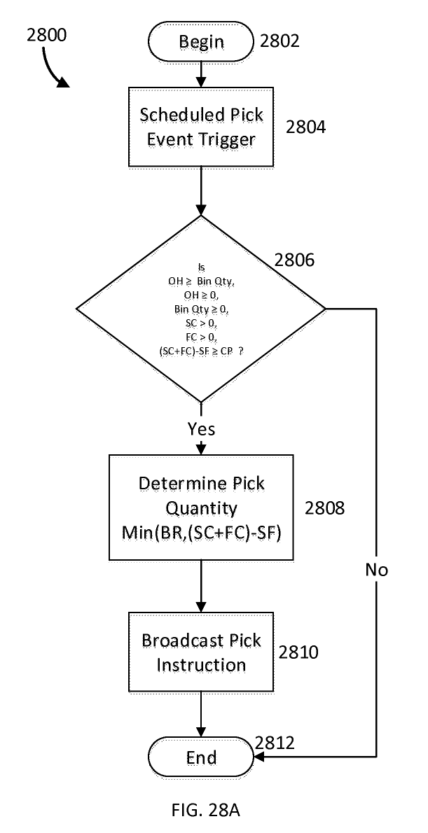

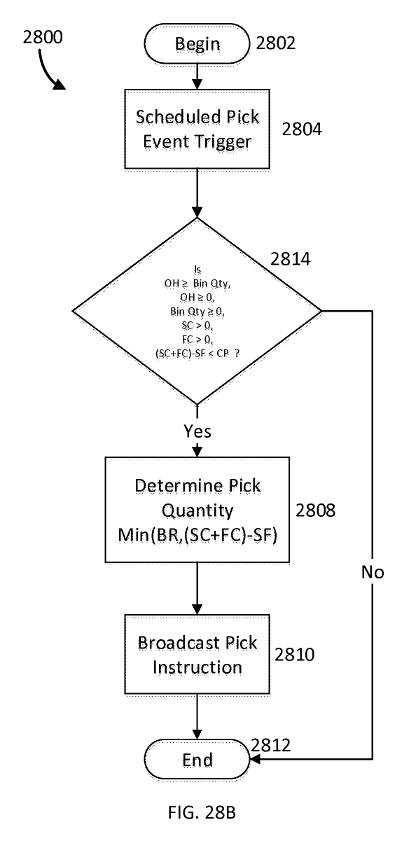

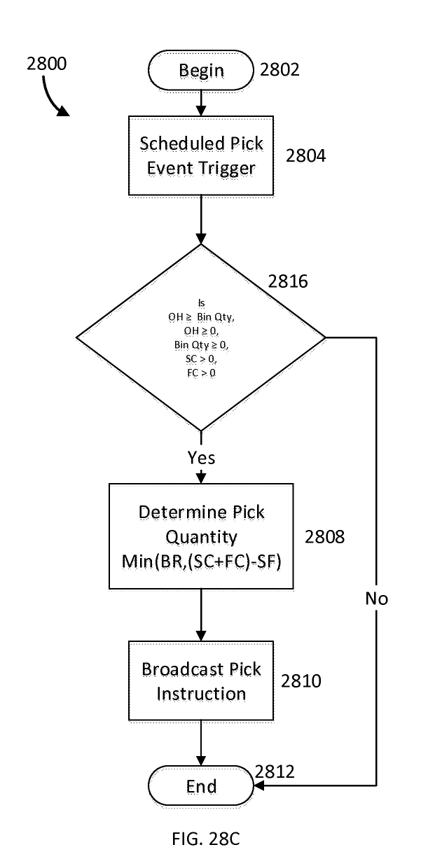

FIG. 28A presents an example implementation of a pick to fill rule for modular items on feature display that can be triggered by a pre-determined schedule of execution times. At the scheduled execution time, picks are generated based on the shelf capacity of the product and the current sales floor quantity of the product. The rule presented in FIG. 28A is not necessarily to be associated with a vendor managed product, but is associated with a product that has been binned. The rule presented in FIG. 28A is associated with products that are on PI. If the employee that receives pick instructions does not execute the pick by a predefined expiration time associated with this rule, then the instruction for executing the pick expires. The process 2800 of executing the rule in FIG. 28A begins with act 2802. In act 2804, a scheduled pick triggering event occurs, that instructs the inventory management system 304 to execute this rule. In act 2806, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Is the shelf capacity of the product greater than zero? (SC>0)
5) Is the feature capacity of the product greater than zero? (FC>0)
6) Is the difference of the sum of the shelf capacity and the feature capacity of the product with the current sales floor quantity of the product greater than or equal to the case pack size of the product? ((SC+FC)−SF≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 2808, the quantity of product to be picked is determined to be either the backroom quantity of the product in storage or the difference of the sum of the shelf capacity of the products modular home and feature capacity of the product with the quantity of the product on the sales floor, whichever is less (Min(BR, (SC+FC)−SF)). In act 2810, upon determination of the appropriate quantity of product for the current pick, the pick instructions are broadcast by the pick instruction output interface 318 to the appropriate output computing device 320. In act 2812, execution of the rule ends.

FIG. 28B presents a slightly altered example of the rule described in FIG. 28A, where act 2806 of FIG. 28A is replaced by act 2814. In act 2814, conditions 1-5 are unchanged from act 2806, but condition 6 can be expressed as follows:

6) Is the difference of the sum of the shelf capacity and the feature capacity with the current sales floor quantity less than the case pack size of the product? ((SC+FC)−SF<CP)
If any of the conditions do not return in the affirmative, then the execution of the rule exits. If all of these conditions return in the affirmative, then the execution of the rule continues. In this example, the altered condition 6 in act 2814 results in eaches being picked from the backroom storage location.

FIG. 28C presents another slightly altered example of the rule described in FIG. 28A, where act 2806 of FIG. 28A is replaced by act 2816. In act 2816, conditions 1-5 are unchanged from act 2806, but there is no condition 6. The rule presented within FIG. 28C is applicable when the product is not stored by cases within the storage location 122, but is only stored as individual product units, and must be picked by eaches.

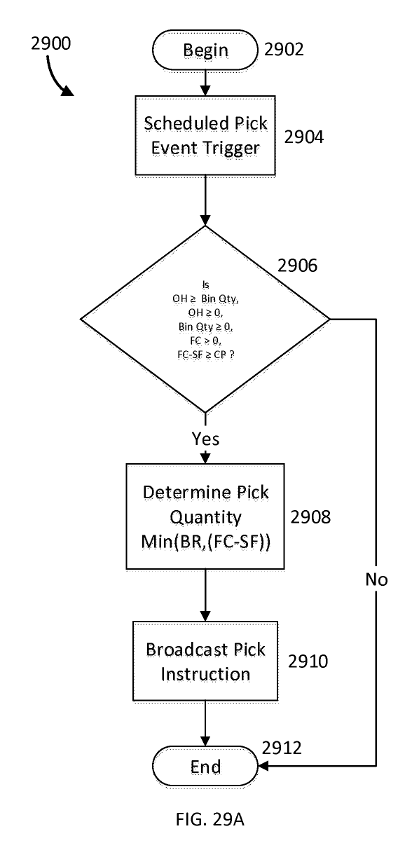

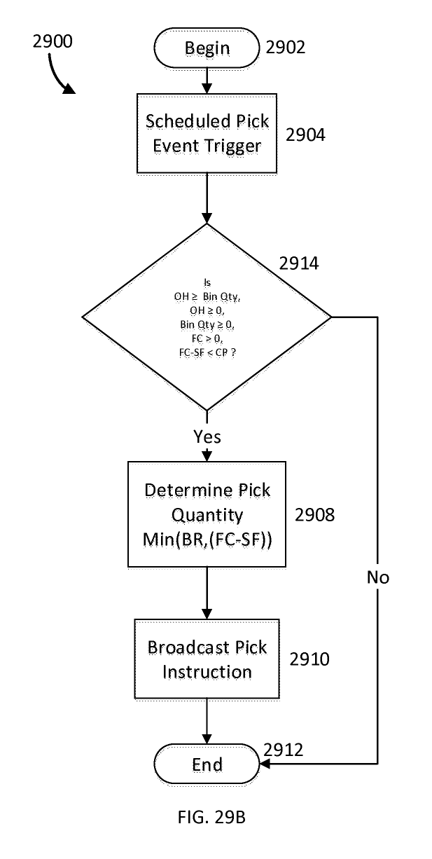

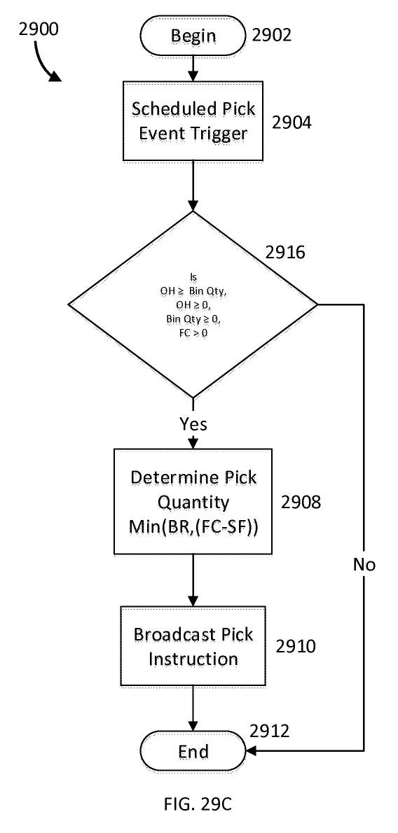

FIG. 29A presents an example implementation of a pick to fill rule for non-modular items on feature display with a feature capacity that can be triggered by a pre-determined schedule of execution times. At the scheduled execution time, picks are generated based on feature capacity and the current sales floor quantity of the product. The rule presented in FIG. 29A is not necessarily to be associated with a vendor managed product, but is associated with a product that has been binned. The rule presented in FIG. 29A is associated with products that are on PI. If the employee that receives pick instructions does not execute the pick by a predefined expiration time associated with this rule, then the instruction for executing the pick expires. The process 2900 of executing the rule in FIG. 29A begins with act 2902. In act 2904, a scheduled pick triggering event occurs, that instructs the inventory management system 304 to execute this rule. In act 2906, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Is the feature capacity of the product greater than zero? (FC>0)
6) Is the difference of the feature capacity of the product and the current sales floor quantity of the product greater than or equal to the case pack size of the product? (FC−SF≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 2908, the quantity of product to be picked is determined to be either the backroom quantity of the product in storage or the difference between the feature capacity of the product and the current sales floor quantity of the product, whichever is less (Min(BR, FC−SF)). In act 2910, upon determination of the appropriate quantity of product for the current pick, the pick instructions are broadcast by the pick instruction output interface 318 to the appropriate output computing device 320. In act 2912, execution of the rule ends.

FIG. 29B presents a slightly altered example of the rule described in FIG. 29A, where act 2906 of FIG. 29A is replaced by act 2914. In act 2914, conditions 1-5 are unchanged from act 2906, but condition 6 can be expressed as follows:

6) Is the difference of the feature capacity and the sales floor quantity less than the size of the case pack for the product? (FC−SF<CP)
If any of the conditions do not return in the affirmative, then the execution of the rule exits. If all of these conditions return in the affirmative, then the execution of the rule continues. In this example, the altered condition 6 in act 2914 results in eaches being picked from the backroom storage location.

FIG. 29C presents another slightly altered example of the rule described in FIG. 29A, where act 2906 of FIG. 29A is replaced by act 2916. In act 2916, conditions 1-5 are unchanged from act 2906, but there is no condition 6. The rule presented within FIG. 29C is applicable when the product is not stored by cases within the storage location 122, but is only stored as individual product units, and must be picked by eaches.

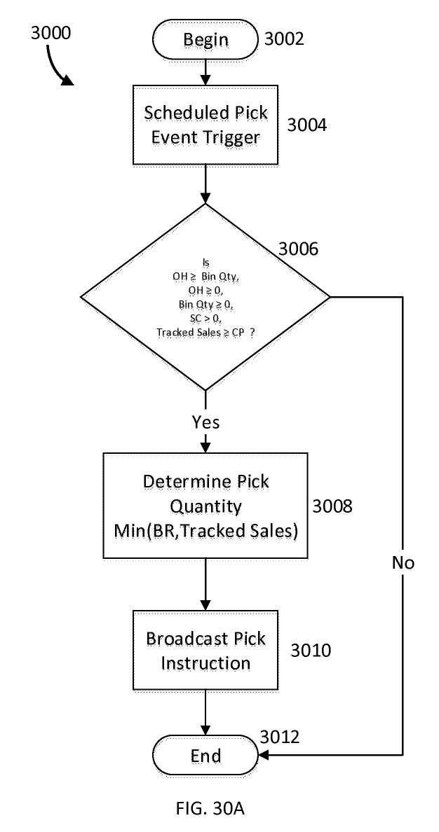

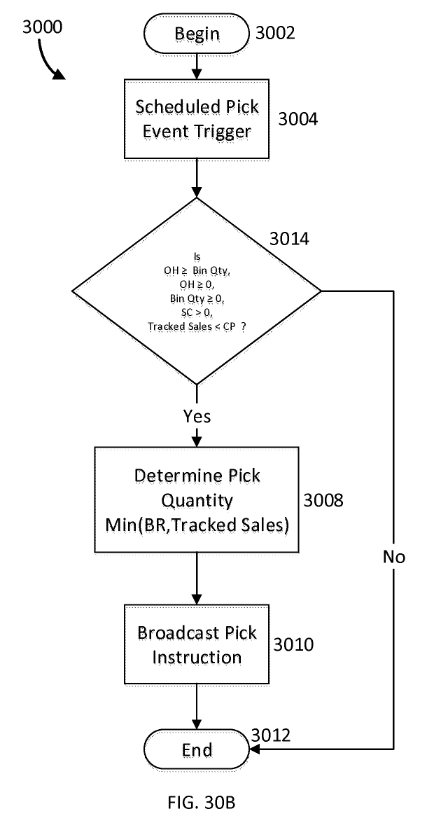

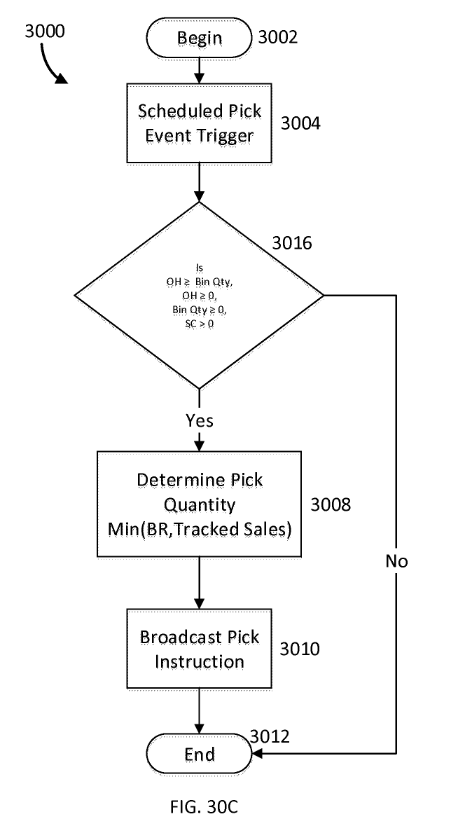

FIG. 30A presents an example implementation of a pick to fill rule for modular items on feature display with no feature capacity that can be triggered by a pre-determined schedule of execution times. At the scheduled execution time, picks are generated based on feature capacity and the current sales floor quantity of the product. The rule presented in FIG. 30A is not necessarily to be associated with a vendor managed product, but is associated with a product that has been binned. The rule presented in FIG. 30A is associated with products that are on PI. If the employee that receives pick instructions does not execute the pick by a predefined expiration time associated with this rule, then the instruction for executing the pick expires. The process 3000 of executing the rule in FIG. 30A begins with act 3002. In act 3004, a scheduled pick triggering event occurs, that instructs the inventory management system 304 to execute this rule. In act 3006, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Is the shelf capacity of the product greater than zero? (SC>0)
5) Are the tracked sales of the product greater than the size of a case pack for the product? (Tracked Sales≧CP)
If any of these conditions does not return in the affirmative, then the execution of the rule exits. If all of these conditions return in the affirmative, the execution of the rule continues. In this example, the condition 5 above results in cases being picked from the backroom storage location 122. In act 3008, the quantity of product to be picked is determined to be either the backroom quantity of the product in storage or the tracked sales of the product, whichever is less (Min(BR, Tracked Sales)). In act 3010, upon determination of the appropriate quantity of product for the current pick, the pick instructions are broadcast by the pick instruction output interface 318 to the appropriate output computing device 320. In act 3012, execution of the rule ends.

FIG. 30B presents a slightly altered example of the rule described in FIG. 30A, where act 3006 of FIG. 30A is replaced by act 3014. In act 3014, conditions 1-4 are unchanged from act 3006, but condition 5 can be expressed as follows:

5) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 5 in act 3014 results in eaches being picked from the backroom storage location.

FIG. 30C presents another slightly altered example of the rule described in FIG. 30A, where act 3006 of FIG. 30A is replaced by act 3016. In act 3016, conditions 1-4 are unchanged from act 3006, but there is no condition 5. The rule presented within FIG. 30C is applicable when the product is not stored by cases within the storage location 122, but is only stored as individual product units, and must be picked by eaches.

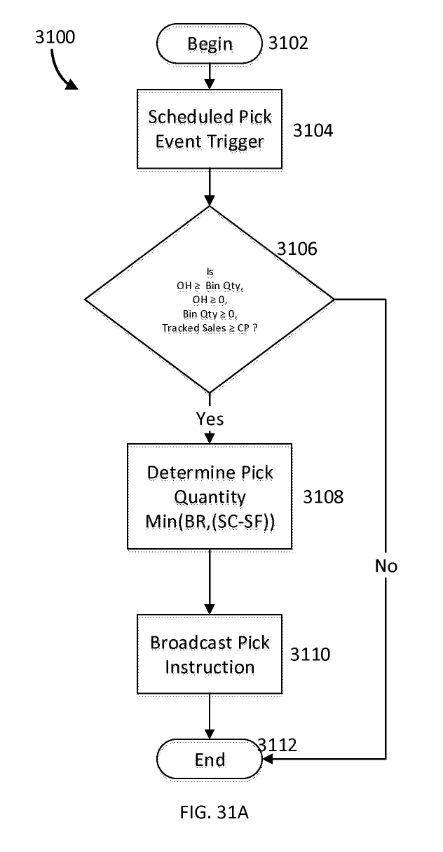

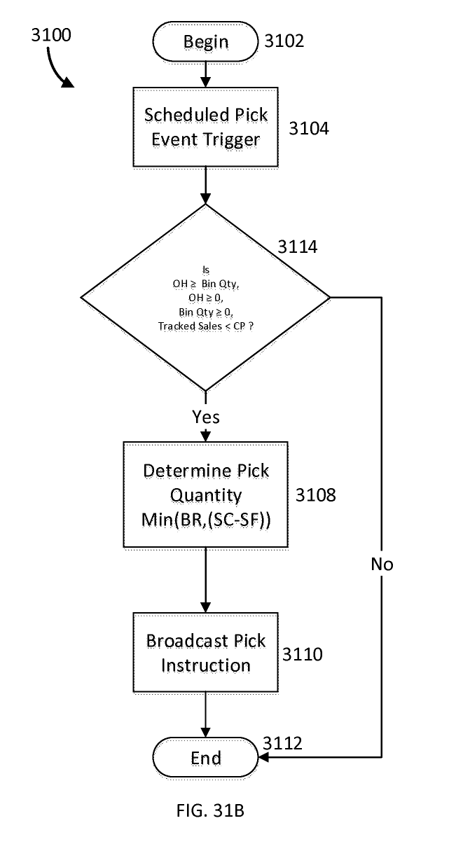

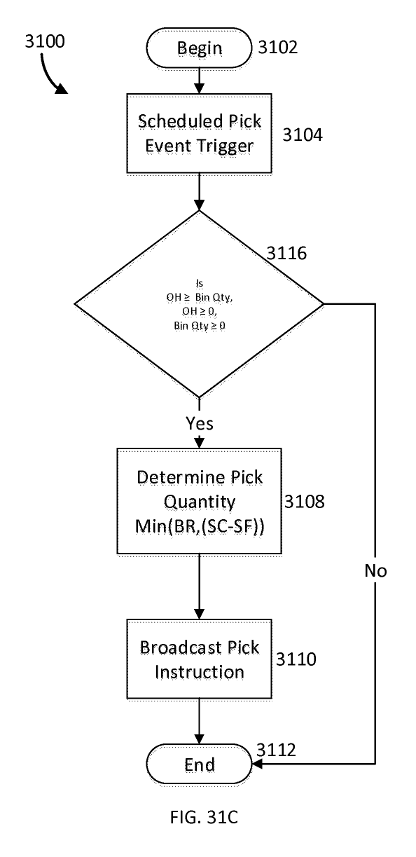

FIG. 31A presents an example implementation of a pick to fill rule for non-modular items on feature display with no feature capacity that can be triggered by a pre-determined schedule of execution times. At the scheduled execution time, picks are generated based on feature capacity and the current sales floor quantity of the product. The rule presented in FIG. 31A is not necessarily to be associated with a vendor managed product, but is associated with a product that has been binned. The rule presented in FIG. 31A is associated with products that are on PI. If the employee that receives pick instructions does not execute the pick by a predefined expiration time associated with this rule, then the instruction for executing the pick expires. The process 3100 of executing the rule in FIG. 31A begins with act 3102. In act 3104, a scheduled pick triggering event occurs, that instructs the inventory management system 304 to execute this rule. In act 3106, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Are the tracked sales of the product greater than the size of a case pack for the product? (Tracked Sales≧CP)
If any of these conditions does not return in the affirmative, then the execution of the rule exits. If all of these conditions return in the affirmative, the execution of the rule continues. In this example, the condition 4 above results in cases being picked from the backroom storage location 122. In act 3108, the quantity of product to be picked is determined to be either the backroom quantity of the product in storage or the tracked sales of the product, whichever is less (Min(BR, Tracked Sales)). In act 3110, upon determination of the appropriate quantity of product for the current pick, the pick instructions are broadcast by the pick instruction output interface 318 to the appropriate output computing device 320. In act 3112, execution of the rule ends.

FIG. 31B presents a slightly altered example of the rule described in FIG. 31A, where act 3106 of FIG. 31A is replaced by act 3114. In act 3114, conditions 1-3 are unchanged from act 3106, but condition 4 can be expressed as follows:

4) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 4 in act 3114 results in eaches being picked from the backroom storage location.

FIG. 31C presents another slightly altered example of the rule described in FIG. 31A, where act 3106 of FIG. 31A is replaced by act 3116. In act 3116, conditions 1-3 are unchanged from act 3106, but there is no condition 4. The rule presented within FIG. 31C is applicable when the product is not stored by cases within the storage location 122, but is only stored as individual product units, and must be picked by eaches.

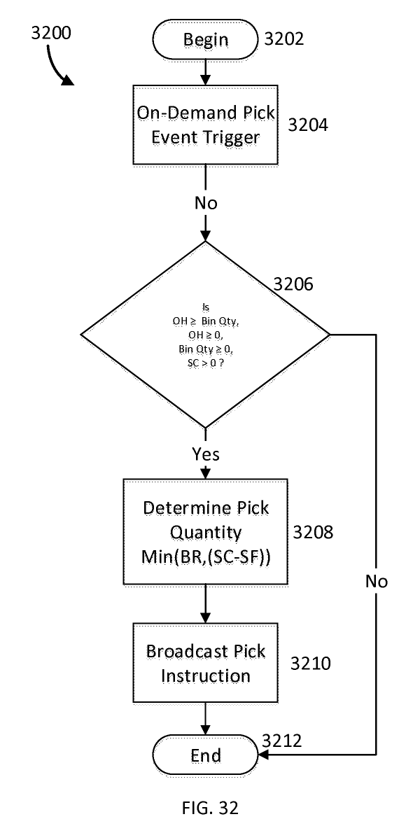

FIG. 32 presents an example implementation of a pick on-demand rule for modular items that can be triggered by the entry of an on-demand pick request by an employee. At the performed execution time, picks are generated based on the shelf capacity of the product. The rule presented in FIG. 32 is not necessarily to be associated with a vendor managed product, but is associated with a product that has been binned. The rule presented in FIG. 32 is associated with products that are on PI. If the employee that receives pick instructions does not execute the pick by a predefined expiration time associated with this rule, then the instruction for executing the pick expires. The process 3200 of executing the rule in FIG. 32 begins with act 3202. In act 3204, an employee entry of the pick request occurs, that instructs the inventory management system 304 to execute this rule. In act 3206, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Is the shelf capacity of the product greater than zero? (SC>0)
If any of these conditions does not return in the affirmative, then the execution of the rule exits. If all of these conditions return in the affirmative, the execution of the rule continues. In act 3208, the quantity of product to be picked is determined to be either the backroom quantity of the product in storage or the difference of the shelf capacity of the product's modular home and the quantity of the product currently on the sales floor, whichever is less (Min(BR,(SC−SF))). In some embodiments of the execution of this rule, the picking of product from storage can be performed by picking cases. In other embodiments of the execution of this rule, the picking of product from storage can be performed by picking eaches. In act 3210, upon determination of the appropriate quantity of product for the current pick, the pick instructions are broadcast by the pick instruction output interface 318 to the appropriate output computing device 320. In act 3212, execution of the rule ends.

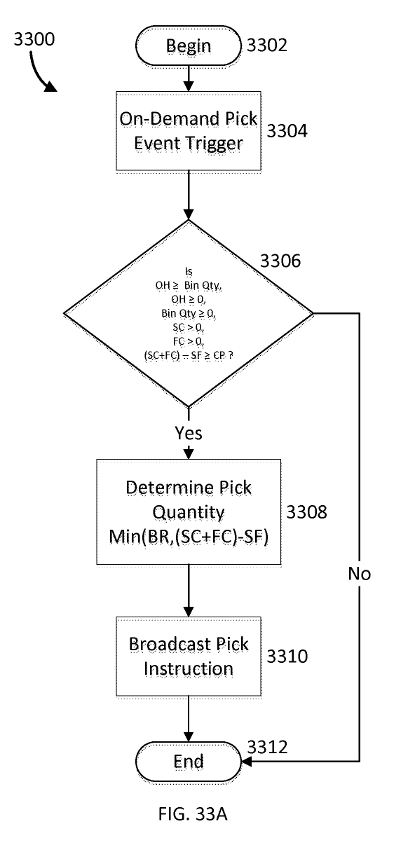

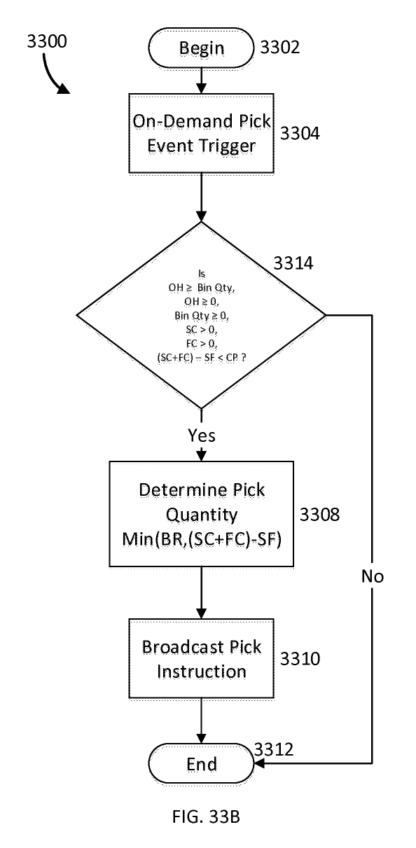

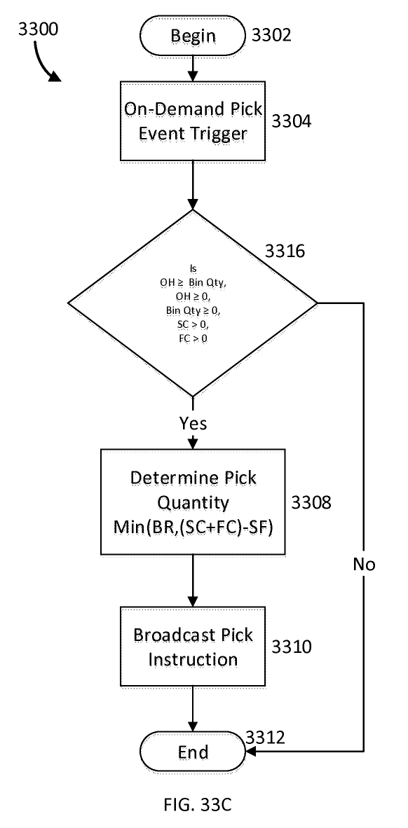

FIG. 33A presents an example implementation of a pick on-demand rule for modular items on feature display that can be triggered by the entry of an on-demand pick request by an employee. At the performed execution time, picks are generated based on the shelf capacity of the product, the feature capacity of the product, and the current sales floor quantity of the product. The rule presented in FIG. 33A is not necessarily to be associated with a vendor managed product, but is associated with a product that has been binned. The rule presented in FIG. 33A is associated with products that are on PI. If the employee that receives pick instructions does not execute the pick by a predefined expiration time associated with this rule, then the instruction for executing the pick expires. The process 3300 of executing the rule in FIG. 33A begins with act 3302. In act 3304, an employee entry of the pick request occurs, that instructs the inventory management system 304 to execute this rule. In act 3306, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Is the shelf capacity of the product greater than zero? (SC>0)
5) Is the feature capacity of the product greater than zero? (FC>0)
6) Is the difference of the sum of the shelf capacity and the feature capacity of the product with the current sales floor quantity greater than or equal to the case pack size of the product? ((SC+FC)−SF≧CP)
If any of these conditions does not return in the affirmative, then the execution of the rule exits. If all of these conditions return in the affirmative, the execution of the rule continues. In this example, the condition 6 above results in cases being picked from the backroom storage location 122. In act 3308, the quantity of product to be picked is determined to be either the backroom quantity of the product in storage or the difference of the sum of the shelf capacity of the products modular home and feature capacity of the product with the quantity of the product on the sales floor, whichever is less (Min(BR, (SC+FC)−SF)). In act 3310, upon determination of the appropriate quantity of product for the current pick, the pick instructions are broadcast by the pick instruction output interface 318 to the appropriate output computing device 320. In act 3312, execution of the rule ends.

FIG. 33B presents a slightly altered example of the rule described in FIG. 33A, where act 3306 of FIG. 33A is replaced by act 3314. In act 3314, conditions 1-5 are unchanged from act 3306, but condition 6 can be expressed as follows:

6) Is the difference of the sum of the shelf capacity and the feature capacity with the current sales floor quantity less than the case pack size of the product? ((SC+FC)−SF<CP)
If any of the conditions do not return in the affirmative, then the execution of the rule exits. If all of these conditions return in the affirmative, then the execution of the rule continues. In this example, the altered condition 6 in act 3314 results in eaches being picked from the backroom storage location.

FIG. 33C presents another slightly altered example of the rule described in FIG. 33A, where act 3306 of FIG. 33A is replaced by act 3316. In act 3316, conditions 1-5 are unchanged from act 3306, but there is no condition 6. The rule presented within FIG. 33C is applicable when the product is not stored by cases within the storage location 122, but is only stored as individual product units, and must be picked by eaches.

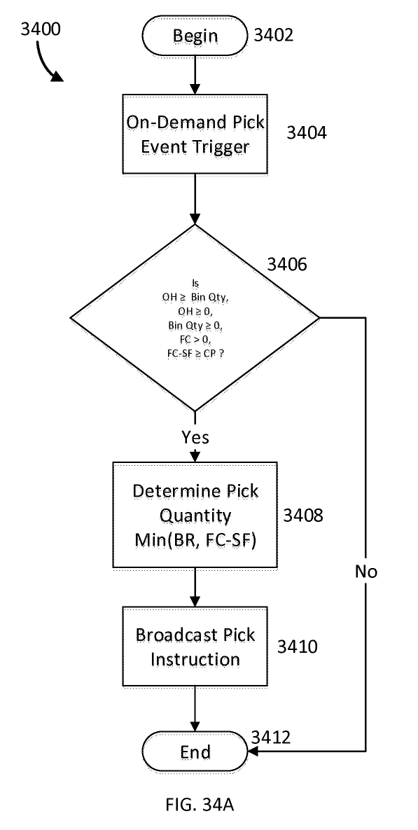

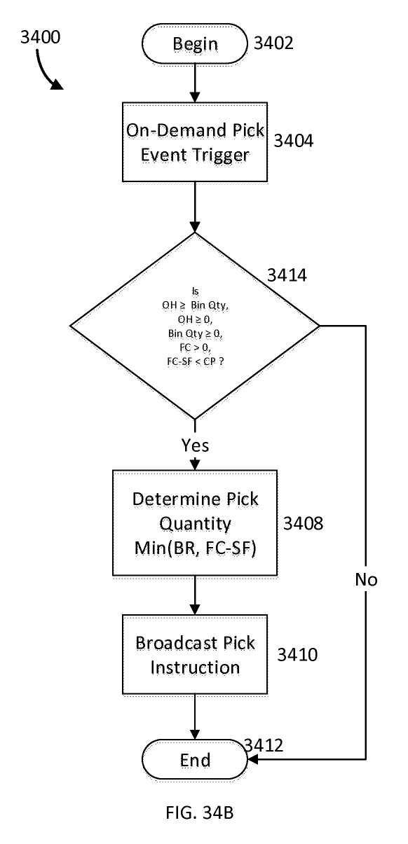

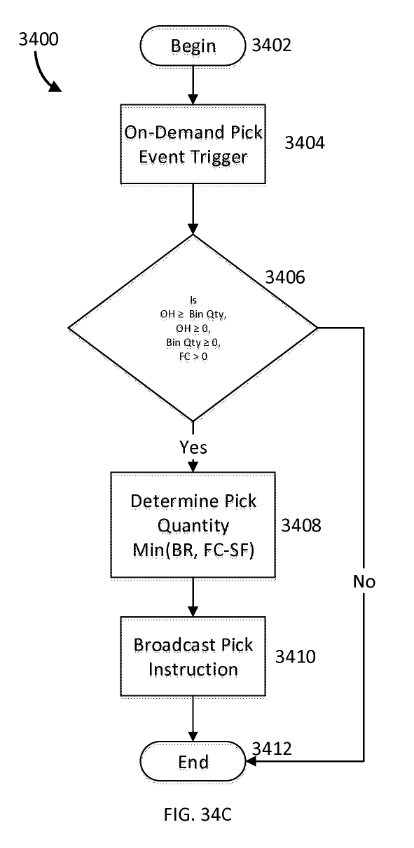

FIG. 34A presents an example implementation of a pick on-demand rule for non-modular items on feature display that can be triggered by the entry of an on-demand pick request by an employee. At the performed execution time, picks are generated based on the feature capacity of the product, and the current sales floor quantity of the product. The rule presented in FIG. 34A is not necessarily to be associated with a vendor managed product, but is associated with a product that has been binned. The rule presented in FIG. 34A is associated with products that are on PI. If the employee that receives pick instructions does not execute the pick by a predefined expiration time associated with this rule, then the instruction for executing the pick expires. The process 3400 of executing the rule in FIG. 34A begins with act 3402. In act 3404, an employee entry of the pick request occurs, that instructs the inventory management system 304 to execute this rule. In act 3406, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Is the feature capacity of the product greater than zero? (FC>0)
5) Is the difference of the feature capacity of the product with the current sales floor quantity of the product greater than or equal to the case pack size of the product? (FC−SF≧CP)
If any of these conditions does not return in the affirmative, then the execution of the rule exits. If all of these conditions return in the affirmative, the execution of the rule continues. In this example, the condition 5 above results in cases being picked from the backroom storage location 122. In act 3408, the quantity of product to be picked is determined to be either the backroom quantity of the product in storage or the difference between the sum of the shelf capacity and feature capacity of the product with the current sales floor quantity of the product, whichever is less (Min(BR, FC−SF)). In act 3410, upon determination of the appropriate quantity of product for the current pick, the pick instructions are broadcast by the pick instruction output interface 318 to the appropriate output computing device 320. In act 3412, execution of the rule ends.

FIG. 34B presents a slightly altered example of the rule described in FIG. 34A, where act 3406 of FIG. 34A is replaced by act 3414. In act 3414, conditions 1-4 are unchanged from act 3406, but condition 5 can be expressed as follows:

6) Is the difference of the feature capacity and the sales floor quantity less than the size of the case pack for the product? (FC−SF<CP)
If any of the conditions do not return in the affirmative, then the execution of the rule exits. If all of these conditions return in the affirmative, then the execution of the rule continues. In this example, the altered condition 5 in act 3414 results in eaches being picked from the backroom storage location.

FIG. 34C presents another slightly altered example of the rule described in FIG. 34A, where act 3406 of FIG. 34A is replaced by act 3416. In act 3416, conditions 1-4 are unchanged from act 3406, but there is no condition 5. The rule presented within FIG. 34C is applicable when the product is not stored by cases within the storage location 122, but is only stored as individual product units, and must be picked by eaches.

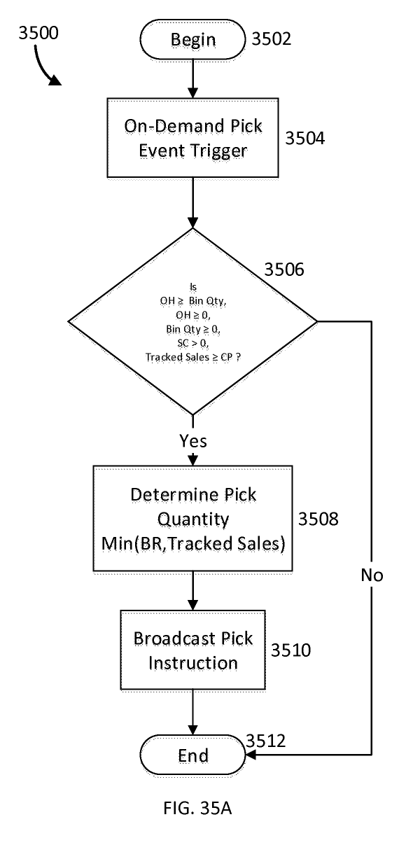

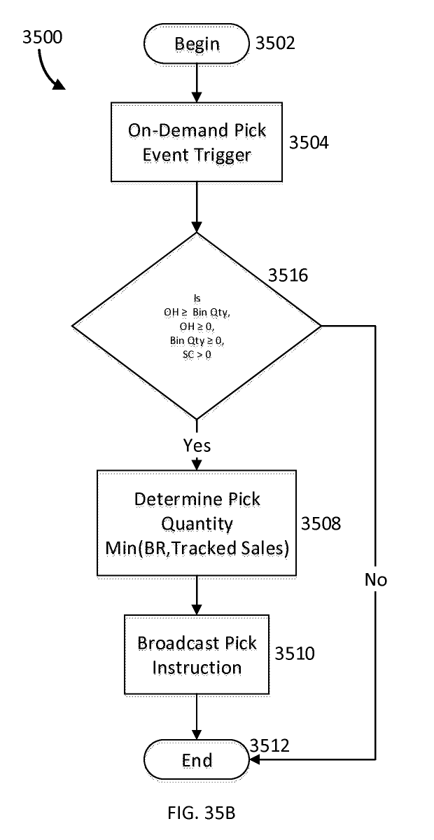

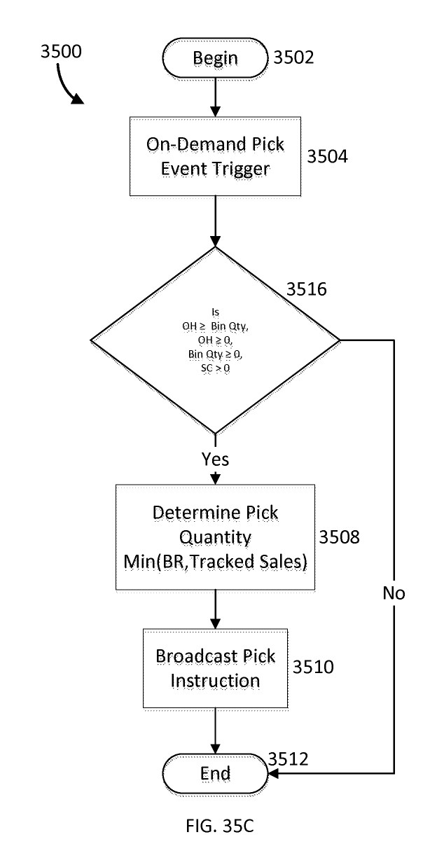

FIG. 35A presents an example implementation of a pick on-demand rule for non-modular items on feature display that can be triggered by the entry of an on-demand pick request by an employee. At the performed execution time, picks are generated based on the tracked sales of the product. The rule presented in FIG. 35A is not necessarily to be associated with a vendor managed product, but is associated with a product that has been binned. The rule presented in FIG. 35A is associated with products that are on PI. If the employee that receives pick instructions does not execute the pick by a predefined expiration time associated with this rule, then the instruction for executing the pick expires. The process 3500 of executing the rule in FIG. 35A begins with act 3502. In act 3504, an employee entry of the pick request occurs, that instructs the inventory management system 304 to execute this rule. In act 3506, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Is the shelf capacity of the product greater than zero? (SC>0)
5) Are the current tracked sales of the product greater than or equal to the case pack size of the product? (Tracked Sales≧CP)
If any of these conditions does not return in the affirmative, then the execution of the rule exits. If all of these conditions return in the affirmative, the execution of the rule continues. In this example, the condition 5 above results in cases being picked from the backroom storage location 122. In act 3508, the quantity of product to be picked is determined to be either the backroom quantity of the product in storage or the current tracked sales of the product, whichever is less (Min(BR, Tracked Sales)). In act 3510, upon determination of the appropriate quantity of product for the current pick, the pick instructions are broadcast by the pick instruction output interface 318 to the appropriate output computing device 320. In act 3512, execution of the rule ends.

FIG. 35B presents a slightly altered example of the rule described in FIG. 35A, where act 3506 of FIG. 35A is replaced by act 3514. In act 3514, conditions 1-4 are unchanged from act 3506, but condition 5 can be expressed as follows:

5) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 5 in act 3514 results in eaches being picked from the backroom storage location.

FIG. 35C presents another slightly altered example of the rule described in FIG. 35A, where act 3506 of FIG. 35A is replaced by act 3516. In act 3516, conditions 1-4 are unchanged from act 3506, but there is no condition 5. The rule presented within FIG. 35C is applicable when the product is not stored by cases within the storage location 122, but is only stored as individual product units, and must be picked by eaches.

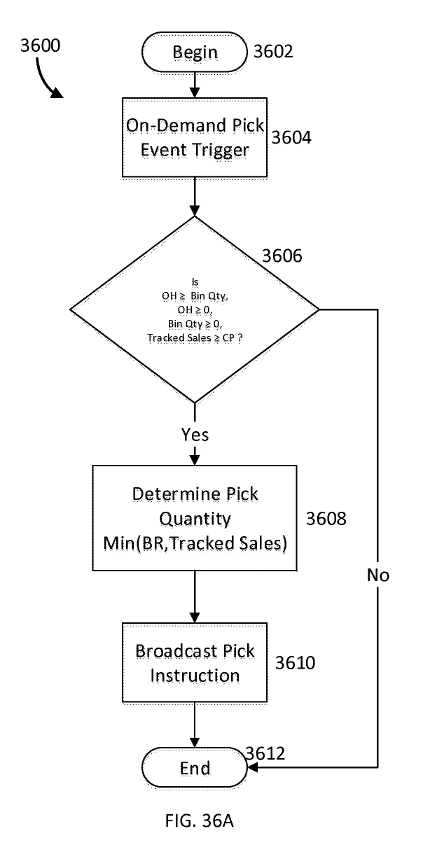

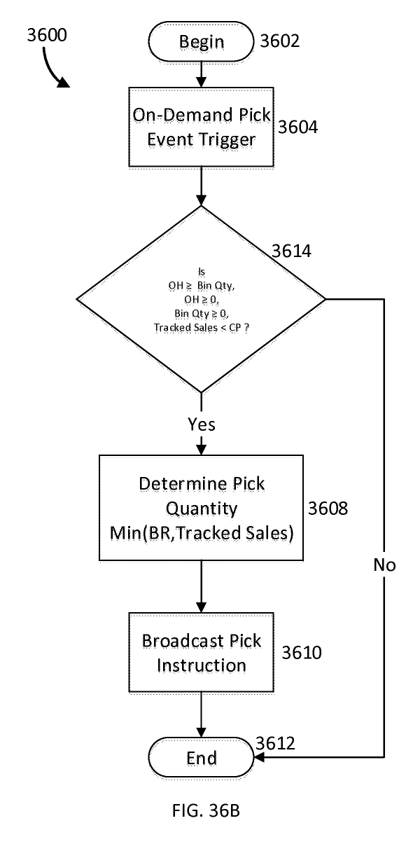

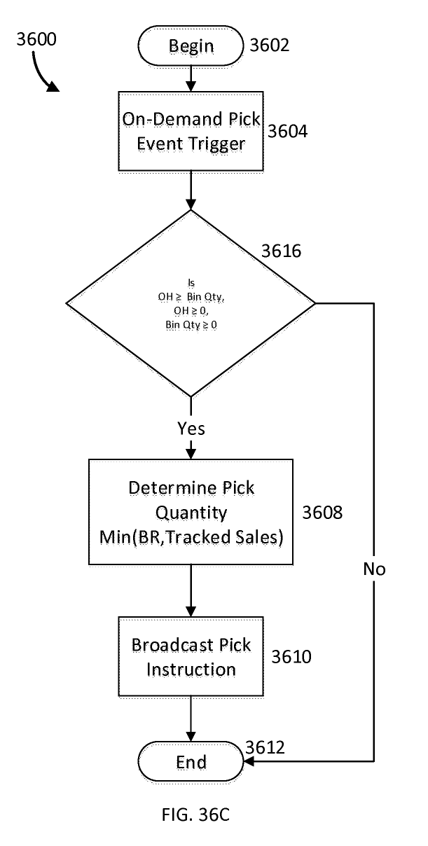

FIG. 36A presents an example implementation of a pick on-demand rule for non-modular items on feature display with a feature capacity that can be triggered by the entry of an on-demand pick request by an employee. At the performed execution time, picks are generated based on the tracked sales of the product. The rule presented in FIG. 36A is not necessarily to be associated with a vendor managed product, but is associated with a product that has been binned. The rule presented in FIG. 36A is associated with products that are on PI. If the employee that receives pick instructions does not execute the pick by a predefined expiration time associated with this rule, then the instruction for executing the pick expires. The process 3600 of executing the rule in FIG. 36A begins with act 3602. In act 3604, an employee entry of the pick request occurs, that instructs the inventory management system 304 to execute this rule. In act 3606, required conditions for executing the associated pick are checked. The required conditions for this pick rule include:

1) Is the total on-hand quantity of the product greater than or equal to the bin quantity of the product? (OH≧BR)
2) Is the on-hand quantity of the product greater than or equal to zero? (OH≧0)
3) Is the bin quantity of the product greater than or equal to zero? (BR≧0)
4) Are the current tracked sales of the product greater than or equal to the case pack size of the product? (Tracked Sales≧CP)
If any of these conditions does not return in the affirmative, then the execution of the rule exits. If all of these conditions return in the affirmative, the execution of the rule continues. In this example, the condition 4 above results in cases being picked from the backroom storage location 122. In act 3608, the quantity of product to be picked is determined to be either the backroom quantity of the product in storage or the current tracked sales of the product, whichever is less (Min(BR, Tracked Sales)). In act 3610, upon determination of the appropriate quantity of product for the current pick, the pick instructions are broadcast by the pick instruction output interface 318 to the appropriate output computing device 320. In act 3612, execution of the rule ends.

FIG. 36B presents a slightly altered example of the rule described in FIG. 36A, where act 3606 of FIG. 36A is replaced by act 3614. In act 3614, conditions 1-3 are unchanged from act 3606, but condition 4 can be expressed as follows:

5) Are tracked sales of the product less than the size of the case pack for the product? (Tracked Sales<CP)
If any of the conditions do not return in the affirmative, then the execution of the rule exits. If all of these conditions return in the affirmative, then the execution of the rule continues. In this example, the altered condition 4 in act 3614 results in eaches being picked from the backroom storage location.

FIG. 36C presents another slightly altered example of the rule described in FIG. 36A, where act 3606 of FIG. 36A is replaced by act 3616. In act 3616, conditions 1-3 are unchanged from act 3606, but there is no condition 4. The rule presented within FIG. 36C is applicable when the product is not stored by cases within the storage location 122, but is only stored as individual product units, and must be picked by eaches.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A system for replenishing inventory in a retail environment, the system comprising:
a memory;
at least one processor coupled to the memory;
an inventory management engine executed by the processor and adapted to track the quantity of at least one product available in at least one location within the retail environment; and
a rule processing engine executed by the processor and adapted to execute at least one rule of a plurality of rules for picking the at least one product for replenishment in the at least one location within the retail environment.

2. The system of claim 1, wherein the at least one location within the retail environment includes a selling location, a feature location, and a reserve location.

3. The system of claim 1, wherein the plurality of rules for picking the at least one product includes a rule that defines a predetermined schedule of time to pick the at least one product.

4. The system of claim 1, wherein the at least one rule of the plurality of rules for picking includes a rule that defines a pick of the at least one product at a time and a quantity chosen by a system operator.

5. The system of claim 1, wherein the at least one rule of the plurality of rules for picking includes a rule that defines a pick of a calculated quantity of the at least one product at a time chosen by a system operator.

6. The system of claim 1, wherein the at least one rule of the plurality of rules for picking includes a rule that defines a predetermined schedule of times to pick the at least one product responsive to a determination by the inventory management engine that a rate of sale of the at least one product is greater than a sales floor quantity of the at least one product.

7. The system of claim 6, wherein the at least one product is a product whose storage quantity in a reserve location has been increased by delivery of a quantity of the at least one product to the retail establishment within a specific time window.

8. The system of claim 6, wherein the at least one product is a product whose total on-hand quantity in a selling location, a feature location, and a reserve location has changed within a specific time window.

9. The system of claim 6, wherein the at least one product is a product whose total sales floor quantity in the selling location and feature location has diminished within a specific time window.

10. The system of claim 1, wherein the at least one rule of the plurality of rules for picking includes a rule that defines a predetermined schedule of times to pick the at least one product responsive to a determination by the inventory management engine that sufficient quantity of the at least one product is available in storage to fill available space on a sales floor reserved for the at least one product.

11. The system of claim 1, wherein the at least one rule of the plurality of rules for picking includes a rule that defines a predetermined schedule of times to pick the at least one product responsive to a determination by the inventory management engine that all quantity of the at least one product in storage is available to stock available space on a sales floor reserved for the at least one product.

13. The system of claim 1, wherein the inventory management engine is further configured to track a quantity of the at least one product over a time period whose time window commences at the time of product delivery to the retail establishment.

14. The system of claim 1, wherein the inventory management engine is further configured to track a quantity of the at least one product over a time period whose time window commences at the time of a most recent pick of the at least one product.

15. The system of claim 1, wherein the inventory management engine is further configured to track a quantity of the at least one product over a time period whose time window commences at the time of a most recent placement of the at least one product in a feature location.

16. The system of claim 1, wherein the at least one rule of the plurality of rules for picking includes a rule for picking the at least one product having only a single modular location.

17. The system of claim 1, wherein the at least one rule of the plurality of rules for picking includes a rule for picking the at least one product having multiple modular locations.

18. The system of claim 1, wherein the at least one rule of the plurality of rules for picking includes a rule for picking the at least one product having a modular location and a feature location with a feature capacity.

19. The system of claim 1, wherein the at least one rule of the plurality of rules for picking includes a rule for picking the at least one product having a modular location and a feature location without a feature capacity.

20. The system of claim 1, wherein the at least one rule of the plurality of rules for picking includes a rule for picking the at least one product having only a feature location with a feature capacity.

21. The system of claim 1, wherein the at least one rule of the plurality of rules for picking includes a rule for picking the at least one product having only a feature location without a feature capacity.

22. The system of claim 1, wherein the plurality of rules for picking the at least one product for replenishment comprises at least one rule for replenishment based on case size of the at least one product.
